(19) United States
(12) Patent Application Publication
(10) Pub. No.: US 2022/0084015 A1
(43) Pub. Date: Mar. 17, 2022

(54) METHODS AND SYSTEMS FOR ETHICAL CRYPTOCURRENCY MANAGEMENT

(71) Applicant: Asante Technology LLC, Bethesda, MD (US)

(72) Inventors: Camelia Magdalena Fawzy, Bethesda, MD (US); Matei Mazen Fawzy, Bethesda, MD (US); Iulian Mihai Tache, Bucharest (RO); Aremescu Vitalie, Bucharest (RO)

(73) Assignee: Asante Technology LLC, Bethesda, MD (US)

(21) Appl. No.: 17/023,087

(22) Filed: Sep. 16, 2020

(51) Int. Cl. G06Q 20/36; G06Q 20/06; G06Q 40/04; H04L 12/58; G06Q 30/02

(52) U.S. Cl. CPC G06Q 20/3678; G06Q 20/0658; G06Q 30/0208; G06Q 40/04; H04L 51/32; G06Q 20/3672

(57) ABSTRACT

Some embodiments are directed to methods and systems for a cause-based eco-system that includes a platform supporting cryptocurrency transactions between users and organizations, the embedding of ethical constraints in the cryptocurrency as part of the transactions, and a marketplace to facilitate and manage the transactions. The eco-system also includes a lending and investment marketplace platform that allows users to invest in ethically or socially conscious organizations, and to borrow/lend against those investments.

### BACKGROUND

A cryptocurrency is a decentralized network based on blockchain technology, stored on a distributed ledger, enforced by a disparate network of computers, and that is not issued by any central authority.

Cause-based donations are donations to organizations performed in order to both support these organizations and improve society in accordance with some form of social responsibility.

### SUMMARY

Exemplary embodiments relate to blockchain technology. More particularly, exemplary embodiments relate to methods and systems for generating and managing ethical cryptocurrency and ethical cryptocurrency transactions.

Exemplary embodiments enhance or improve the concept of cause-based donations by using cryptocurrency instead of traditional central bank-based currency. For example, units of cryptocurrency may be embedded with ethical or mission-based constraints. As a result, cryptocurrency used to support a socially conscious mission may be identified as such. In addition, cryptocurrency that is not embedded with the ethical or mission-based constraints may not be accepted in a transaction.

Exemplary embodiments include a cause-based eco-system that includes a platform supporting cryptocurrency transactions between users and/or organizations, the embedding of ethical constraints in the cryptocurrency as part of the transactions, and a marketplace configured to facilitate and manage these ethical cryptocurrency transactions. The eco-system also includes a lending and investment marketplace platform configured to allow users to invest in ethically or socially conscious organizations or endeavors, and to borrow/lend against those investments.

Exemplary embodiments include a method of combining digital currency and social messaging to create an ethical digital currency, the method including, based on a useful service performed, the useful service including exchanging a digital currency, embedding a recognition note in the digital currency, and awarding the recognition note in exchange for the useful service, wherein the ethical currency is a combination of the digital currency and the recognition note.

Exemplary embodiments include a system for combining digital currency and social messaging to create an ethical digital currency, the system including a processor, a user interface functioning via the processor, and a repository accessible by the processor, wherein the processor creates a recognition note; the processor embeds an amount of digital currency in the recognition note; and the processor submits the recognition note embedded with the amount of digital currency; wherein the ethical digital currency is a combination of the amount of digital currency and the recognition note; and wherein at least one of the embedding of the amount of digital currency and the submitting the recognition note is performed on a digital currency exchange platform.

### BRIEF DESCRIPTION OF THE DRAWINGS

Various exemplary embodiments of the systems and methods may be described in detail, with reference to the following figures, wherein:

FIG. 1 is a flowchart illustrating a method of organizing an ethical cryptocurrency exchange, according to various exemplary embodiments.

FIG. 2 is a flowchart illustrating a method of monetizing TCards, according to various exemplary embodiments.

FIG. 3 is a flowchart illustrating a method of creating a TCard, according to various exemplary embodiments.

FIG. 4 is a flowchart illustrating a method of receiving a TCard, according to various exemplary embodiments.

FIG. 5 is a diagram illustrating a blockchain digital currency, according to various exemplary embodiments.

FIG. 6 is a flowchart showing the steps of an embodiment of the method of implementing and using a blockchain digital currency.

FIG. 7 is a diagram of a payment platform, according to various exemplary embodiments.

FIG. 8 is a block diagram illustrating a digital exchange system, according to exemplary embodiments.

FIG. 9 is a block diagram illustrating various components of a digital exchange system, according to exemplary embodiments.

FIG. 10 is a block diagram illustrating a digital media network constructed in accordance with exemplary embodiments.

FIG. 11 is a flowchart illustrating a method of operating a digital exchange system according to exemplary embodiments.

FIG. 12 is a schematic diagram illustrating a digital exchange system in accordance with exemplary embodiments.

FIG. 13 is a block diagram illustrating a digital exchange system according to exemplary embodiments.

FIG. 14 is a block diagram illustrating various components of a digital exchange system, according to exemplary embodiments.

FIG. 15 illustrates exemplary components.

FIG. 16 illustrates a schematic overview of the various phases of exemplary embodiments.

FIG. 17 shows a schematic overview of the integration of a vendors digital currency banking platform with customers, merchants and credit card associations using Bitcoin (BTC) and USD ($), according to exemplary embodiments.

FIG. 18 shows a schematic overview of a digital currency storage, payment and credit lending platform comprising eight distinct hardware and software components using a spliced/paired online digital wallet design, according to exemplary embodiments.

FIG. 19 is a diagram illustrating a platform architecture including a payment processor and a transactions layer.

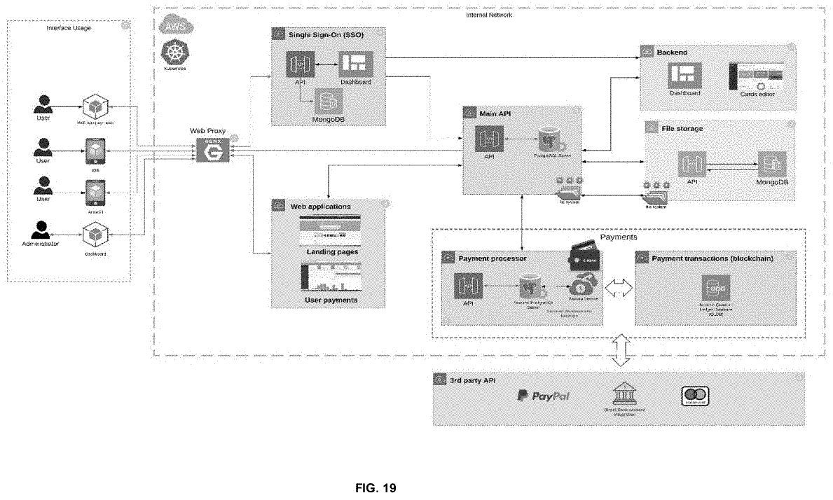

While the exemplary embodiments may be described in connection with certain embodiments, there is no intent to limit it to those embodiments. On the contrary, the intent is to cover all alternatives, modifications and equivalents as included within the spirit and scope of the exemplary embodiments as defined by the appended claims.

### DETAILED DESCRIPTION

These and other features and advantages are described in, or are apparent from, the following detailed description of various exemplary embodiments.

Phase I—Ethical Cryptocurrency

In an exemplary embodiment, the technology platform includes a cryptocurrency and an innovative social messaging framework that support and encourage ethical or cause-based organizations, or individuals engaged in ethical/social causes. The platform creates and maintains an environment that encourages users to engage in ethical/social causes. Specifically, when a transaction using a cryptocurrency is performed in support of an ethical cause, the party performing the transaction receives a “thank you” message (also referred to as “TCard”) that rewards that party's behavior. In exemplary embodiments, the TCard may be coupled to the cryptocurrency (also referred to as “Tcoin”) during the transaction, and a record of the cause-based transaction can be established. In exemplary embodiments, electronic contracts, i.e. “smart contracts” or “smart transactions” are provided herein. Smart contracts are decentralized autonomous procedures embedded in cryptocurrency and that couple conditions and actions. These conditions and actions can inspect associated event descriptions while referencing external resources and application programming interfaces (APIs, e.g., to validate an organization's identity or non-profit status) enabling the currency itself to ensure operational and aspirational constraints. The smart transactions can range from a basic invoice or other simple financial transaction, to complete smart agreements that are negotiated and/or executed electronically and/or that have their payment obligations paid e.g. at a pre-approved date/time, with blockchain digital currency in the private systems disclosed herein. The smart contract created during the transaction can also reference external resources and APIs, and to enable the cryptocurrency itself to ensure that the transaction is in line with the principles of the ethical cause. In exemplary embodiments, the Tcoin is a digital currency that uses cryptographic currency technologies to create a secure, persistent, distributed medium of exchange. In exemplary embodiments, the TCard is a social messaging framework that embeds Tcoins in messages to celebrate and encourage community service by expressing gratitude. The process of creating a TCard allows the generation of a Tcoin with a variety of value options such as, e.g., local currencies, other cryptocurrency, credit-card credit, other credit, and the like.

In exemplary embodiments, one or more Tcoins may be contained in a TCard. For example, TCards may be generated from social contexts and interactions, e.g., participants in a conversational thread might come together to send a TCard, the TCard containing one or more Tcoins. In embodiments, one or more Tcoins may correspond to a same TCard.

In a separate embodiment, in order to directly couple the cryptocurrency and the reward (TCard/Tcoin) for cause-based transactions, the Tcoin may be generated only through the process of creating the TCard. Specifically, a TCard may not be sent if it is not associated with a Tcoin value. Conversely, a Tcoin may not be used in a cause-based transaction without the coupled TCard, providing evidence that the Tcoin is involved in a cause-based transaction.

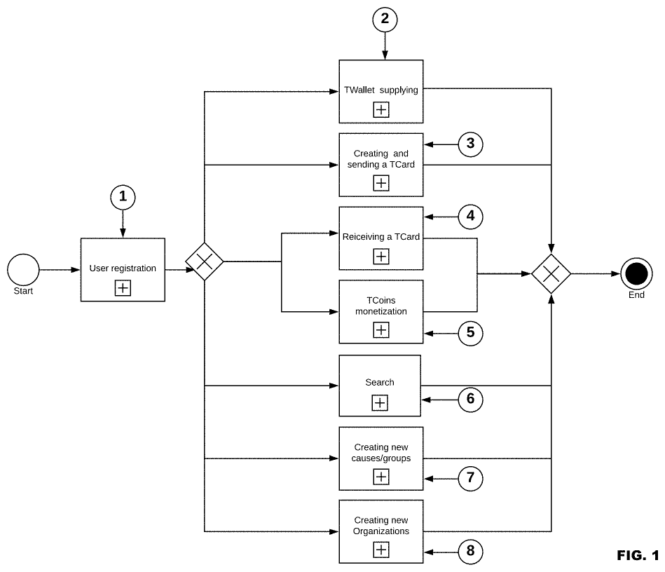

FIG. 1 is a flowchart illustrating a method of organizing an ethical cryptocurrency exchange, according to various exemplary embodiments. In FIG. 1, the method starts at Step 1 where a user is registered. Exemplary embodiments include user registration, account management, and/or invitation of a new user, and the registration of a new user may include providing the new user's name, contact information, organization to which they belong, cause in which they may be involved, and other identifying information. In exemplary embodiments, the user may be a person, a group of people, or an organization. At Step 2, a cryptocurrency wallet, herein referred to as a TWallet, is created for the registered individual, group of individuals or organization. The TWallet may be configured to hold the new user's Tcoins and TCards. Exemplary embodiments include supplying the TWallet account with Tcoins, creating and sending TCards with Tcoins, receiving TCards, and monetizing the Tcoins, i.e., exchanging the Tcoins for existing non-digital currency. At Step 3, a TCard is created, for example when the registered individual, group of individuals or organization sends a “thank you” note to a party as a reward for having performed a cause-related action or for having performed a cause-related transaction.

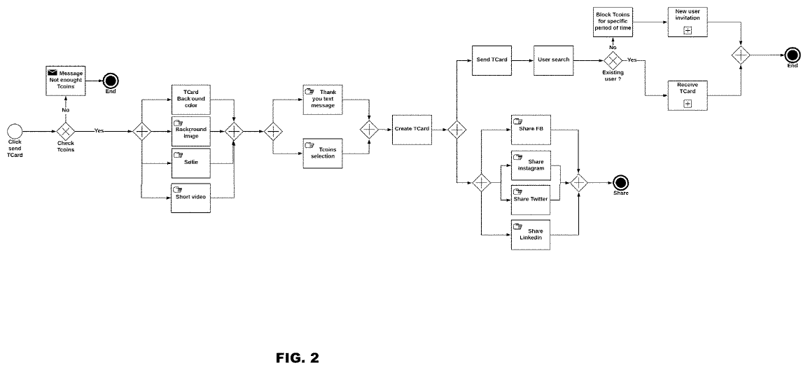

In exemplary embodiments, at step 4, one or more TCards may be received by the registered individual, group of individuals, or organization. Embedded in each of the one or more TCards may be one or more Tcoins that may be in the form of cryptocurrency. In exemplary embodiments, the embedded Tcoins may be exchanged with other individuals or groups for goods and/or services as long as the exchanged goods and services are consistent with the constraints and ethical boundaries of the ethical cause for which the TCards were sent in the first place. In exemplary embodiments, at Step 5, the TCards are monetized in the form of Tcoins, or exchanged for existing non-digital currency, as further explained with respect to FIG. 2 below. In exemplary embodiments, the method searches for new causes at Step 6 for which TCards may be sent. Additionally or alternatively, new causes or ethical actions may be created at Step 7. In exemplary embodiments, at Step 8, new organizations dedicated to accomplishing these ethical actions or causes may be created, and these new organization may be linked to new causes and to new users. In summary, exemplary embodiments include search of users/causes/organizations, set up of a group and management of TWallet group, and set up of an organization.

FIG. 2 is a flowchart illustrating a method of creating a TCard, according to various exemplary embodiments. In example embodiments, an acknowledgment or thanks for a given action is submitted. If the person or party submitting the acknowledgement or thanks does not have enough Tcoin in their account, then the acknowledgment or thanks cannot be submitted and a message is displayed informing them that they do not have a sufficient balance to submit the acknowledgment or thanks. In embodiments, if the person or party submitting the acknowledgement or thanks has enough Tcoin in their account, then they may be able to customize the TCard by, e.g., adding a background image corresponding to the specific image, adding a background photograph, a selfie, a video, or the like. In example embodiments, when the person or party has chosen an appropriate customization from the options above and more, the person or party can complete the TCard with an acknowledgement of thanks such as, e.g., a “thank you” note, and determine how many Tcoins may be transferred together with the TCard. As a result, a customized TCard has been created.

In example embodiments, when the person or party determines to a TCard, they may search whether the receiving party is already registered in the system. If the receiving party is already registered, then the TCard is sent to them. If the receiving party is not registered, a communication such as, e.g., a text message, an email, or other form of communication usable to send an invitation to the receiving party, may be sent to the receiving party. The receiving party may then undergo the registration process, after which the TCard may be sent to them. In example embodiments, if there is a delay between the creation of the TCard and sending the TCard to the receiving party, e.g., due to the receiving party not being registered in the system, the Tcoins of the person or party submitting the acknowledgement or thanks are frozen for a determined period of time until the receiving party is registered in the system at which point the TCard and the associated Tcoins, which were frozen, are sent to them.

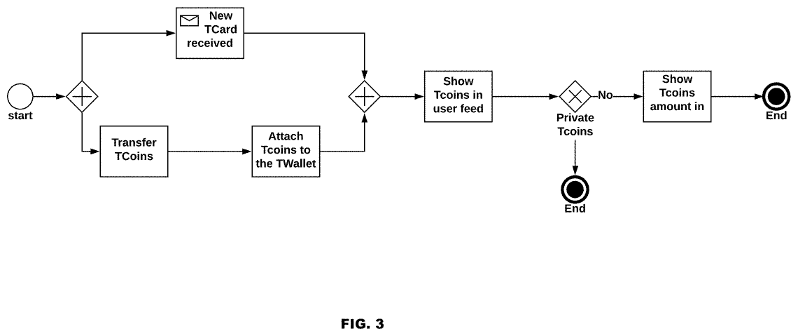

FIG. 3 is a flowchart illustrating a method of receiving a TCard, according to various exemplary embodiments. In exemplary embodiments, receiving a TCard by a receiving party may take place via a notification of the receiving party such as, e.g., push notifications via text messaging or email. Once the TCard is received, the Tcoins associated with the TCard are then transferred to the receiving party and added to the receiving party's TWallet. In embodiments, the Tcoins may not be visible in the receiving party's feed, or in the sending party's feed, if the Tcoins are exchanged under a private option. Otherwise, the Tcoins may be rendered public and may be displayed in the receiving party's feed, or in the sending party's feed, together with the corresponding TCard.

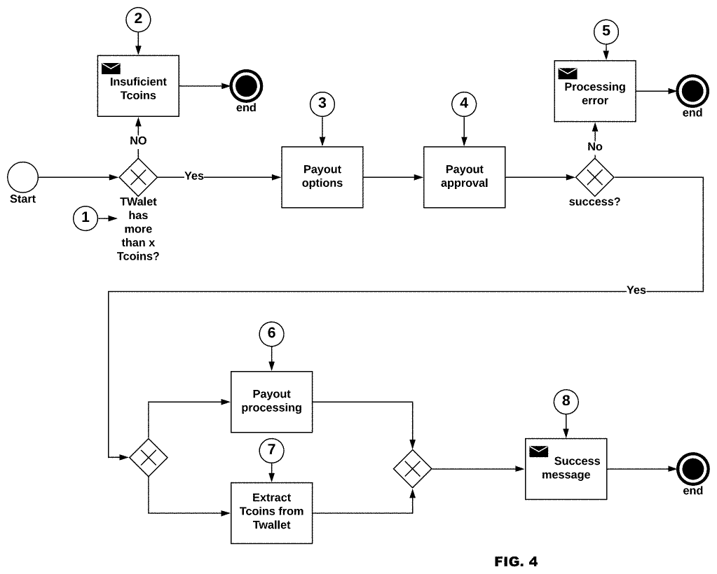

FIG. 4 is a flowchart illustrating a method of monetizing TCards, according to various exemplary embodiments. In exemplary embodiments, Tcoin monetization may be performed by checking the availability of Tcoins for payout at Step 1. In embodiments, when the user does not have sufficient Tcoins for a potential payout, a message stating the Tcoins insufficiency for payout may be provided at Step 2. If the user has sufficient Tcoins, the user may select a payout method at Step 3. In embodiments, when the method is selected, the payout may be approved at Step 4.

In exemplary embodiments, the user may face the following situations at the payout, each independent from the other: 1) a processing error message at Step 5, e.g., indicating that the Tcoins balance is insufficient, where the user may have to return to Step 1; and 2) the payout is successful, where Tcoins balance is reduced in the TWallet, and the equivalent currency is withdrawn at Step 6. After the withdrawal, a message on the successful payout may be displayed to the user at Step 7.

The following provides a greater discussion on blockchain technology as it applied to digital currency.

The Internet became the modern day “town square;” it's where people “walk”, shop, inspect, interact, deal, display and inevitably: transact: exchange trusted form of value. Today the vast majority of financial or value transactions rely on the platform of the various credit card companies, which have adapted their methods from the pre-Internet era. The popular credit card paradigm while omnipresent is also fraught with inconveniences, and risks. Credit card transactions involve exposure of the credit card data, which includes the card data, and any personal data used to verify the identity of the card presenter. All that data as it moves across the Internet's arteries, is subject to theft, and abuse. And thus by buying a $10.00 item on the Web, a credit card owner may risk his full credit line, should his card particulars be pilfered by a cyber-thief. Merchants in need of instant verification, keep their customers' data “close to the surface” where hackers can and do access them. Credit card purchase is traceable, and allows the credit card companies, and any government agency so empowered to build behavior profiles for the millions of credit card users, simply tracking what each user is buying. Credit card transactions are ill disposed toward micro payments, which may be quite popular on the Web. Also, the modern Internet dynamics features software applets which are in need of micro transactions carried out through pre-established rules, and without human intervention—hard to carry out with credit cards. When people access their credit card accounts, or their bank accounts, they are burdened with tedious and annoying identity-verification dialogues, which can be spoofed, and allow hackers to masquerade as their victims. These assorted difficulties and others have created the pressure to develop alternative ways to transact currency online. Merchants and sellers, as well as buyers are becoming quite creative financially, and they invent alternative currencies comprised of loyalty points, and other conditional payment instruments to guide and cajole the market to their interests. Years ago, initiatives, like DigiCash have attempted to mint digital coins for anonymous use on the Net. The initiative failed for coming on too early. Today there are various alternative-currency companies, and various payment platforms, which are generally an off-shoot of the prevailing credit card platform.

Exemplary embodiments include a set of complementary procedures (tools) to enable efficient and convenient transaction of value online. Value is abstracted in the form of money, which depends on mutual trust. Even gold, the early form of money, was not in and by itself a useful commodity: you could not eat it, not plant it, not build with it, nor haul with it; people accumulated gold only because they expected others to be willing to give something of practical value in exchange of it. By contrast, in a barter regimen, one peasant surrendered, say, three useful guard dogs, for one useful horse. When gold was exchanged for paper, the dependence on mutual trust grew even bigger, and the same for the current stage when money is about to assume the form of a bit string. Per se, a bit string is useless, and its only value is trust-dependent. And hence to run a transactional regimen online it is necessary to provide the trust, which for the first stage (where we are in), that trust may be provided by secure tie-in of the bit string to US dollars, or any other established national currency. Traders would pay dollars, receive a bit string, trade the bit string in their normal course of activity, then redeem any bit string in their possession against US dollars or other established currency. That is the bird's view of the emerging era of Internet transactions. In exemplary embodiments, a digital coin is defined, of any desired denomination, and is comprised of meta data describing various parameters thereof, and also describes the payload thereof, the string that would identify the value of the coin.

Exemplary embodiments relate to how the value of a digital coin is being expressed. In the nominal way the bit string expresses its value through the identity of the bit sequence. E.g. bit sequence: “1000”, means decimal 8, “1010” means decimal 10. Any other we part with the method, and rather use the size of the string, its bit count, as the expression of value. Thus if 1 US cent corresponds to 10 bits, then a US dollar may be expressed via a string of a 1000 bits. Any 1000 bits long coin may be associated with the value of $1.00, regardless of the identity of the bits. This implies that one could mint 2¹⁰⁰⁰ coins of $1.00 denomination. By so expressing value it is possible to mint a sufficiently large number of coins to be traded individually and distinctly much as paper dollars are. The identity of the coin may be expressed through the identity of its bits—as opposed to the value of the coin which is expressed by its size.

A given “mint” may thus be able to mint (issue) coins of varying denominations, and hand them over to online or off-line users who would buy such coins by paying the corresponding value in US dollars, or any other acceptable currency. Any trader who so purchased a digital coin would be able to transfer that sequence as a method of payment for any transaction he or she could make. Here we reach the point of trust. The payee may need to verify that the sequence of bits he is getting (the digital coin) is in fact redeemable. That is, he or she could approach the mint with that sequence, and receive the corresponding amount in US dollars. After all the payer could have minted his own coin, and falsely proclaim that it was minted by the mint. The way for the payee to verify the authenticity of the coin just paid is by contacting the mint and getting their assurance that the coin is valid, and that the user could redeem it anytime he wishes to. Here we come at the second element of exemplary embodiments. A trader verifying a coin could demand from the mint to exchange the verified coin with a new one (same value, different bit identity). The mint may then invalidate the verified sequence, so that if anyone checks on it, it would come back as ‘invalid’, (hence the payer cannot reuse the same coin again), and the verifier may get a brand new sequence for him to use. It's important to note that the mint (also referred to as ‘the bank’) would not have to verify the identity of the coin verifier. It would work like cash, the coin itself is verified, but its holder may remain anonymous. The very act of coin verification is the bottle neck of online transactions, because the transaction cannot conclude before the payee is assured that he was paid with a valuable coin. Exemplary embodiments include a mechanism to alleviate the burden of instant verification.

The reason that instant coin verification is a bottleneck operation is that all verifications may be handled via a single source. If, for example, two computer centers, that is, two authentication sources, may share the verification burden, then a wily user may be able to use each coin twice, once verified by one source, and the second time verified by the second source. With a single source, there is one database that identifies all outstanding coins, and each time a coin is being redeemed or exchanged, it is flagged as such, so that when queried again, it would be responded to as ‘invalid’. We refer to the database as the master coin database. Exemplary embodiments alleviate the single source burden by creating a verification or authentication hierarchy. The original single source (call it also the ultimate source of coin verification) may project into 2, or say n first level sub-sources. Each sub-source may receive a partial cut from the master coin database. The cut can be two ways. One: coin count. Every sub-source may receive some of the coins to construct its sub-database with. The other way is by divulging to the sub-source only some of the bit identities of each coin. So, if a 100$ coin is comprised of 100,000 bits, then the sub-source might be given the identity of say every other bit. So the sub-source may know 50,000 bits out of the 100,000. It is important to spread the known bits evenly across the coin, because it may be split off, and then for some coin section submitted for verification, the sub-source verifier may have no knowledge at all.

The arrangement may enable users to access any one of the n sub-sources for the purpose of coin verification, (instead of clamoring all onto the single source). When a trader approaches a sub-source for verification, then the following happens: the queried coin may not be included in the sub-source's database. In that case the sub-source may contact the single source, and pass the query request to it. Of course that may mean a greater communication burden as opposed to the trader directly querying the master source. It is therefore incumbent upon the designer of the system to minimize such occurrences. That is to say that a trader should be likely to query a coin with a sub-source that includes that coin in its database. An element of exemplary embodiments relates to how to insure that likelihood. If, on the other hand, the queried coin is listed in the sub-source database, then the sub-source could tentatively OK the coin as valid based on its knowledge of the identity of 50% of the bits (too many bits for chance matching). The sub-source may then send off that verification fact, along with the presented coin up the hierarchy to the ultimate source. The ultimate source may then examine the full bit image of the coin against its master database, and confirm the verification of the sub-source if all is well. Since the sub-source only knows the identity of say, 50,000 bits, and not all the 100,000 bits of the coin, it would be impossible for the sub-source to defraud the single source. Only a holder of that coin has the identity of all its bits. If we further insure that each coin may appear in the database of only one sub-source, and no more, then, it would be impossible for a trader to defraud the system. If a trader approaches a sub-source where the coin is not listed, his verification request may go to the single source, who would first notify the sub-source that lists the coin that it's no longer valid, and only then verify it to the trader. The may make the trader wait for a while for his verification. However if one manages to build a system whereby the majority of coin verifications happens between a trader and the sub-source that lists the coin then the burden of real time verification by the single sources is alleviated via n sub-source verification. (n+1) verification sources really because a trader could still approach the single source for verification, and the single source, in that case would notify the sub-source that lists the coin.

Each sub-source, in turn would be able to delegate its own verification authority further. Each of the new sub-sub-sources may be given the identity of only 25,000 bits of each 100$ coin, and the coins may be divided among the m sub-sub-sources under each sub-source. The number of known bits may be progressively smaller for each lower level of sub sourcing, but the number may still be large enough to prevent chance guessing.

The authentication of verification hierarchy could be designed to maximize the ‘hits,’ i.e., the number of times that a trader approaches the right sub-source for coin verification. So for example on entering a shopping center, a trader may exchange his $200 digital coin with one that is listed in the shopping center sub node. The exchange may be done through the shopping center sub node that would take the incoming coin up the hierarchy ladder until it finds the level where it can be verified. The verification notice travels down the hierarchy ladder to OK the incoming coin to the shopping center sub-source. The shopping center sub-source may then issue a coin of its own database (that is marked as unused, unclaimed, not yet in circulation) to the entering trader. Simultaneously the shopping center sub-source may send up the ladder the fact that his unused coin has been circulated. The trader then may have a $200 digital coin that they could redeem in any store in the shopping center, getting instant approval from the shopping center sub-source. Hence all the shopping done in that mall, could go ahead instantly even if the central financial computer (the ultimate source) is shutting down, or is too congested at the moment. The procedure enables asynchronic verification, because any sub-source authorizes a coin based only on knowledge of part of its bits. The authorization travels up to the single source ultimate verification at some later point in time. Should there be any mishaps, and the unknown bits don't match the single source listing, then the mint which takes its cut from every minted coin may take the loss for it. Since one could change the number of bits known to each level, it is possible to manage the off chance.

This size-based value of coins which enables the delegation of coin verification is also the foundation of the splitting option for each coin. A hundred dollar coin, comprised of 100,000 bits could be split into two $50 coins, each comprising half of the sequence, namely 50,000 sequential bits. The split can be at any ratio up to the smallest tradable denomination, say, for instance $1.00. A trader may be able to handle one large coin, say for $1000, and chop out of it strings corresponding to the amount to be paid. The data of the original coin that spawned the sub-coin may be carried in the split-off coins' headers as metatags. If the trader and the mint know each other then they could use symmetric cryptography to safely exchange coin information. If they don't know each other they can rely on asymmetric cryptography for that task. If, however a coin needs to be dispatched between two strangers, which are individuals without a published public key and a corresponding private key, then the coin could be exchanged.

The easy split feature of the digital coin offers easy, quick and automated transactions between ‘ agents’ rather than human beings. Case in point: a peer-to-peer (P2P) network, where nodes both give (resources, computation, storage), and take benefits (communication of data to a destination). The success of a P2P network depends on the fair participation of most of the nodes. Otherwise nodes may be switched on when they need the service of the network, and switch off when they are expected to contribute their services to the same. To combat the tendency, a size-measured, easy-split digital coin may be most appropriate. An originating node may attach a digital coin (size measured bit sequence) to a message to be P2P transformed. Each node that may supply resource services in the pathway of the message may be paid from the attached coin, according to some payment schedule. Hence a passing message may incur payment from the originator of the journey to all those nodes that supply services to it, which may allow for efficiency driven modification of routes. High capacity nodes might exact a higher price for their service. Such a paradigm of quick coin splitting may take place without constant and per-transaction verification of the coin. It would hardly be necessary because the nodes are there for the duration, and they need the network to function. And hence if some time later it appears that a particular node has cheated with fraudulent coins, that node may be cut out of the network which may deter most node operators from coin cheating. Also, the sums per transaction, or per millisecond, are very low, and since a fraud may be discovered soon enough, it does not pay to rob the software house which is supplying the P2P digital coin network. Governing rules may chop off the carried-on size-measured digital coin, and pay the servicing nodes according to preset rules of payment. Some provisions may be put in place what to do if the original coin is exhausted and the message is not yet fully delivered. Similar rules may identify how to split a coin if the message is split. Generally the original coin may be set high enough to support even a long and arduous communications path (many service nodes), with the balance transmitted back to the original node using, say, the central, network, “bank,” which serve as a coin management and mint center. Nodes that over used the system without being switched on sufficient time to collect credit may have either to purchase network money against a hard currency, like US$, or switch themselves on, compete on giving services (thereby making money) to be used for their own needs. The whole operation can be primed with a standard number of coins given to each node. The subsequent transactions may redistribute these bit currencies among the nodes. The network bit money may be either on a standalone basis, where there is no transfer of debit or credit from anywhere, or linked to another platform for automated payment, or perhaps tied in to US$, so that owners may be able to buy Internet money, and use it in a bidding game to get favorable advantages over high capacity nodes. As mentioned, the split-off of coins is straight forward, because the coin bit count expresses its value.

Transacting digital goods is a special case for bit currency. By using the currency as an encryption key, the buyer may submit the coin header (from a coin in his or her possession) to the seller. The seller may send the header along with the goods to be sold to the Mint (that issues these coins) to be encrypted. The digital goods are thus encrypted with the contents of the coin, the buyer claims to possess. The Mint may send back the encrypted goods to the seller, and he, or the Mint directly, may send the encrypted file to the buyer. The buyer may use the contents of his coin as a key to decrypt the goods and enjoy its value.

The notion of encrypting digitized goods may be readily applicable for instances where an intermediary is managing a file transfer regimen. Companies, like Pando Inc. offer users to send large files from one to the other. The files are controlled, and managed, by the Pando servers. The man-in-the-middle transfer may be used as follows: The sender sends the file to the receiver using a file intermediary like Pando. The intermediary encrypts the sender's file before releasing it to the recipient. The recipient sends the intermediary the received file hash value (its digital signature). Once the signature is verified by the intermediary, it checks for certain delivery conditions, and if fulfilled, the intermediary sends to the receiver the decryption key to decrypt the file in his possession. (All that is managed by software). The intermediary then sends the sender a certificate of receipt of the file. The receipt is based on the examination of the hash value, proving that the encrypted file was received all right. The conditions for the intermediary to send the decryption key to the receiver may vary. They may be a verification that the payment for the goods was made. The intermediary could serve as a mint, or rely on the services of an external mint. Once the receiver sends the coin to the intermediary, to pay for the digital goods, the intermediary verifies that the coin is good, cut from it, its own service fee, and send the balance to the benefit of the sender. Normally a sender may have an account with the intermediary, and the payment from the receiver may be channeled into that account. Other conditions may involve some declaration on the part of the receiver for proper use, for not transferring further (respecting digital rights) and the like. The procedure offers the sender a silent proof of receipt. The might be significant in some business climates. The conditions for the transaction could work either way. The recipient too could withhold his sending of the hash value until the sender makes certain warranties, like the fact that the file is owned by the sender or is public domain, or that the file does not contain private information, lewd material, and the like.

Traditional currencies included coins having intrinsic value (e.g. gold, silver, and copper). Paper currency was traditionally issued by centralized issuers and was backed by reserves having intrinsic value (e.g. the ‘gold standard’). In the 20^{th} century, the modern central banking system was developed and most official currencies were removed from the gold standard and/or backed by a fractional reserve system. Such “fiat money” was controlled by the central banks that issued it. Over the years, various private parties have developed various private currencies, scrip, coupons, and such as alternatives to official currencies. However these were only available for limited purposes and their distribution was also limited. Since the widespread availability of the Internet and the worldwide web, some of these were effectively made available as ‘virtual’ currencies, but they still had very limited or specific uses and distribution. In the last decade or so, digital currencies and cryptocurrencies, have emerged. Some of these currencies have had appeal for a number of reasons including their potential for privacy, security (provided via digital footprint), and independence from central banks and governments. These currencies can also offer resistance to arbitrary inflation. These digital currencies represent an electronic store of value that have lately become a growing alternative to traditional real world currencies. Among the most popular or well-known digital currencies is Bitcoin, however there are at present hundreds of cryptocurrencies that have been developed over the last decade.

These currencies and the transactions based on the currencies can be secured by information that is kept and/or recorded in a database called a blockchain, which provides a verifiable public ledger. The security includes e.g. a timestamp for each event and a digital hashtag to ensure integrity of the blockchain. The information can include details about the currency and specifics about the transfer thereof from, e.g., a payer to a payee. The blockchain database typically includes a distributed or peer-to peer feature, with a plurality of nodes on a network to validate and record transactions, and verify any modifications to the blockchain, where the modifications are in turn shared and validated independently to ensure and verify the ownership of currency. Because of several, if not all of the foregoing features, such cryptocurrencies have often been attractive to criminal elements, and resisted by or repugnant to governments and central banks. Transactions that provide anonymity and such ease of transfer can avoid any oversight or control, by-pass the banking system and laws, and avoid taxation.

Notwithstanding these concerns, because of their rising popularity, in the last few years many businesses, including many online and traditional retailers have begun accepting e.g. Bitcoins for some transactions. Some banks and non-bank financial services companies began providing or enabling exchange and services. The tide continues to turn and governments, banks, and other non-bank financial services have realized that they too may be able to take advantage of many of the features of such currencies in the right circumstances.

Existing cryptocurrencies are generally decentralized. Rather than being minted or created by a central bank and based on a reserve or fractional reserve, new cryptocurrency “coins” are typically created by a process called mining which involves searching, e.g. for specific solutions to a complex mathematical formulation, or numbers meeting specified criteria, typically of increasing complexity. Each solution discovered represents a unique coin of value, and that unique information helps to identify the currency in the blockchain. The nature of the method of currency creation means anyone with sufficient computing power can create new currency, which has an inflationary effect, albeit one that is controlled by the rate at which new solutions can be found, also referred to as “mined” and/or the maximum number of solutions that exist for any given cryptocurrency. Moreover, most existing cryptocurrencies are not readily converted to cash, or exchanged in the various foreign exchanges, but banks and non-bank financial services firms are gradually adapting. While currency mining creates opportunities for independent/private businesses, it effectively cuts out the financial institutions. In addition, because of the completely decentralized creation process, the security of the cryptocurrency itself is to a greater or lesser extent offset or put at risk by the vulnerability of miners, digital exchanges, and other parties to malevolent electronic activities.

Governments have begun to publicly recognize certain limitations to traditional physical currencies, not limited to the expenses of printing, minting, maintaining, and circulating such currencies, providing equal access to the currency and banking systems, and collecting taxes from unreported transactions, e.g., unreported transactions, and underground economy including ‘under the table’ paid work, as well illicit activities.

The existence of a large unbanked population that does not participate in conventional banking is often the result of lack of available banking services in unserved or underserved communities. The unbanked culture creates multi-faceted problems, including an underground cash economy, and a disparate economic reality for people who are excluded from the system. In order to overcome some of the challenges or shortcomings of traditional physical currencies, including providing enhanced or improved access to the unbanked, proposals are being made to consider use of cryptocurrencies, or to create and test their own cryptocurrencies. Several jurisdictions, including India and the European Union are looking at proposals for actually becoming cashless.

Exemplary embodiments include a system and method for the secure storage, payment and credit lending of digital currency or crypto-currency that uses traditional credit cards and debit cards for the convenient payment of goods and services from merchants in fiat currency, and automatically withdraws the converted funds from digital currency assets stored in a highly secure online digital wallet account. Digital currencies or crypto currencies have recently emerged as an alternative to traditional “fiat” currencies and credit/debit card payment infrastructure. Fiat currencies typically represent the tradable currency of a particular nation such as the US dollar, or a group of nations such as the Euro. Trade in fiat currencies suffers the disadvantages of value manipulation by government, bank account fees, transaction fees and taxes, and a lack of privacy or anonymity. The involvement of traditional banks in the process dramatically slows transaction speed and increases costs for the customer. Moreover, it is unnecessary from a technical point of view, given the instant world-wide online access now available to most banking customers via their internet-connected computer or mobile phone device. Digital currencies have the potential to displace traditional banks from online banking and international banking markets.

The recent advent of digital currencies is primarily due to the desire for a fast, secure, transparent, easily tradable international currency that can be safely and instantaneously transferred online between users, is immune to manipulation by governments, involves no bank fees and provides increased privacy and anonymity for both the customer and vendor. Digital currency accounts or wallets have great potential to displace credit card and debit card accounts for many everyday transactions due to their lower cost and potentially safer use online. Digital or crypto currencies are typically valued on the transaction volume of the currency with each and every transaction being stored on a transaction ledger or software block-chain and validated by a peer-to-peer distributed network of computers. Using such a distributed network to validate every transaction prevents double payments, ensures a high level of security against transaction fraud and removes the need for trust in a third party to validate transactions.

The exchange value of a digital currency into a fiat currency may be determined purely via the laws of supply and demand. Some digital currencies such as Bitcoin supply new currency via the use of networked computer processing power to verify every transaction and manage the network in a process called “mining” that rewards block-chain validation with new currency. Demand is typically achieved via the analysis of the volume of all currency transactions. In an exemplary embodiment, all transactions are recorded in multiple nodes of a distributed network of computers or servers that simultaneously determine the instantaneous value of the currency at any one time. The value and date of every digital transaction is completely transparent because it is used by the entire computer network to determine the currency value and requires a majority of nodes to be validated. The results in vastly increased levels of security against transaction fraud, as the value and date of every transaction is ultimately verified on every computer on the network. However, the identity of both the customer and merchant, or the transmitter and receiver, may only be known to themselves. Consequently, digital currency transactions are fast, secure, private and free of taxes and large bank fees.

A major problem facing mainstream adoption of digital currencies arises from the requirement for both parties involved in a transaction to use digital wallet software that consist of encoded public and private key software. The means that vendors or merchants need to have their own digital currency wallet and online payment processing system in order to accept payments in digital currency from customers. Consequently, digital currency adoption is dependent upon its popularity and infrastructure adoption rate with merchants and vendors. The may take several decades to reach the merchant penetration rate of existing credit/debit card infrastructure. To circumvent the market barrier to widespread mainstream adoption, digital currency debit cards have recently emerged to provide a method for merchants to accept digital currency from customers using existing debit card infrastructure. Digital currency debit cards enable customers to spend digital currency from their digital wallet everywhere they can use debit or credit cards.

Digital currency debit cards require fast transaction approval that confirms the customers' account balance or spending limit as with traditional fiat currency debit card accounts. Furthermore, if the private electronic key for a digital currency account is lost, erased or stolen then the customer loses all their digital currency assets. Hence digital currency debit cards are typically designed in one of either two configurations to satisfy transaction approval requirements and asset security, namely (1) the customers' digital currency balance is stored locally on the debit card itself that acts as an offline or “cold” digital currency wallet, or (2) the customers' digital currency balance is stored online on a cloud-based server or “hot” wallet that can be accessed by the customer via computer or mobile device. The major drawback of configuration (1) is that the physical theft or loss of the debit card results in the total loss of all digital currency stored on the cold digital wallet. The major drawback of configuration (2) is that hot digital wallets are stored in mobile devices or on internet-connected computer servers that are highly susceptible to online theft from computer hacking and internet fraud. Moreover, if the private key of a digital wallet is stored on the customers' computer or mobile device, it is usually even more susceptible to online theft. Hence, the responsibility for digital currency asset security often lies entirely with the customer, which is a direct consequence of digital currency transactions having both public user anonymity and no trusted intermediary third party to validate transactions. Consequently, both configurations of digital currency debit cards typically only store small amounts of digital currency that the customer can top up from more secure cold wallets or digital currency vaults.

The inherent security drawbacks of existing digital currency debit card technologies mean that they are not suitable for credit card accounts where creditors or lenders may accept the potential losses due security risks instead of the customer. There currently exists no secure digital currency wallet solution that satisfies the security risk requirements of credit lenders and the technical requirements of existing credit and debit card infrastructure. Consequently, digital currency credit card products have not yet emerged in the market because of the significant potential for loss, fraud or theft of digital currency. There exists significant demand for a digital currency credit card product that requires no upfront funds from the customer, can be used for large transaction amounts, and can be reversed or repudiated by the customer in cases of non-delivery by merchants or vendors, unlike digital currency debit cards transactions which are typically non-reversible. However, a digital currency credit card product requires significant digital currency assets or credit for lending to approved customers and a more secure digital currency wallet technology than is currently available with existing digital currency debit card products. For digital currency adoption to rival traditional fiat currency as a payment method, a highly secure digital currency credit/debit card and online wallet technology may be advantageous.

Exemplary embodiments include a system and method for an automated online digital currency payment, storage and credit lending platform that incorporates a cryptographically encoded or spliced/paired digital wallet account for the secure storage of all digital currency assets, traditional credit/debit card infrastructure for payment transactions in fiat currency with merchants, and a distributed peer-to-peer network of lenders to provide credit lending facilities to credit card customers. Exemplary embodiments also include traditional credit and debit card payment platforms with the secure online storage of digital currency in a spliced/paired digital wallet design. In addition to debit card accounts with highly secure digital currency storage, customers can also apply for credit card accounts with borrowed funds supplied through a distributed network or pool of lenders or investors. The pool of lenders or investors may, although not limiting the exemplary embodiments, include the pool of customers who have digital currency assets stored in a debit card account encoded within the proprietary spliced/paired private key software code. The card issuer or vendor of the digital currency payment, storage and lending banking platform has the ability to charge fees for services including, but not limited to, payments and transactions, secure currency storage, account management and credit management services. One consequence of the exemplary embodiments is that instead of being responsible for their own digital wallet asset security, the customer may entrust that responsibility to the spliced/paired wallet technology and the credit/debit card issuer, wallet vendor or digital currency bank.

Ease of use and asset security levels offered by digital currency wallet technology is critical to the commercial feasibility of vendors to be able to offer customers digital currency credit cards, debit cards and other digital currency banking products. Conventional digital wallets, such as online Bitcoin wallets, typically comprise, but are not limited to, a private software key in excess of fifty characters long and a shorter public key or address around thirty characters long. The private key is required to access or use digital currency assets stored in accounts associated with the public address. Theft or loss of the private key typically results in the permanent loss of all digital currency assets. However, loss of the public address is not detrimental as it can be recalculated or reformulated using the private key. Regardless of whether the private key is retained by the customer, the wallet vendor or both, if it is stored on any server, computer or mobile device that is connected to the internet it is vulnerable to online theft or loss. Consequently, conventional online digital wallets are susceptible to internet theft, loss or deletion of the private key information, which in practice commercially limits the amount of digital currency typically stored in an online wallet or debit card device. Although debit card accounts can be regularly topped up from safer offline digital wallet accounts, the limitation adds significant inconvenience to the customers, discourages use for larger transactions and makes digital currency credit card products too risky for credit card issuers and banking vendors.

Exemplary embodiments incorporate a digital wallet technology that can be described as a spliced/paired online wallet technology. In contrast to conventional online digital wallets, the novel spliced/paired digital wallet design involves the private software key being separated or spliced into two separate smaller keys that can only access the contents of a digital wallet when paired together, but cannot access a digital wallet separately by themselves. The concept is for the customer to retain one spliced private key and the card issuer, wallet vendor or digital bank to retain the other spliced portion of the private key for trusted payment processing and storage backup services. Most of the time, when a transaction is not being executed, the spliced private key information stored on either the vendors computer server or the customers computer device is entirely useless to an online thief or computer hacker who is successful in penetrating computer security. The two spliced keys are only ever susceptible to online theft when they are temporarily paired together as a result of the customer executing a digital currency transaction via a credit card, debit card or software program that connects to the vendors' online platform server via the internet.

In exemplary embodiments, the paired private keys that temporarily exist on the vendors online server during transaction processing may also be stored as a back-up on the vendors offline server platform, cold wallet or digital currency vault which is never physically connected to the internet. Consequently the customers' digital currency assets can be fully protected against both online theft and loss. If the customer loses their spliced key information via the physical loss of a computer or mobile device, the accidental deletion of stored software files or the physical loss of a smart credit/debit card then the spliced key information can be restored on that device using the back-up paired key information stored on the vendors offline server network, cold wallet or digital vault. Consequently spliced/paired digital wallet technology represents a significant enhancement or improvement in the security of digital assets against both theft and loss compared to conventional digital wallet technology. The dramatic reduction in risk for an online digital wallet technology in turn enables credit card accounts to be attractive and commercially feasible to vendors, credit card issuers, lenders and even investors. Furthermore, the risk profile of digital currency credit card products for the vendor in the exemplary embodiments may be reduced or eliminated when the funding of credit lending facilities is outsourced to a distributed peer-to-peer network of credit lenders and investors managed by the vendors online server network. The network of investors and lenders to credit card customers may include the vendors own debit card account customers as well as external investors and investor pools.

In exemplary embodiments, a secure digital currency storage, payment and credit lending platform is provided to customers by a digital currency card issuer, banking institution or wallet vendor; and may include distinct components of hardware and software, namely (1) a digital currency debit card issued to customers by the vendor, (2) a digital currency credit card issued to customers by the vendor, (3) a vendors online server platform that stores the vendors spliced private key information and runs the vendors software engine, (4) a vendors offline server network, cold wallet or digital vault that securely and regularly stores updates of the back-up copy of the paired private keys, (5) a customers' portion of the spliced digital currency wallet account software stored on customers smart credit/debit card, computer, tablet or mobile device, (6) a software database of the vendors portion of the spliced digital currency wallet for all customers stored on the vendors online server platform or network, (7) a vendors software engine that performs customer validation, transaction validation, key coding/decoding, key splicing/pairing, account updates, payment processing, currency conversion, back-up file creation, and (8) a vendors peer-to-peer lending network that connects potential credit card customers with a pool of digital currency lenders and manages all customer credit card application approvals, contracts, fees and interest charges on behalf of the pool of lenders and investors.

In exemplary embodiments, the vendors offline server platform may also be used to store and validate customer card account balances and interface directly with credit card associations, which may have enhanced or improved credit/debit card security benefits over the first embodiment.

In exemplary embodiments, the vendors database of spliced portions of customer private keys and user account information may exist as a software block-chain that is stored on a large distributed peer-to-peer network of customer computers instead of the vendors online server network. The configuration may provide advantages in terms of providing an increased level security against theft or fraud over conventional digital wallets, without customers having to place total trust in the vendor for digital asset security. Nonetheless it may not have the same security levels offered by the first embodiment.

In exemplary embodiments, the customers debit cards and credit cards may use smart card technology with embedded integrated circuitry. In the case, the customers' spliced private key may be stored and updated directly on the card when being used for fiat currency transactions for faster transaction approval and processing at the time of the purchase. The embodiment may provide enhanced or improved customer convenience and use because it reduces the need for online transaction validation via the customers' computer, tablet or mobile device.

In exemplary embodiments, the customers debit cards and credit cards, or the first and second components, utilize traditional credit card technology with magnetic stripes. In the case the transaction is approved at the time of the purchase but processing of the transactions are handled in batches requiring for online transaction validation via the customers' computer, tablet or mobile device, which offers the customer the added security option of confirming every transaction via computer or mobile device.

Advantages of the exemplary embodiments include increased online security of digital currency assets, the use of digital currency for both credit and debit card transactions with any merchant or vendor that accepts credit or debit cards for fiat currency transactions, the use of computers or mobile devices with any merchant that accepts digital currency transactions, and the supply of credit lending funds to credit card customers using a distributed pool of investors and lenders. Vendors and credit card issuers also benefit from various embodiments of the exemplary embodiments due to the dramatic reduction of security risks associated with online digital wallets, the resultant increased commercially feasibility of digital currency credit card products, the ability to fund credit card lending using existing debit card customers and third party investors, and the increasing mainstream consumer appeal of easy-to-use digital currency banking products. Various other potential embodiments of the exemplary embodiments may be developed without departing from the scope and ambit of the exemplary embodiments.

In exemplary embodiments, the operator or owner of the exemplary embodiments, namely the card issuer and vendor of the digital currency banking platform, has the ability to charge customers fees for goods and services including but not limited to, credit and debit card devices, payments and transactions in either fiat or digital currency, secure digital currency storage, currency conversion and exchange, account management and credit management services. The vendor benefits from operating a profitable digital currency payment, storage and credit lending platform that contains very little inherent risk from online theft, fraud, loss or customer credit default. The customers benefit from access to a digital currency banking platform that is highly secure, easy-to-use, widely accepted with merchants, and for the first time offers customers digital currency credit card products. The credit lender, micro-investor or digital currency debit card customer benefits from being able to earn significant interest rate returns in digital currency from investing relatively small amounts in high return credit card investment products that contain a significantly reduced risk of loss.

Exemplary embodiments provide private permissioned systems using blockchain digital fiat currencies that are established and controlled by agreement of a group of financial institutions who are authorized to circulate electronic representations of real world currency useful in a variety of financial transactions including but not limited to consumer-to-consumer (“C2C”), consumer-to-business (“C2B”), business-to-consumer (“B2C”), and business-to-business (“B2B”). In various embodiments, the participating financial institutions comprise qualified banks and other (nonbank) financial services companies. In one embodiment, the financial institutions have their own virtual accounts and can hold minted in-circulation digital currency in their own virtual accounts. Exemplary embodiments further include a plurality of virtual bank accounts, virtual credit accounts, and virtual foreign exchange accounts. Each such account may be associated with a party who is a specific account holder that is a customer or consumer; a vendor, a merchant, a lender, or a borrower; or any combination thereof. Each account holder may have at least one account that is a virtual bank account, a virtual credit account, or a virtual foreign exchange account.

Methods are disclosed herein for transacting payments using blockchain digital currency in a private permissioned financial system. The methods including a) identifying a first party requesting a payment in blockchain digital currency in the system from a second party, and a second party determining whether to make a payment of blockchain digital currency to the first party; b) ensuring that at least the first and second parties each hold at least one virtual account in the system, and have a unique identifier within the system; c) providing each of the first and second parties with a digital signing key unique to that party for authorizing or approving a payment of digital currency in the system; d) establishing electronic communications between the first and second parties within or without the system to communicate regarding a payment of digital currency within the system; e) communicating an invoice or smart transaction from the first party detailing the specified amount of payment of digital currency requested; f) recording the invoice or smart transaction in a database in the system; g) receiving the invoice or smart transaction by the second party; and h) processing the invoice or smart transaction by the second party.

In exemplary embodiments, if the invoice or smart transaction is approved for payment; the method may further include signing the invoice or smart transaction in the database with the digital signing key and authorizing payment; followed by transferring the specified amount of blockchain digital currency from the virtual account of the second party to the virtual account of the first party; and recording the details of the approval, authorization, and payment in the database.

Exemplary embodiments include systems and methods for using digital blockchain currencies in conjunction with real world currencies, and a digital blockchain currency that can be conveniently incorporated into a new network of financial institutions as well as into an existing structure of central banking authorities and member banks. The systems and methods generally utilize a private permissioned network of financial institutions and utilize a digital blockchain fiat currency that is backed by a real-world currency. The systems and methods provide a wide range of functionality through the system, including via the use of e.g. multiple application programming interfaces (API) each of which provides further utility. Smart payments, including payments for invoices, contracts and other request for payments (generally “smart transactions” as defined herein) are also utilized in several of the systems and methods.

“Currency” as used herein means any money that is used as a store of value and medium of exchange in a particular nation, or between nations whether issued as notes or coins. Well-known exemplarys include but are not limited to the following Australian dollar, Brazilian real, British pound Sterling, Canadian dollar, Chinese yuan, European euro, Hong Kong dollar, Indian rupee, Japanese yen, Mexican peso, Russian ruble, Singapore dollar, South African rand, Swiss franc, and the U.S. dollar. In general, currency herein includes money that can be used as legal tender for payments. Currencies may typically be assigned value by fiat or by backing by a particular commodity (e.g. gold, silver, platinum, or other valuable commodity). In certain cases a currency may be specific to a particular merchant or vendor or a group of merchants or vendors (e.g. a group with a commonality such as a geolocation, (e.g. local town ‘bucks’) or a common industry organization, or the like). Such merchant-specific or merchant-issued ‘ currencies’ may be backed by something of relative value such as goods or services offered by a specific merchant/vendor, or group of merchants/vendors. In other cases, other merchants or vendors may accept such ‘ currencies’ by arrangement with this issuer. Exemplarys might include ‘ points’ issued by credit card companies, or frequent-customer rewards, or even ‘ cash-back’ points.

“Fiat” as used herein means ‘ by agreement or internal rule’. The value of fiat money or currency is typically set via a governmental law, rule, regulation, or decree. The value of such currency can likewise be changed by law, rule, regulation, or decree. Moreover the supply of fiat money can be altered by adjusting the amount in circulation. Such changes can result in inflationary or deflationary effects on economies using the fiat money, and in today's world, those changes are typically carefully managed controlled by central banks established for such purposes. Reliable fiat currencies are guaranteed by this issuer (i.e. the government). Loss of the guarantee, or loss of credit-worthiness of the government, or faith in the ability of the government to back the currency can result in collapse of the currency or hyperinflation. In contrast to fiat money, commodity-based money is backed in whole or part by a commodity whose value is readily determined, e.g. by its price on an open market. The value of commodity currencies can be pegged to the value of the commodity directly or e.g. via a mathematical formula. The value can thus fluctuate along with the market price of the commodity. In a pure commodity money system, any paper money that is in circulation may be fully backed by the commodity and historically paper money was freely exchangeable for e.g. gold (the “gold standard”). A coin in a commodity system is worth the face value on the coin, or has even greater value as the underlying metal from which it is made (e.g. gold or silver). A coin whose face value is not supported at least by the value of the metal from which it is made is fiat money. Thus, hyperinflation is nearly impossible in a gold-backed currency, because the commodity itself has underlying value. For purposes herein, the digital blockchain currency is a fiat electronic currency by virtue of the fact that the value thereof is linked by mutual agreement to a real-world currency. The currency may be referred to herein as virtual fiat money or VFM. In contrast, the real-world currency referenced and represented by the digital blockchain currency may be either a fiat currency or a commodity-backed currency. Thus, any requirement that the digital currency herein be a fiat currency is not dependent on the type or nature of the underlying real-world currency. For the sake of clarity, a digital currency that is created in accordance with the system and methods disclosed herein may still be referred to as a fiat currency or VFM, even if it represents or is backed by a reserve (e.g. a partial or fractional reserve) of commodity or commodity-based currency.

As used herein, “central authority” means a person, an entity, or a group of entities that has the ability and authority to issue digital currency in connection with the systems and methods disclosed herein. In various embodiments the central authority may be a private entity issuing currency to be used within a private system, such as a private permission-based network. In other embodiments herein, the central authority may be a central bank, or a governmental authority issuing digital currency for a country or a geographic or geopolitical region. A central authority hereunder can also be an entity such as a merchant or a bank or a private network that issues a private ‘ digital currency’ for its customers, or members or the like.

As used herein, “immutable” means that all prior ‘blocks’ on the chains (e.g. data entries, records, party IDs, timestamps, and the like) cannot be altered or modified by a party without permission. In general, there is no reason to ever alter or modify a prior block entry and no party is permitted to do so. The database itself can be “modified” by appending new data (e.g. blocks) to the chain. The blockchain may be encrypted (e.g. via a public (or shared/group) key) and can be viewed only by parties with “read” permission, and modified by only parties with “write” permission. In general modifications to the blockchain require a private key that specifically identifies the modifying party. In other words each new block on the chain is appended to the chain by a specific party who has permission to make the modification and the details of the modification (e.g. the time of such modification, the party making the change) are recorded along with the data entered in any newly appended block. Each party that has such a private key is limited with respect to the permissions granted that key. Keys and the permissions that are provided thereby may be revoked or inactivated at any time and the central authority and/or the network of financial institutions generally may establish rules and authority for securely managing keys in the system/network as well as procedures governing revocation of permissions and issued keys.

“Out-of-circulation” refers to the state of an electronic file or token that has been created and includes an intact blockchain, but which has not been placed into circulation in the system. In contrast to out-of-circulation currency, currency is “in-circulation” by a process of ‘ digital minting’ or creation when a participating financial institution that is a bank having permission to do so, modifies the blockchain of an out-of-circulation digital token by appending a new block which assigns, e.g., a real world currency and value to the token. The bank may generally place a corresponding amount of real world currency into an appropriate reserve account to back the digital ‘minting’ process. “Removal of digital currency from circulation” means removing some portion or all of a given amount of in-circulation digital currency and returning it to out-of-circulation digital currency. The blockchain would of course be modified to indicate the date on which the particular digital currency token was removed from circulation. The removal from circulation may be accompanied by the bank reclaiming or removing any real world currency placed in reserve in connection with the minting of the digital currency being removed from circulation.

The value of a given in-circulation digital blockchain token is stated as a number of “physical currency units” of the corresponding real world currency specified for that token. In an embodiment, the number of currency units are expressed as the number of “minimal physical currency units” in circulation for that currency. For example, if the corresponding real world currency is U.S. dollars, the minimal physical currency units are pennies, i.e. cents ($0.01). If, for example, the token represented US $1.08 the value would be expressed as 108 (cents). A token representing US $7897.23 would have a value key of 789723 (cents). In another embodiment, a fractional value of the “minimal physical currency units” in circulation can be transacted, such as when micropayments are required. An exemplary of such micro transactions would be a payment for a service or feature in the Internet of Things (IoT).

A “real world currency” (RWC) is generally a currency that currently exists or previously existed in at least one physical form such as coins or paper money. Real world currencies include both ‘traditional’ currencies used by any nation, e.g. as legal money, as well as digital currencies that are used as legal money or issued by any central bank or under the authority of any recognized government or the like. The skilled artisan may appreciate that in many modern transactions ‘real world’ currencies exist primarily as electronic currency—i.e. as represented by an account balance, an electronic transfer or payment of funds, transfers between clearing banks, and such. For purposes herein, currencies that have both a physical and electronic counterparts are ‘real world’. In contrast, private cryptocurrencies that are not in common official use by any country, or approved by any government as official currency, nor readily available at commercial banks are generally not ‘real world’ currencies for purposes herein, even if such currencies are accepted by e.g. some private vendors, merchants, or retailers. Moreover, as some countries are considering doing away with physical currency altogether in favor of digital currency, traditional currencies or real world currencies that do not have or no longer have a physical counterpart can also be ‘real world’ currencies herein, as well as any after-developed currencies that meet the foregoing definitions. As long as a currency is legal and can be held as reserves, then digital currency in accordance with the present system and methods can represented such currency and/or be backed by such currency.

As used herein, “transaction” means any financial transaction of any type or nature between two or more parties. Transactions include consumer-to-consumer (“C2C”), consumer-to-business (“C2B”), business-to-consumer (“B2C”), and business-to-business (“B2B”), as well as financial institution-to-financial institution, financial institution-to-consumer, consumer-to-financial institution, financial institution-to-business, and business-to-financial institution transactions. For purposes herein, a business can include a government entity that has financial transactions with consumers, other businesses, other governments, and financial institutions. Transactions hereunder are generally conducted via digital currency, but may include real world currency, combinations of digital and real world currency, or even exchange of goods or services, in part or whole, or in combination with real world or digital currency. Transactions can be conducted by payment by any means including point of sale and online transactions, paying vendors or merchants, collecting accounts receivable, borrowing, lending, foreign exchange, automated teller machine (ATM) transactions, clearing monetary transactions, and arrangements via ‘ smart’ electronic agreements.

“Payment” hereunder means completing a financial transaction or satisfying a financial obligation. In embodiments, payment is made within the system using digital currency. In various embodiments, a payment is made automatically or upon ‘ authorization’ by a party, for example upon approval of an invoice, a smart transaction or the like. It is understood that any party authorizing a payment can make that payment directly or indirectly. I.e. an approving or authorizing party may use e.g. a third party, an agent, or a proxy to make such authorized payments on their behalf. In embodiments, such third party has their own account (e.g. a virtual bank account (VBA), a virtual credit account (VCA), or a virtual foreign exchange account (VFX)) within the system from which to make such payments. In other embodiments the third party or agent has adequate permission to make payment directly from the approving or authorizing party's account.

A “key” as used herein sometimes refers to e.g. a key within the context of encryption and decryption, such as a public/private key pair. Keys are often required herein for functions such as accessing, encrypting, decrypting, viewing, appending and such with respect to electronic files, blockchains, blocks of data, and the like in the private system such as on networks, or in databases, or data that is passed peer-to-peer or received from another party in the system. “Key” also more generally indicates a means for providing digital access to a file, or a method of authenticating a party and an action taken within the system or with respect to a blockchain, block, data file, or the like. A key may represent or require a password, or other suitable indicia of permission to a party within the system. Key management includes issuing of permissions, passwords, digital access, and other authentication means (including biometrics). Key management further includes reaffirmation, revocation, reissuance and the like with respect to permissions, keys, passwords, digital access and the like. Key management is important for maintaining the high degree of confidence and trust among the parties in the private financial systems provided herein. Methods for key management in secure systems are known in the art. A “digital signing key” as used herein comprises at least a digital means of ensuring a party's identity and verifying that a file or data entry was created by that party, or that an action taken was in fact taken by that party. The strength of the digital signing keys may correspond directly to the confidence that the key represents the party and that use of the key is an authorized action of the party to whom the key belongs.

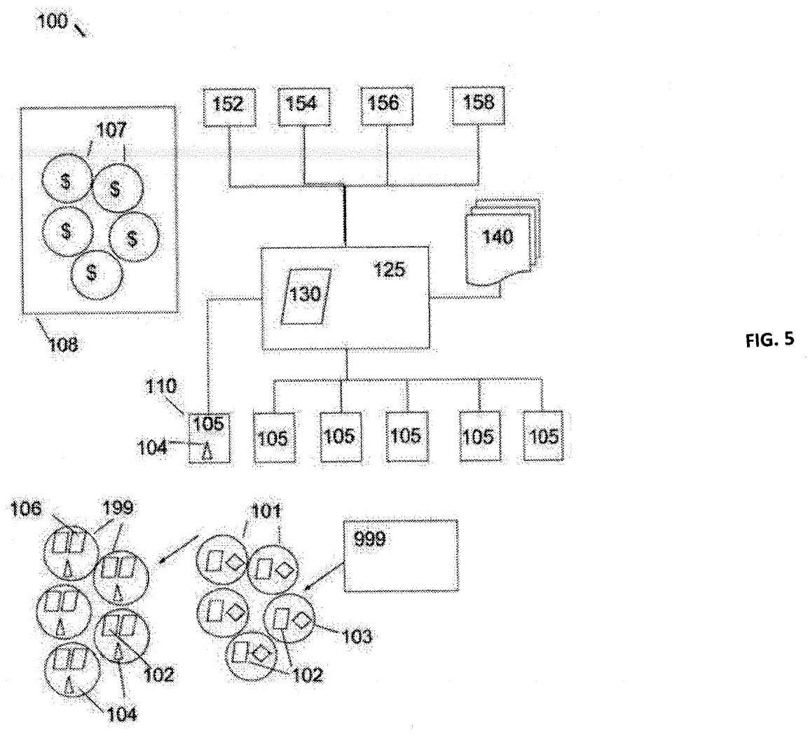

The foregoing systems can be better understood with reference to the figures. FIG. 5 shows an overview of an embodiment of a hybrid system in accordance herewith. As can be seen, the central authority 999 has the sole authority to create out-of-circulation tokens 101. The out-of-circulation tokens 101 comprising a blockchain 102 are only accessible by the financial institutions 105 that are qualified banks 110. A qualified bank 110 wanting to put digital currency into circulation for its own needs or to fulfill a request from a customer can place an amount of real world currency 107 in a reserve deposit 108. The bank 110 can verify that the out-of-circulation token 101 is authentic via a digital security means 103 such as a hashtag or the like, and can use its digital minting key 104 to digitally mint in-circulation digital currency 199 in proportion to the amount of real world currency 107 placed in the reserve deposit 108 by appending an in-circulation block 106 to the blockchain 102.

System 100 is a hybrid currency system featuring both private permissioned digital fiat currency and traditional real world currency. The system features network 125 comprising a plurality of servers (not shown) with connections to each of the financial institutions 105 and a distributed database 130. A group of software modules 140 can provide many additional functions such as minting, acquisition, redemption, clearing, foreign exchange services, credit and lending services, automated teller access functions, peer-to-peer transactions, token splitting functions, key management, and more.

The system further comprises a plurality of customers 152, consumers 154, vendors 156, merchants 158—each of whom hold accounts 160 in the system 100. The private network and the database are only accessible to such parties with permission. Various parties within the system may have different levels of permission for different functions and uses of the in-circulation digital currency 199.

Another embodiment includes methods for implementing and using a private permissioned blockchain digital fiat currency. The methods generally involve establishing a central authority to issue a plurality of electronic tokens representing blockchain digital currency that is out of circulation in the system (“out-of-circulation tokens”). The out-of-circulation tokens have zero value, and each token comprises a blockchain that initially includes an “out-of-circulation” block comprising a plurality of the following data: i) a real world currency ID key; ii) a null issuing financial institute (FI) key; iii) a null issue timestamp; iv) a null party name ID; v) a null party account ID; vi) a null party ‘transfer to’ timestamp; and [0305] vii) a value key wherein the quantity is zero. The out-of-circulation tokens include unique digital security feature(s) generated by the central authority on each out-of-circulation token to ensure security, traceability, and authenticity for that token. The tokens can be encrypted with public keys such that only qualified banks can access the out-of-circulation tokens. Digital signatures, digital fingerprints, hashtags or the like can be used to ensure authenticity.

The methods comprise recruiting or getting a plurality of financial institutions to become parties by mutual agreement to a private permissioned network in connection with the digital fiat currency. The central authority establishes unique permissions for each of the financial institutions to identify each such financial institution in the system. For each participating financial institution that is a qualified bank (as determined, e.g., by agreement), the central authority generates a unique public/private mint key pair that allows the bank to digitally mint in-circulation digital currency by modifying the blockchain of out-of-circulation tokens by appending an in-circulation block on to the blockchain, notwithstanding the unique digital security features on the out-of-circulation tokens. The skilled artisan may appreciate that the central authority may use a single public group key that may enable each of the banks to use their own private key to digitally mint currency as set forth herein. Thus while each bank may have a unique private key for decrypting, and a public key for signing or authenticating documents signed by the bank, the central authority may have a public group key that can encrypt the tokens in a manner that only financial institutions that are banks can decrypt the blockchain and append data to it in the manner required to mint in-circulation currency from out-of-circulation tokens.

The exemplary methods further comprise the step of providing a plurality of private servers. Each server comprises 1) non-volatile computer memory storing: i) one or more distributed databases comprising: a) the out-of-circulation tokens; and b) the in-circulation digital currency in the system; ii) executable computer code/computer readable instructions sufficient to limit access to the blockchains for out-of-circulation tokens to public/private mint key holders, to allow said key holder to append an in-circulation block to the keychain to digitally mint in-circulation digital currency; iii) executable computer code/computer readable instructions sufficient to allow the blockchains of in-circulation digital currency tokens to only be modified by public/private decryption key holders with sufficient permissions, and to append new blocks to said blockchains; iv) executable computer code/computer readable instructions sufficient to accurately store each blockchain so modified in the databases; v) executable computer code/computer readable instructions sufficient to create and store a unique timestamp corresponding to each such blockchain modification; and 2) one or more processors capable of executing the code; and a network is established among the private servers, and connections are created between the private servers on the network. The network includes means for distributing the databases between the servers. The connections can comprise private peer-to-peer connections, or other private permissioned connections. In some embodiments the servers provide an electronic portal for accessing the databases. Out-of-circulation tokens are accessible only to the financial institutions (e.g. qualified banks) having permission to access those tokens. In-circulation digital currency tokens are initially accessible only to the financial institutions having permission to access those tokens.

For each bank electing to digitally mint an amount of in-circulation digital currency, the bank undertakes the steps of: 1) reserving funds in proportion to the amount of in-circulation digital currency the bank elects to digitally mint; 2) digitally minting the amount of in-circulation digital currency by modifying the blockchain for one or more out-of-circulation tokens by appending thereto an “in-circulation” block comprising a plurality of the following data: i) a real world currency ID key; ii) an issuing financial institute (FI) key; iii) an issue timestamp; iv) a party name ID; v) a party account ID; vi) a party ‘transfer to’ timestamp; and vii) a value key specifying the value of the token expressed as the number of “minimal physical currency units” in circulation for the corresponding real world currency; and 3) repeating steps i(1) through i(2) each time the bank elects to digitally mint an amount of in-circulation digital currency. After out-of-circulation tokens are created and in-circulation digital currency has been digitally minted, the method involves allowing a party that is a financial institution, customer, consumer, vendor, merchant with permission to use the in-circulation currency in one or more transactions in the private system. In each instance, the method, being blockchain-based, comprises faithfully/accurately recording the details of the transactions in one or more blocks appended to the blockchain, providing timestamps and ensuring the integrity of the blockchains.

The methods allow a private network of financial institutions together with a central authority, such as a central bank, to issue, utilize, and control a blockchain digital fiat currency that works seamlessly in conjunction with a real world currency, and which can be readily redeemed or otherwise exchanged for real world currency, or which can be used for electronic transactions and electronic contracts of all types including sales, purchases, lending, foreign exchange and more. In combination with blockchain digital currency and the electronic smart transactions provided herein, the methods comprise a powerful method that allows financial institutions to benefit from many of the advantages of blockchain digital currencies while avoiding the pitfalls. The method is trust-based and permission-based such that specific parties have specific roles, and specific privileges within the private network.

The participating financial institutions in the private network generally comprise banks and nonbank financial services companies. In an embodiment, the methods involve a full reserve of real world currency, i.e. the total amount of in-circulation currency in the system is equal to the total reserved funds held by the banks.

In an exemplary, embodiment the method further includes providing computer readable instructions stored in the non-volatile memory for one or more of the following functions: a) digital minting of in-circulation digital currency from out-of-circulation tokens; b) acquisition of in-circulation digital currency tokens in exchange for real world currency or traditional electronic funds denominated in real world currency; c) redemption of in-circulation digital currency in exchange for real world currency or traditional electronic funds denominated in real world currency (with or without subsequent removal of or some or all of the in-circulation digital currency from circulation); d) bank to bank clearing of in-circulation digital currency in exchange for real world currency or traditional electronic funds denominated in real world currency (with or without subsequent removal of or some or all of the in-circulation digital currency from circulation); e) peer-to-peer payments between any two or more parties in the system; f) peer-to-peer electronic contracts and data exchange between any two or more parties in the system; g) vendor invoices via peer-to-peer smart transactions data exchange, and payments between a vendor and one or more parties in the system; h) vendor refunds via peer-to-peer smart transactions data exchange, and payments between a vendor and one or more parties in the system; i) merchant transactions via peer-to-peer smart transactions data exchange, and payments between a merchant and one or more parties in the system; j) merchant refunds via peer-to-peer smart transactions data exchange, and payments between a merchant and one or more parties in the system; k) person to person transfers of in-circulation digital currency (for example via peer-to-peer smart transactions with optional “IOU” payback agreement); l) same party account transfers for transferring in-circulation digital currency; m) a lending marketplace for matching borrowers and lenders of in-circulation digital currency via peer-to-peer smart contracts and data exchange; n) a foreign exchange marketplace for exchanging in-circulation digital currency denominated in a first real world currency for in-circulation digital currency denominated in a second real world currency; o) automated teller machine deposits and withdrawals (including “human” as well as machine based ATMs via peer-to-peer smart transactions data, and digital currency value exchanged for real world currency); p) invoice factoring (e.g. via peer-to-peer smart contracts, data, and digital currency value exchange); q) collections of vendor invoices or debts via peer-to-peer smart contracts, data, and digital currency value exchange; and r) dispute resolution.

In embodiments, the foregoing functionalities are provided through one or more software modules, APIs, or the like providing useful additional functionalities to the system and designed to allow the functionality to be easily implemented into e.g. applications to be used by various parties, in accordance with their permissions.

In various embodiments, the methods further comprising the step of compensating the financial institutions through transaction, subscription, and other banking and financial services fees. Because the blockchain digital currency is created by fiat and not mined, it is not possible for financial institutions to be compensated through fees for mining or creating the digital tokens representing in-circulation currency. In another embodiment, the financial institutions may otherwise realize value from anonymous use of their customer transaction data and/or in uses of customer's data for the specific benefit of the customer for which the customer may also pay a fee to utilize.

In one embodiment, the one or more distributed databases further comprise a transaction database that comprises electronic transactions or contracts defining transactions between parties involving the in-circulation currency and which track the transaction details and provide an audit trail of the transaction and the in-circulation currency in connection therewith. In one embodiment, creating connections between the private servers on the network further includes creating sufficient network connections to provide access to the transaction database to the parties to the electronic contracts. Access to such transaction may be limited to the parties who are directly involved in the transactions or contracts.

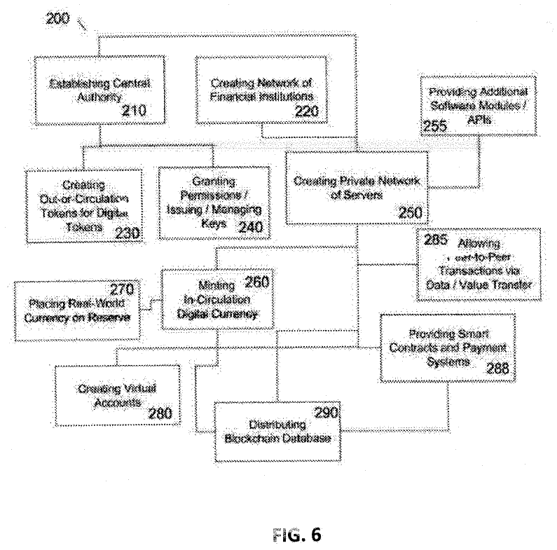

FIG. 6 shows a flowchart of an embodiment 200 of the general method described above. As the skilled artisan may recognize, the methods involve the interconnections of many aspects of a complex system and thus the order of the steps of the and any method disclosed herein can generally be altered except where one step reasonably requires a predicate or a prior step to be carried out first. Unless the order of steps is strictly required, they steps and relationships depicted or exemplified should not be deemed to be presented in any particular order of preference but can be varied where useful. Similarly, except where apparent from the context of the step, the brief terminology or short description for the various steps is intended to be general and not limiting.

As can be seen, method 200 comprises a unique approach to utilizing digital blockchain currency in conjunction with real world currency. In the methods generally, a central authority is established 210. The central authority is useful herein because the blockchain digital currency of the exemplary embodiments is not mined or discovered, but is created by fiat for use by a private network of financial institutions. The network of financial institutions is created (creating step 220). The central authority undertakes the step 230 of creating electronic tokens representing out-of-circulation currency. The central authority, in conjunction with the network of financial institutions next exercises its authority in granting permissions and issuing/managing keys 240 to financial institutions based on, e.g. their role in the private network. For example, the financial institutions that are qualified banks are generally the only financial institutions that have adequate permission to mint in-circulation digital currency from out-of-circulation tokens. Creating a private network (step 250) allows the financial institutions that are banks with permission to access the out-of-circulation tokens created by the central authority. The private network enables providing additional software modules, APIs, or the like to vastly enhance the functionality of the system and the overall application of the methods provided herein.

After the network is established, each financial institution that is a qualified bank, using its dedicated, unique keys, can undertake the step of minting (step 260) in-circulation currency from the out-of-circulation tokens. In order to practice the minting step, a qualified bank may also place real world currency on reserve (step 270), in accordance with the requirements of the network of financial institutions. In an embodiment, there is a 100% reserve requirement. In other embodiments, the reserve requirement may be fractional, i.e. real world reserves may be required for only a portion of the in-circulation digital currency.

When in-circulation digital currency is created, the blockchain of each individual token is appended with one or more data blocks that identify the details of that in-circulation digital currency including at least the unique ID of the bank that created or minted that currency, the value in the corresponding real world currency, and the date and time of minting (i.e. a timestamp). The blockchain is immutable and recorded in a database that is distributed in step 290 via the network to parties that have adequate permission to view the data. The data may be distributed peer-to-peer or via other means as is most useful. The advantages of using peer-to-peer distribution of such data are known in the art.

The in-circulation digital currency may be useful in transactions between banks. However, to maximize the use and application of the methods a plurality of virtual accounts (including for example virtual bank accounts, virtual credit accounts, and virtual foreign exchange accounts) are created in step 280 for a plurality of banks customers, consumers, vendors, merchants and other members (including financial services companies, lenders, foreign exchange companies, and the like). Each of the foregoing parties to the system have at least one such virtual account and each account is connected to the server network directly or via one or more banks or nonbank financial services institutions. In embodiments of the methods, the steps of allowing peer-to-peer transactions (step 285) and providing electronic payment systems and electronic smart transactions and smart contracts (step 288) are included. Such steps may include allowing peer-to-peer transfer of value via the in-circulation digital currency, in addition to peer-to-peer data transfer.

Platform Architecture

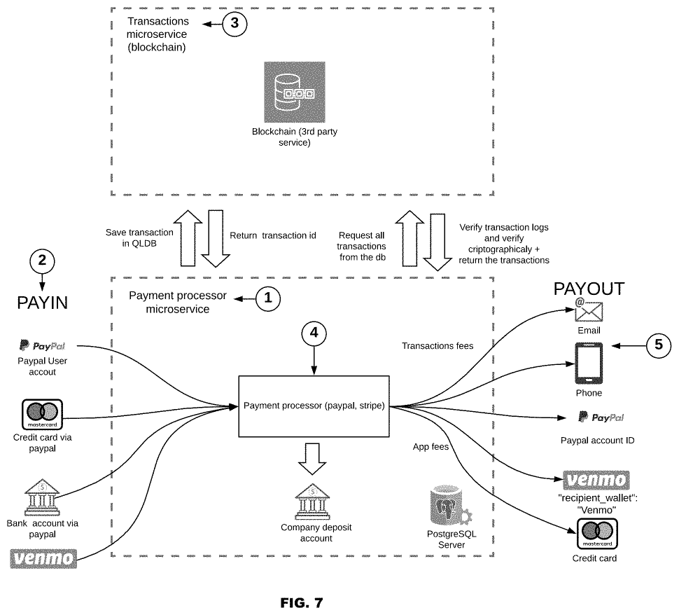

FIG. 7 is a diagram of a payment platform, according to various exemplary embodiments. In exemplary embodiments, as also illustrated in the platform architecture below, the payment platform includes two components: 1) a payment processor layer (e.g., Paypal, Zelle, and the like); and 2) a transactions layer (e.g., blockchain). In exemplary embodiments, the payment processor layer may include a main bank account attached thereto. When procuring Tcoins, fees may be incurrent by the platform merchant account. For example, if the payment processor is Paypal, then the Paypal Hyperwallet may be used, and when withdrawing Tcoins, any fees from the payment processor, as well as fees for setting up the platform may be applied. In exemplary embodiments, in the transaction layer, when Tcoins are exchanged, a record of the exchange may be stored in the transaction service 3. The transaction layer may also allow for visualization of the number of Tcoins being exchanged, the list of Tcoin transactions, the balance of the TWallet, all taken from the blockchain records.

In exemplary embodiments, in order to perform a Tcoin purchase (also referred to as “pay-in”), a user may request to obtain a number of Tcoins. If the pay-in source, such as an individual or organization, is already registered, then a message on the successful registration of the individual or organization may be displayed. If the pay-in source is not registered, then the user may have to register the pay-in source in order to subsequently transfer the Tcoins. In exemplary embodiments, a fee may be charged to the user when transferring the Tcoins. In embodiments, as the pay-in request is entered, the transaction is verified and the amount is successfully registered in the account only when a sufficient amount of Tcoins is registered with the pay-in source. Once verified, the transaction continues and the TWallet of the user is updated with the additional newly received Tcoins. In exemplary embodiments, if the pay-in source does not have a sufficient number of Tcoins, then a message is provided to the user that the transaction may not proceed, and the transaction is stopped.

In exemplary embodiments, a user, such as an individual or an organization, may initiate a payout to another party. For the payout to be successful, the user initiates the payout with a target of a minimum and a maximum of Tcoins to pay out. If the target is not given by the user, then an error message may be provided to the user and the payout is stopped. Once the target is initiated, the payout is validated, and a request for payout submitted. In embodiments, the balance of the user account is checked, and if the account has enough Tcoins, the payout is accepted. If the account does not have enough Tcoins, then an error message is provided to the user and the payout is stopped.

In another embodiment, individual users and organizations may have dedicated ethical cryptocurrency accounts. For example, individual accounts can track incoming and outgoing TCards/Tcoins, as well as ethical actions that have been taken for each. The accounts may include a pre-defined menu of ethical transactions in which account holders can participate, e.g., a drop-down menu, or free-text search/word cluster capabilities. The ability to send outgoing Tcoins/TCards can also be enabled, and each transaction may be associated with specific tasks/organizations.

For larger dynamic organizations, integration of the platform may enable inclusion of data from e.g., existing volunteer registration systems, human resource systems, and other human capital systems to accommodate a dynamically changing volunteer workforce.

Exemplary embodiments include operational innovations including approving and on-boarding organizations and individuals, as well as defining and connecting communities within the platform or framework. In exemplary embodiments, operational innovations may be articulated, both initially and as they evolve, and attending to their protection may be advantageous towards achieving the goal of promoting a cause-based platform.

Exemplary embodiments include technological innovations including providing more hard points for strategic business protection as well as creating intrinsic value through development and refinement of breakthrough technologies. Exemplary embodiments include 1) embedding ethical constraints in digital currency; 2) embedding the digital currency with social messages in their various configurations; and 3) using currency transaction histories as the basis for social network generation.

Exemplary embodiments include end-user accounts and organizational/volunteer team accounts. For example, individual accounts can track accumulation of incoming and outgoing TCards and their associated Tcoin value, as well as self-reported ethical acts that an individual has accomplished through either a prescribed drop-down menu of items, or free-text search/word cluster capabilities, for specifying such ethical actions. The ability to send outgoing Tcoins/TCards may also be enabled and associated with specific tasks/organizations or other means of distributing Tcoins/TCards.

Transaction Reporting

In another embodiment, the value of a TCard may correspond to the amount of Tcoins involved in a given transaction. Specifically, the larger the amount of cryptocurrency transacted or donated, the higher the praise may be expressed in the TCard. In addition, the TCards may be rendered public for each individual user or organization, thus showing to the general public via a news feed, to social media participants, or to the other users of the platform, the identities of the individual users supporting cause-based missions as well as the amounts of Tcoin they exchanged in accomplishing that end. Alternatively, the information rendered public may be tailored to the goals and comfort level of each individual user of the platform. The goal of such reporting may be to encourage other individuals in supporting cause-based organizations or missions. In embodiments, white lists or black lists of organizations or of activities may be embedded in Tcoins, signifying categories of activities or deeds to be accepted (white list) or rejected (black list). In embodiments, reporting may also include screening for language that is not in keeping with the ethical mission or cause. In exemplary embodiments, the organizations or individuals may be periodically audited to ensure that their programmatic aspirations are in keeping with the ethical mission or cause, in terms of activity, language, and overall behavior.

In exemplary embodiments, the value of a TCard may depend on the level of gratitude expressed through the number of Tcoins associated with that particular TCard. However, the news feed may only show the number of TCards received, the number of TCards sent, and the total value of Tcoins in a user's account (if the person chooses to make that public). The profile of that user may show more details about individual TCards received if the user chooses to make them public. In exemplary embodiments, Tcoins may not be entirely anonymous, and may include some information about how the Tcoins have been received. In the case of a blockchain based currency, individual transactions may be public in order to be verified.

A greater discussion on social platforms is provided below.

In many cases, community organizations, such as youth sports leagues, church groups, and social organizations, rely on sponsorships by local businesses, for example, to fund ongoing operations. Thus, fundraising becomes an important function of the community organization. At the same time these businesses rely on the purchasing power of the organization's members and associates. Thus the digital exchange provides a system and method for sponsorship communications, proposals, acceptance between the businesses, community organizations and complying members and associates with measurable rewards.

To the extent possible, it may be advantageous for community organizations to utilize various media outlets to aid in their fundraising activities. However, for many community organizations, the access cost may be a barrier to certain types of media. Typically, news and information flow to a media outlet via paper transfers, voicemails and telephone conversations, electronically through email systems, electronically through established media interfaces, and/or via field reporters. In most cases, the news and information (data, and the like.) input is accomplished manually in the sense that an action may be taken beyond the normal operation of the news event in order to input news to the local media company.

Embodiments provide a system and method to facilitate sponsorship of community organizations that can be integrated with communications information and news flow networks. These and other advantages of the exemplary embodiments, as well as additional inventive features, may be apparent from the description of the exemplary embodiments provided herein. Embodiments of the exemplary embodiments advantageously address this issues of how organizations can utilize a portion of their sponsorship efforts, for example within a community or region, to cost effectively create visibility for their organization and how businesses can automatically be positioned to receive recognition across an integrated media network in a continuous sponsorship environment. In exemplary embodiments, a portion of the income flowing from the continuous sponsorship method would be predetermined and automatically set aside to start-up, maintain and expand an integrated community media network. Further, businesses could be rewarded with recognition within the integrated media network they are supporting when their sponsorship reaches a predetermined threshold amount.

In particular embodiments, organizations and individuals would be able to communicate and display sponsorship requests for business acceptance through a digital proposal exchange. These businesses would be able to view, accept, or initiate sponsorship proposals directed at specific or any organization or individual registered on the digital proposal exchange.

In one aspect, embodiments provide a method of electronically facilitating sponsorship of community organizations. The method includes providing a system that includes a networked electronic forum for the submission of a sponsorship proposal, and receiving and processing an electronic communication from a member of a community organization, where the communication indicates acceptance of the sponsorship proposal. The method also includes automatically sending an electronic communication with information regarding the acceptance of the sponsorship proposal by the community organization. Further, the method includes receiving an electronic communication that includes information demonstrating compliance with terms of the sponsorship proposal, and crediting the community organization for each communication demonstrating compliance with terms of the sponsorship proposal.

In a particular embodiment, providing a system that includes a networked electronic forum for the submission of a sponsorship proposal comprises providing a system that includes a networked electronic forum for the submission of a sponsorship proposal and for the registration of the community organization. In a further embodiment, electronic communications are sent and received via the internet. More particular embodiments of the method include configuring the system to send and receive electronic communications via a mobile communications device. The mobile communications device may be a tablet computer or a smart phone. Certain embodiments of the method include maintaining a database that stores contact information of members and associates of the community organization. The method may also include automatically sending electronic communications to members and associates of the community organization regarding the acceptance of the sponsorship proposal by the community organization, where the electronic communications further specify terms of compliance for the sponsorship proposal. Further, the method may include configuring the system to allow members and associates to send electronic communications to third parties regarding the acceptance of the sponsorship proposal by the community organization.

In a particular embodiment, the method further includes generating an identification code, where the identification could be either a matrix barcode, a barcode, or an identification number. In more particular embodiments, receiving electronic communications that have information demonstrating compliance with terms of the sponsorship proposal includes receiving electronic communications with the identification code number. Further, the identification code may be uploaded to the digital exchange by the sponsor. In certain embodiments, crediting the community organization for each communication demonstrating compliance with terms of the sponsorship proposal comprises awarding a number of points (or alternatively a percentage of purchase sale or a fixed amount per purchase) to the community organization for each communication demonstrating compliance with terms of the sponsorship proposal, where each point awarded has a monetary value.

The method may further include receiving data about a community event, transforming the data into a format for viewing at one or more locations in the community, and transforming a portion of the data into print-ready verbiage. Particular embodiments may include parsing the data to obtain information regarding the community event, selecting at least one text option to use to display the information, adding the information to the at least one text option to create a part of the print-ready verbiage, and combining the part of the print-ready verbiage to other parts of the print-ready verbiage to form the print-ready verbiage. Even more particular embodiments may include automatically generating an entry in an electronic community-based media communication when the community organization is credited a predetermined threshold amount by the server.

In another aspect, embodiments provide a system for facilitating sponsorship of community organizations. The system includes a computer server connected to a communications network. The communications network may be the internet or an intranet. The server is programmed to accept and process a registration submitted over the network by a community organization, to accept and process a sponsorship proposal submitted over the network by a sponsor, and to receive communications indicating acceptance of the sponsorship proposal by the community organization. The server is also programmed to automatically send communications regarding acceptance of the sponsorship proposal to members of the community organization, to receive communications demonstrating compliance with terms of the sponsorship proposal; and to credit the community organization for each communication received demonstrating compliance with terms of the sponsorship proposal.

In a particular embodiment, the server is programmed to generate an identification code for a user of the digital exchange. The aforementioned communications demonstrating compliance with terms of the sponsorship proposal may include the identification code. Further, the server may be programmed to distribute the identification code to a mobile communications device. In certain embodiments, the server includes a database with contact information for members of the community organization, and may include contact information for associates or affiliates of the community organization. Also, the server can be programmed such that system users can arrange to automatically send electronic communications to third parties regarding acceptance of the sponsorship proposal to members of the community organization.

In further embodiments, the credit provided the community organization for each communication received demonstrating compliance with terms of the sponsorship proposal is accomplished by awarding some number of points to the community organization, wherein each point has a monetary value (or alternatively awarding a percentage of sale or a fixed amount of money for each sale). In yet another aspect, embodiments provide a method to facilitate sponsorship proposals between community organizations and sponsors. The method includes integrating a digital media center, a sponsorship exchange system, and an Advise System that includes Needs Plans of community organizations and Objectives Plans of sponsors, and connecting businesses with organizations and residents within a community to facilitate sponsorship of individuals and organizations that are linked to advised promotions across the digital media network. The method further allows receiving information from a point-of-sale (POS) system operated by the sponsor, and allocating funds to community organizations based on the information received from the POS system and information previously input from the registered user.

In a certain embodiment, the method includes electronically receiving information from a point-of-sale (POS) system, either manually by operators or automatically, at specified time intervals. In some embodiments, receiving information from a point-of-sale (POS) system includes receiving customer identification information from a point-of-sale (POS) system. Further, the allocation of funds to community organizations may be accomplished without any additional input from the customer. In some instances, the allocation of funds to community organizations is based on previously-made default selections by the customer.

In yet another aspect, embodiments provide a method to facilitate sponsorship proposals between community organizations and sponsors. The method includes integrating a digital media center, a sponsorship exchange system, and an Advise System that includes Needs Plans of community organizations and Objectives Plans of sponsors, and connecting businesses with organizations and residents within a community to facilitate sponsorship of individuals and organizations that are linked to advised promotions across the digital media network. The method further allows receiving information from a mobile communications device via a mobile application used by the sponsor, and allocating funds to community organizations based on the information received from the mobile communications device and information previously input from the registered user.

In a particular embodiment, a method for an organization, school or program administrator to request registration of individuals for participation in a given sponsorship or fundraising program or to become a subscriber of a media platform associated with a given organization, school or program, thereby connecting individuals to specific fundraising needs of that program and media platforms associated with that organization, school or program, and including the individuals who accept into the group or network of people that have a common goal of attaining the sponsorship or fundraising goals and/or supporting a specific media platform.

Embodiments include a method for individuals that are participating in the sponsorship exchange system to periodically pledge amounts of purchase or sponsorship activity. For example, a typical pledge amount may be $10 per month, and the sponsorship activity may consist of specific needs at different levels relative to specific organizations, schools or programs. The method may include, for example, selecting projected purchases on a monthly basis from a list of consumer items (e.g., restaurant food, gasoline, groceries, and the like.). The system then calculates potential sponsorship amounts based on those projected purchases. Another method may be to simply pledge an amount and the system then delivers possible purchase behavior and places of business to make those purchases to attain that pledged amount. The user is then notified continuously of opportunities to purchase with specific sponsorship deals based on data input into the pledge notification system. The pledges can be for needs at different levels and can be for school needs, program needs, community organization needs, tuition assistance programs for individuals, or fee reduction programs for individuals.

A method for an organization, school, program or individual to periodically receive reports relative to sponsorship and media platform subscriptions. These reports detail the results of the individual and collectively the group compared to goals and/or averages of the group. These reports include sponsorship amounts, number of subscribers, number of readers, and other relevant data of the group. A method for organization/program members to petition/request/suggest other individuals to participate in a specific sponsorship initiative, can be for a single event or continuously.

A method to target individuals that participate in a sponsorship and/or digital/electronic network where purchase offers, prizes, and/or other marketing information are presented through a code that can be scanned/read via a mobile device app (e.g., a matrix barcode being scanned by an app on a smart phone or computer tablet). After scanning the matrix barcode, the user is sent to a site where a business deal is presented to the user that is unique to that user. The uniqueness of the deal is determined by an algorithm or set of algorithms within the system, based on the activity of the user in the system and/or information input by the user into the system. The user is identified by the system via the unique user registration information, such as user ID, password, cell phone number, exchange/network ID number, and the like. The deal can be for a purchase that includes a discount, a purchase that includes a sponsorship for one or more schools, organizations or programs within, a gift card or prize, a purchase that includes a raffle ticket for determined prizes, or a combination thereof. The code can be displayed on any media platform, digital or otherwise, for example, within a newspaper, magazine, website, digital magazine, email, poster bulletin, newsletter, and the like. “Reward points” are earned as the user uses the system—for example, a certain amount of points is earned for scanned offers that are declined and scanned offers that are accepted.

In a further embodiment, the method for businesses to target specific customer sets based on organization/school memberships or participation, or based on sponsor exchange purchase activity. For example, businesses may target network users that are currently not their customers (where the definition of current customer is provided by the business—e.g., a cardholder/participant may be a current customer of a business if he/she has made a purchase in the last three months). Businesses may target customers that may agree to make purchases at non-peak hours or seasons. Alternatively, businesses may target participants of certain organizations, schools, or programs.

In a particular embodiment, a method for automatically tracking when business matrix barcode scan costs reach a predetermined threshold amount, thereby generating an entry into a dataset linked to a content/advertisement management system to ultimately position an advertisement for a business in one or more of the media platforms in a geographically determined area. Businesses may pay a specified amount for each matrix barcode scan. Businesses may pay a specified amount for a scan that does not result in a purchase. Businesses may pay another specified amount for a scan that does result in a purchase. These scan amounts may be tracked and once the amount reaches a predetermined level of amount, an advertising space is allotted to that business on a determined media platform. For example, the matrix barcodes may be placed in a daily print newspaper. Once the scan charges reach a certain level, the business may be notified that a certain amount of advertising inventory is available for that business to run/display an ad at no additional or lower charges.

In certain aspects, a method to offer a sponsorship system for tuition assistance or contributions to college savings plans whereby the user participates in an educational question/answer process and a winner is selected from those that answer the set of one or more questions correctly. The user scans or reads a code via a mobile device (e.g., a matrix barcode being scanned by an app on a smart phone or computer tablet). The code can be displayed on any media platform, digital or otherwise, for example, within a newspaper, magazine, website, digital magazine, email, poster bulletin, window cling, newsletter, and the like. After the code is scanned, the user is sent to a site where information is provided via a set of slides, or thru a video, or thru photos with captions, or thru articles. The code can be a companion to other media content, such as a companion to an article in a newspaper, where the information in the code educational system is relevant to the article in the newspaper. The user is identified by the system via the unique user registration information, such as user ID, password, cell phone number, exchange/network ID number, and the like. After the information is presented, the user answers a set of one or more questions. Depending on the answers, the user may be positioned for a drawing for a prize such as, e.g., an amount of money towards a college savings plan or tuition reimbursement.

The aforementioned method for exchange/network users linked to a given organization, school and/or program to petition others in the network, whether or not they are directly connected to the petitioning school, organization or program, to participate in a specific sponsorship program or event (e.g., a 20% giveback sponsorship for a given Tuesday at a specified restaurant for a specific program within a school—please join in our sponsorship event). The system would provide an ID card for those that accept and are not currently linked to the petitioning school, organization or program.

A method where an individual network/exchange participant may propose a sponsorship event or program for a participating school, organization or program of the exchange/network, and invite other participants of the network/exchange to participate in the event or program, whether or not they are directly connected to the sponsored school, organization or program. The proposer creates a proposal with one of the participating businesses and sends the proposal to that business. The business then either accepts or denies or counters with another proposal. Once a proposal is accepted by both the individual and the business, then the system is prepared to have individual exchange/network participants attach to the proposal for compliance.

In certain embodiments, the aforementioned method wherein a matrix barcode is placed in/on a media platform (e.g., a newspaper, magazine, digital magazine, website, and the like.). The matrix barcode is scanned with a digital app that sends the user to a digital application platform where the user can then log in and begin the process of proposing a sponsorship event. In one aspect, a method where the extent of exchange activity provides reward points for media coverage for schools, organizations, and programs. The system tracks the activity in the digital marketing network and “media coverage points” are earned each time activity such as purchases are made or matrix barcodes are scanned. Once a specified level of media coverage points are earned, a notification is sent to the relevant school, organization, team or program and the appropriate media coverage is established and executed. Points may be earned for media coverage—where a certain amount of points may earn coverage of an event of the organization, school, or program within. Media coverage means that efforts may be put forth to cover an event and publish an article or video or photos of the event.

In another aspect, a method where a matrix barcode system in/on a given media platform (e.g., a newspaper, magazine, digital magazine, website, and the like.) serves as a service directory that is attached to a digital marketing network for a given region, that displays purchase deals for services/products that offer sponsorships for community organizations, schools and programs. The deals can also offer discounts, gift cards, reward points, raffle tickets for an upcoming raffle event. In another aspect, wherein sponsorship and marketing deals are offered for both discounts and sponsorship (possibly including raffles)—wherein reward points are earned for exchange participants (ID cardholders) that provide referrals for the businesses in the directory. These referrals would be viewed by participants that are connected in a “referral network.”

A method, further comprising providing, via matrix barcode usage, reward points to reduce subscription prices of media platforms, wherein the system tracks matrix barcode scan activity by the user, and provides an option for the media platform provider employing the matrix barcodes to offer a subscription price reduction or credit based on the amount of activity of a given user. A method where a school, organization or program director can request/suggest a pledge arrangement/system be used to attain financial needs in the digital network. In yet another aspect, the individual that is making the proposal and having the proposal exchange with the participating business is electronically awarded a reward, such as a gift card or loyalty points or a discount, and the like, from that business in return once the proposal is accepted by both parties and becomes a sponsorship plan. Once awarded, the individual makes a purchase at that business and the award may be attached to the individual's account and visible to the business, and awarded at that time. In a particular embodiment, a matrix barcode is displayed throughout the community (e.g., on a poster advertisement at a table in a restaurant) that when scanned sends the person who scans the code to a site where information and data can be submitted for possible use in a media center/network—a number of media platforms (digital, print, and the like.)—and reward points or awards are earned as a result of the content submittal—the awards can be any combination of sponsorship funds for community organizations, discounts at participating businesses, gift cards, event tickets, and the like. Also, advertisement credits may be earned by the sponsor as described in certain embodiments.

A revolving sponsorship fund (RSF) may be established to allow funds to be developed, consumed, and replenished by the community organizations or the programs within. The RSF is an account where community organizations (or programs within the community organization) can at times borrow an amount of money as needed—like a line of credit. The RSF may be established by one or more individuals or entities via donation and/or through purchase activity in the digital exchange system. Further, a pledge system may be utilized to establish the support group for the community organization (or program within the community organization) to borrow from the RSF—i.e., a group of people are registered in the digital exchange system, linked to a particular community organization or program within (e.g., a specific team in a sports organization or the drama club or a sports program within a school)—the registered users linked then pledge amounts of sponsorship through participation in the digital exchange system (like $10/month for a year, and the like.)—the pledge amounts are tallied—when the collective (aggregate) pledge amount reaches a predetermined sponsorship level over a specified period, the RSF $ (like a line of credit) become available for the organization or program and the group then participates in the digital exchange system with the objective of achieving the sponsorship amount as pledged. A refundable deposit is provided rather than a donation. The refundable deposit, like a donation, can be directed at the RSF or directly to a community organization or program within the community organization through the compartmentalized sponsorship fund. In certain embodiments, where an interest rate is attached to the refundable deposit.

In certain embodiments, the sponsorship proposal includes a “pay-per-pledge” term—where a sponsorship proposal exchange is occurring between a community organization, or a program within a community organization, with a sponsor. The community organization participants collectively pledge to purchase an amount, thereby yielding an amount of sponsorship. The “pay-per-pledge” term in the proposal, and once the proposal is accepted becoming the sponsorship plan, would be where a sponsor pays a portion or all of the pledged sponsorship amount up front before the purchases take place. In particular embodiments, a refundable deposit is provided rather than a donation. The refundable deposit, like a donation, can be directed at the RSF or directly to a community organization or program within the community organization through the compartmentalized sponsorship fund. An interest rate may be attached to the refundable deposit.

Embodiments include a method where sponsors such as corporations, other businesses or organizations, or individuals can electronically pledge matching sponsorships, the matching sponsorship function being integrated with the digital exchange system. Corporate and individual matching sponsorships represent the system capability to electronically input or accept these matching sponsorship offers. Once a matching sponsorship offer is pledged electronically in the system, and as individuals then make purchases in the digital sponsorship exchange system, a matching sponsorship amount is also gained by an organization or program within as defined by the matching sponsorship offer (e.g., a $0.50 match for every sponsorship $1 earned). The system is configured to track the purchase activity and automatically account for the matching amounts.

Embodiments include a system and method in which a revolving sponsorship fund (RSF) is established and integrated with a digital sponsorship exchange system. The RSF serves to allow funds to be borrowed, with or without interest, and replenished by the community organizations (including schools) and the programs within those organizations via participation in the digital sponsorship exchange system. Community organizations and/or the programs within those organizations use the funds available in the compartmentalized sponsorship fund for their organizational needs—operating and/or capital. Individuals and businesses participate in the digital sponsorship exchange system and funds are generated for organizations and/or programs within those organizations. Funds may be temporarily held in the compartmentalized sponsorship fund for the various organizations and programs.

The method may also include a pledge system to establish the support group for the community organization or program within the organization to borrow from the revolving sponsorship fund (RSF). For example, a group of people and/or entities may be registered in the digital sponsorship exchange system, and linked to a particular community organization and/or program within that particular organization (e.g., a specific team in a sports organization or the drama club or a sports team within a school)—the registered users pledge amounts of sponsorship through participation in the digital sponsorship exchange system (e.g., $10/month for a year). The pledge amounts are tallied and when the collective (aggregate) pledge amounts for the entire group reaches an acceptable sponsorship pledge level, the RSF funds, similar to a line of credit, become available for the organization or program and the group. The transactions are facilitated by the digital sponsorship exchange system with the objective of achieving the sponsorship amount as pledged, plus any interest that has accrued (if applicable) until the borrowed amount is paid in full.

The method may also include a credit rating system that depends on variables such as (1) amount of registered users/cardholders activity in the digital sponsorship exchange system for those registered users linked to the organization or program within that are requesting funds from the RSF, (2) the pledge and participation history of the linked, registered users/cardholders—relative to both amount currently pledged in the system by each registered user and to how well each registered user has done historically with previous pledges, and (3) the pledge history of the organization or program relative to repayment of borrowed funds. An algorithm in the digital sponsorship exchange system calculates a credit rating based, in part, on the variables above. Credit rating scores directly impact the aggregate pledge amount necessary to be approved for the requested funds from the RSF. For example, an organization requests to borrow $10,000. A relatively high credit rating for a linked group of people may require a pledge amount totaling to $12,000 over a specified period of time. A relatively low credit rating for a linked group of people may require a pledge amount totaling to $14,000 over a specified period of time. Credit ratings may also impact interest rates, if applicable.

The digital sponsorship exchange system may be constructed to track the actual sponsorship amounts produced and compares those actual amounts to the pledge amounts for each registered user and aggregately for the organization or program within the organization. Notifications may be electronically sent to linked, registered users and to administrators of organizations or programs—to notify each recipient of their individual performance of actual sponsorship relative to pledged amounts—and to also notify all recipients of the performance of the group collectively, actual sponsorship earned relative to the amount pledged. In certain embodiments, the system provides the means, such as an electronic interface, for an individual registered user or entity to electronically co-sign for the borrowed funds—meaning that the cosigner accepts responsibility for repayment of the borrowed funds, including any accrued interest if applicable.

Embodiments include a method where a “digital scratch-off app” (e.g., displayed on a user device at business locations throughout a community) displays a “scratch-off mystery offer, reward or prize.” When prompted to do so (e.g., clicking a button or touching a button on a touch-screen display), the app displays the removal of the “scratch-off covering” to reveal a result—can be a mystery offer, reward, gift card, or other prize. The “digital scratch-off app” may also be linked to a digital network (sponsorship and/or marketing network). The app displays a “scratch-off mystery offer, reward or prize.” For example, the user presents an ID code also linked to the digital network (sponsorship and/or marketing network)—the code is input into the app (manually or by scanning a barcode or other scannable code on an ID card—digital or not)—the app then displays the removal of the “scratch-off covering” to reveal a result—can be a mystery offer, reward, gift card, or other prize.

A cash-back rewards system may be combined with a digital exchange and sponsorship network. The cash-back reward system provides a means for participants to receive cash-back rewards that can be used to pay individual fees, school tuition, and the like. to participating organizations and schools. The cash-back rewards system may also be linked to the revolving sponsorship fund (RSF). Individuals can then borrow from the revolving fund to pay for fees, tuition, and the like. —and then participate in the exchange network to pay down/back the borrowed funds, plus any interest incurred if applicable. A pledge system can be used to establish the support group for the individual to borrow funds for the cash-back rewards system. A credit rating system may be established for the revolving fund and linked to the cash-back rewards system. Furthermore, a digital marketing or sponsorship system may be used to allow entities (businesses, and the like.) to position themselves into a pledge system where potential customers can pledge to do business with a given entity.

In still another aspect, embodiments provide a method to facilitate sponsorship proposals between organizations and sponsors. The method includes integrating a digital media center network, a sponsorship exchange network system, and an advise system having a database and configured to continuously electronically monitor purchasing behavior and to maintain, within the database, statistical calculations of purchase behavior. The advice system is further configured to use the statistical calculations to automatically generate a sponsorship proposal that matches an individual organization with an individual sponsor, based on particular funding needs of the individual organization and on particular objectives of the individual sponsor.

In a further embodiment, the method includes the step of configuring the advise system to automatically transmit a targeted promotion to one or more groups or individuals, wherein the targeted promotion is based on the sponsorship proposal. The method may also include the step of transmitting the targeted promotion to the one or more groups or individuals via electronic mail or electronic text message. In yet another embodiment, the method calls for configuring the advise system to monitor amounts pledged by the one or more groups or individuals in accordance with terms of the sponsorship proposal, and determine possible purchase behavior and places of business to make purchases that may allow the one or more groups or individuals to attain a pledged amount. In a more particular embodiment, the method requires configuring the advice system to automatically notify the one or more groups or individuals of new promotions implemented in support of the sponsorship proposal, when the advice system determines that the new promotion is of interest to the one or more groups or individuals.

In certain embodiments, the method includes the step of configuring the advice system to automatically transmit the targeted promotion over the digital media center network, wherein the targeted promotion is based on the sponsorship proposal. The method may further include the step of configuring the advice system to evaluate the particular funding needs of the individual organization, the funding needs being in the form of a needs plan, which can accommodate one or more needs having different priorities, and wherein the advice system takes these priorities into account when generating the sponsorship proposal. The needs plan may include needs having different priorities and different funding requirements. In a particular embodiment, the method calls for registering one or more groups or individuals participating in the sponsorship proposal, and linking, within the advice system, each registration with at least one of the one or more needs in the needs plan.

In certain embodiments, the method includes the step of configuring the advice system to generate a sponsorship profile for each sponsor, the sponsorship profile including all of the sponsorship proposals accepted by the respective sponsor along with a status thereof. In a further embodiments, the method includes the step of configuring the advice system to distribute targeted promotions to the one or more groups or individuals participating in the sponsorship proposal by distributing a matrix barcode that can be scanned via a mobile electronic device, wherein scanning the matrix barcode, transfers a mobile electronic device user to an electronic site where the user can participate in transactions that support objectives of the sponsor. In some embodiments, the method calls for configuring the advice system to display the matrix barcode on the digital media center network, and crediting the user for viewing the targeted promotion. In other embodiments, the method includes the step of configuring the advice system to credit, each time a matrix barcode is scanned, the sponsor associated with the scan. In a further embodiment, the method requires configuring the advice system to crediting the user for submission of information for distribution on the digital media center network.

In a particular embodiment, the method includes the step of configuring the advice system to provide an electronic pledge feature devised to allow the sponsor to tailor a specific customized promotion for an individual or group within the sponsorship exchange system. The electronic pledge feature may be further devised to allow sponsors to compete against one another via an electronic bidding pricing system for enhancing or improving their respective customized promotions. The method may also include the step of configuring the advice system to evaluate the particular objectives of the individual sponsor, the objectives being in the form of an objectives plan, which can accommodate one or more objectives having different priorities, and wherein the advice system takes these priorities into account when generating the sponsorship proposal. The objectives plan may include objectives having different priorities and different funding levels. The method may further include the step of accepting a pledge from the one or more groups or individuals that links, within the advice system, the pledge with at least one of the one or more objectives in the objectives plan.

In still another aspect, embodiments provide a method of operating a digital exchange system. The method includes providing a server connected to a communications network configured for two-way communications with system users configuring the server to display, on a system-user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, and registering a participant desiring to participate in one or more sponsorship offer plans, wherein said participation establishes an electronic link in the digital exchange system between the participant and the one or more community organizations or individuals. The method further includes providing an electronic revolving sponsorship fund, wherein the one or more community organizations or individuals can borrow funds from the revolving sponsorship fund, electronically allocating the borrowed funds to the one or more community organizations or individuals, based on an amount requested by the one or more community organizations or individuals, and based on available funds in the revolving sponsorship fund, electronically accepting and tracking pledged amounts, from digital exchange system users, to provide support for borrowing funds from the revolving sponsorship fund, and providing an electronic credit rating system, which calculates a credit rating that is used to determine a required aggregate pledge amount necessary for approval and allocation of the requested amounts to one or more community organizations or individuals.

In some embodiments, the credit rating system calculates the credit rating based on an activity history in the digital exchange system of the registered participants associated with the organization requesting the funds. In other embodiments, the credit rating system calculates the credit rating based on a pledge history of the registered participants associated with the organization requesting the funds. The credit rating system may also calculate the credit rating based on a pledge history of the community organization that is requesting the funds. Also, the credit rating system may provide the means for an individual registered user of the digital exchange system to electronically co-sign for the borrowed funds from the revolving sponsorship fund.

In still other aspects, embodiments provide a method of operating a digital exchange system. The method includes providing a server connected to a communications network configured for two-way communications for system users, registering a participant or user desiring to participate in a community marketing network, and requiring the user to provide unique identification information, configuring the server to display offers, prizes, or other marketing information on system user devices, accepting electronically-submitted offers, identifying the user via unique user registration information; and linking a digital application function to the user, the digital application function being operable remotely via a unique location or identification, wherein the digital application function displays offers, rewards or prizes, which are unique to the user.

The server may be configured to display offers, prizes, or other marketing information comprises configuring the server to display offers, prizes, or other marketing information based on industry category. Also, the method includes configuring the server to display, on a system user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, and registering a participant desiring to participate in one or more sponsorship offer plans, wherein said participation establishes an electronic link in the digital exchange system between the participant and the one or more community organizations or individuals.

In certain embodiments, the digital application function is performed by a “digital scratch-off application”, which displays a digitally removable “scratch-off covering” which, when removed, reveals one or more of the offers, rewards or prizes, and the “digital scratch-off application” is linkable to a digital network and accessible to the participant or user via a coded input such that, upon receipt of the coded input, the scratch off covering is removed.

In some embodiments, the method calls for providing an advise system having a database and configured to continuously electronically monitor purchasing behavior and to maintain, within the database, statistical calculations of purchase behavior, wherein the advice system is further configured to use the statistical calculations to automatically generate a sponsorship proposal that matches an individual organization with an individual sponsor, based on particular funding needs of the individual organization and on particular objectives of the individual sponsor. The method may also include the step of configuring the advice system to monitor amounts pledged by one or more groups or individuals in accordance with terms of the sponsorship proposal, determine possible purchase behavior and places of business to make purchases that may allow the one or more groups or individuals to attain a pledged amount, and automatically notifying the one or more groups or individuals of new promotions implemented in support of the sponsorship proposal, when the advice system determines that the new promotion is of interest to the one or more groups or individuals. The method may further include the step of configuring the advice system to automatically transmit a targeted promotion to one or more groups or individuals, wherein the targeted promotion is based on the sponsorship proposal, wherein the targeted promotion is transmitted to the one or more groups or individuals over a digital media network, or via electronic mail, or via electronic text message.

In a particular embodiment, the method requires the step of configuring the advice system to generate a sponsorship profile for each sponsor, the sponsorship profile including all of the sponsorship proposals accepted by the respective sponsor along with a status thereof. In other embodiments, the method includes the step of configuring the advice system to provide an electronic pledge feature devised to allow the sponsor to tailor a specific customized promotion for an individual or group within the sponsorship exchange system, the electronic pledge feature being configured allow sponsors to compete against one another via an electronic bidding pricing system for enhancing or improving their respective customized promotions.

Further, in other aspects, embodiments provide a method of operating a digital exchange system. The method includes providing a server connected to a communications network configured for two-way communications with system users, configuring the server to display, on a system-user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, registering a participant desiring to participate in one or more sponsorship offer plans, wherein said participation establishes an electronic link in the digital exchange system between the participant and the one or more community organizations or individuals, tracking an extent of participation in the sponsorship offer plan by the participant, allocating proceeds to the one or more community organizations or individuals based on the extent of participation in the sponsorship offer plan by the participant, and electronically allocating proceeds to a cash-back savings account for the participant.

The method may include allocating payment of fees to community organizations from the cash-back savings account of the participant. The method may also call for providing an electronic revolving fund where participants can request to borrow funds to pay fees to community organizations. Additionally, the method may include configuring an electronic pledge system wherein participants can pledge to do business with sponsors for specified offers. The method may call for configuring the electronic pledge system to establish a support network for the participant. In some embodiments, the method requires providing a credit rating system that calculates a credit rating for the support network to determine a pledge amount required in order to authorize a request for borrowed funds.

There is a need for an effective system to track the support and sponsorship with the purpose of directing resources to assist the sponsorship needs while assigning recognition within an integrated media network. Thus, as more and more organizations within a community create arrangements with businesses for continuous sponsorship, the need to provide a more automated and quantifiable method for resource allocation and recognition is apparent.

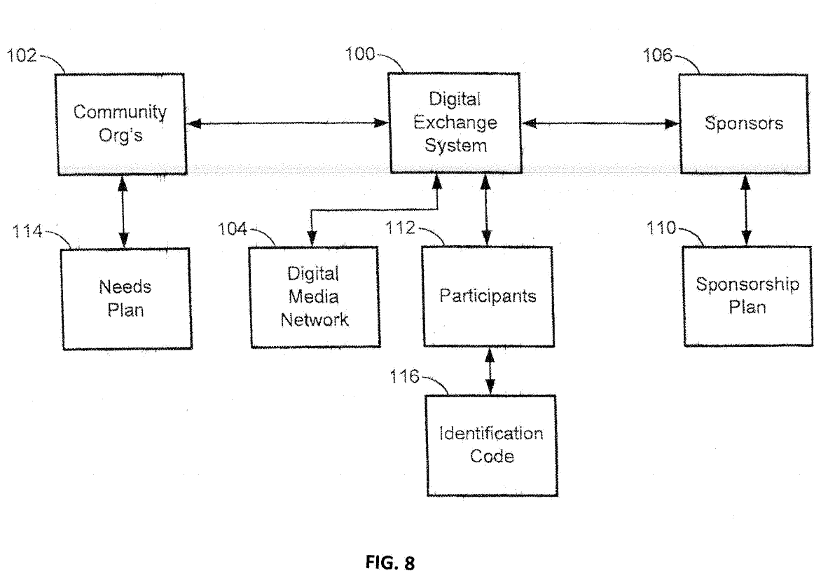

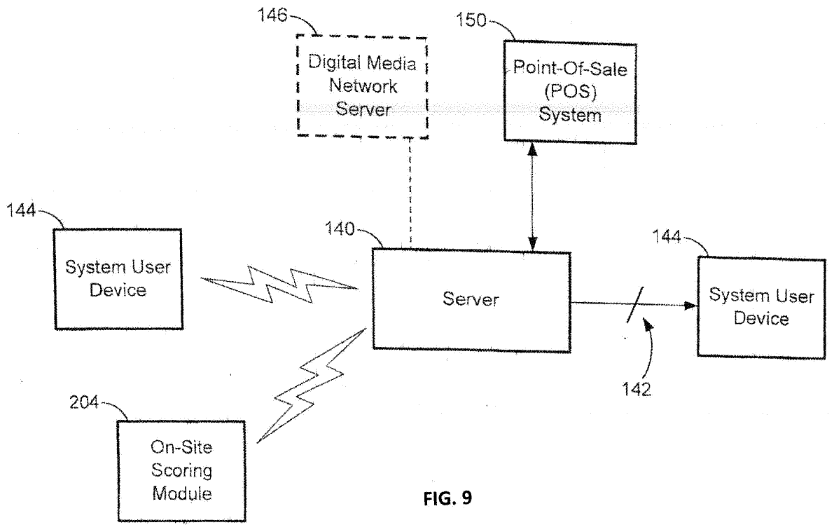

As shown in FIG. 8, embodiments provide a digital exchange system 100 to track the support and sponsorship of community organizations 102 for the purpose of directing resources to assist the sponsorship needs while assigning recognition within an integrated digital media network 104. Further, embodiments permit community organizations 102 to create arrangements with sponsors 106 for continuous sponsorship, and to provide an automated and quantifiable method for resource allocation and recognition. In at least one embodiment, a digital exchange system 100 for facilitating sponsorship of community organizations 102 includes a server 140 (see FIG. 9) connected to a network 142 (see FIG. 9), such as the internet, an intranet, cellular and/or Wi-Fi network, and programmed to provide for the electronic dissemination of community-based information, and programmed to provide a digital exchange system 100 to facilitate the sponsorship of community organizations 102 by sponsors 106 and participants 112.

FIG. 9 is a schematic block diagram that illustrates the server 140, network 142, and system user devices 144, according to an embodiment. System user devices 144 include, for example, personal computers connected to the internet or an intranet, mobile wireless devices such as smartphones or tablets. These system user devices 144 may be employed by members of the community organization 102, by the sponsor 106 and its employees, agents or affiliates, participants 112 in the sponsorship offer plan, also referred to as sponsorship plan 110, crowd-sourced reporters, and the like. The server 140 may also be configured to wirelessly communicate with on-site scoring modules 204, which are discussed in more detail below. The primary elements of the digital media network 104 may reside on server 140, or optionally may reside on a digital media network server 146 (shown in phantom) in communication with server 140.

Embodiments include a system and method which provide community organizations 102 and sponsors 106 an integrated, automated system that serves to match the needs of the organizations 102 (and the people therein) with the objectives of the sponsors 106 within a community and/or region. In particular embodiments, community organizations 102 connect to the digital exchange network 100 in three primary ways:

1. A connection between the server 140 and system user from the community organization 102 that allows the system user to register and electronically submit a needs plan 114 that describes the needs of the community organization 102—and then based on that needs plan 114, receive automated reports generated by the system that assist the community organization 102 with visibility and sponsorship. Demographic, contact, and descriptive information may be provided by the community organization 102 as a part of a community organization profile. Details regarding desired sponsorship are provided as a part of the needs plan 114.

2. Use of the aforementioned connection that allows the system user to submit content about their activities and accomplishments for publishing on the digital media networks 104.

3. Connection to the digital exchange system 100 to: Receive proposals from the sponsors 106; Offer proposals to the sponsors 106; and Participate in sponsorship plan 110 that results from purchases by the sponsorship plan participants 112.

The diagram of FIG. 8 also shows how sponsors 106 can interface with or connect to the network 142 (shown in FIG. 9) in three ways:

1. A sponsor 106 may join the digital exchange system 100 by electronically submitting registration information via the digital exchange system 100. In a particular embodiment, as an integral part of the sponsor registration, the sponsor 106 develops (and maintains thereafter) the sponsorship plan 110 and a sponsor objectives plan by filling out a template of information about the sponsor 106. For example, a restaurant may have an objective to increase business on a certain day of the week, and construct a sponsorship plan 110 that corresponds to that objective. Demographic, contact, and descriptive information may be provided by the sponsor 106 as a part of a sponsor profile.

2. Connection to the digital exchange system 100 to receive proposals from community organizations 102; Offer proposals to the community organizations 102; Receive communications and recommendations from the digital exchange system 100 regarding various proposals.

3. Connection to the digital exchange system 100, which is attached to the digital media networks 104, and wherein the digital exchange system 100 may be configured to automatically position various types of promotions and/or advertisements that roll into one or more digital media networks 104.

In exemplary embodiments, the digital exchange system 100 facilitates sponsorship of community organizations. The digital exchange system server 140 is connected to a network and programmed to provide a system for the dissemination of community-based information, and programmed to provide a digital exchange to facilitate the sponsorship of community organizations by businesses and individuals. Embodiments offer community organizations and sponsors an integrated, automated system that serves to match needs of organizations (and the people therein) with objectives of businesses within a community or region.

Community residents that are affiliated with organizations, either directly such as students, players or participants, or indirectly, such as alumni or supporters, also complete a profile template (and maintain thereafter).

An “Advise” section of the network contains an algorithm that monitors the on-going transactions through the system. The “Advise” system tracks, for example, the following and/or performs the following calculations: monthly purchase amounts input through the system—total from all businesses in a given community/region, breakdown by Business Category (categories e.g., as shown in the Digital Sponsor Platform), breakdown by Business Category averages, breakdown by Organization, i.e., purchase amounts attributed to each organization, and breakdown by Organization on a per user ID card (e.g., $100,000 of purchases were recorded in the exchange system for a specific organization and the organization has 500 ID cards, resulting therefore in an average for the organization of $200/ID card); for each participating business, number of registered users in each community organization or school that have made a purchase in the recent past (e.g., by month, over the last 6 months), comparing that to the total number of registered users in each community organization or school.

Participants 112, whether individuals or some other type of entity, may also be asked to register and to provide information which could be used to construct a participant profile. Part of the registration process may involve issuance of a unique identification code 116 for the participant. In any community, there may be events which could affect sponsorship levels, or which could be used to affect sponsorship levels. To take advantage of these instances, community organizations 102 and sponsors 106 may disseminate information regarding the event and/or the sponsorship via the digital media network 104. In some cases, information may be efficiently disseminated by crowd-sourced reporting in which spectators or members of the general public provide facts, reporting, video, and the like, to communicate the desired message. The digital media network 104 may be configured to electronically send out alerts soliciting crowd-sourced reporting, and further configured to process the information provided by such crowd-sourced reporting.

The digital exchange system 100 may also be configured to track one or more customer loyalty programs implemented by a particular sponsor 106, and allocate funds to the community organization 102 and awards to the participants 112 in accordance with the requirements of the customer loyalty program. Under some customer loyalty programs, customers may fall into any one of several program categories (e.g., platinum, gold, silver, and the like.) which identify the status of the customer. The sponsor 106 may base certain allocations on a participant's status under the customer loyalty program. The digital exchange system 100 may be further configured to generate reports showing, for example, purchase history of participants 112, affiliations, interests, and the like. In some embodiments, the digital exchange system 100 is configured to automatically notify participants 112 and sponsors 106 when the participant 112 is eligible for an award under the customer loyalty program. Additionally, it should be noted that, in a particular embodiment of the digital exchange system 100, sponsors 106 are able to offer sponsorship plans 110 allocating money to a community organization 102 that does not require participants 112 to register or to explicitly indicate any support for the community organization or acceptance of the sponsorship plan 110.

In certain embodiments, the on-site scoring/statistics module 204 receives data from crowd-sourced reporters. The module 204 can interface with or be an integral part of hardware devices such as portable electronic scoring devices, scoreboards, and the like, to automatically obtain the data. The data can include information relating to a community event, a sporting event, an advertisement, a promotional event and the like. The module 204 interfaces with a user interface and data entry module 206 that sends the data to data management module 208. The user interface and data entry module 206 may also receive data from crowd-sourced reporters. Alternatively, module 204 directly sends data to data management module 208. Data entered is stored in data management module 208, from which calculations are performed resulting in another level of analytics, such as sporting statistics, purchasing behavior, such as batting averages, earned run averages, team/individual standings, and the like. Data management module 208 may include multiple data storage servers located at one or more selected locations. For example, the servers could be stored in a central location or distributed throughout the communities being served.

The content management and auto-report module 210 transforms the data into a format for viewing at community event network website(s) 212 and/or at remote receivers 214 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 216. Newsroom 216 may be a newspaper newsroom, a television news station, news-based website, and the like.

In a particular embodiment, the digital exchange system 100 contains an algorithm that monitors the on-going transactions through the system. The digital exchange system 100 tracks, among other things, the following and/or performs the following calculations: monthly purchase amounts input through the system—total from all sponsors in a given community/region, breakdown by business category (categories e.g., as shown in a digital sponsor network), breakdown by business category averages, breakdown by organization, i.e., purchase amounts attributed to each organization, and breakdown by organization on a per user ID card (e.g., $100,000 of purchases were recorded in the exchange system for a specific organization and the organization has 500 ID cards, resulting therefore in an average for the organization of $200/ID card); for each participating sponsor, number of registered users in each community organization or school that have made a purchase in the recent past (e.g., by month, over the last 6 months), comparing that to the total number of registered users in each community organization or school.

In the digital exchange system 100, sponsors 106 may enter the conditions for sponsorship or to enhance sponsorship, such as purchases made on a specific day or time of day. The sponsor 106 may also enter temporary programs or promotions during which time the sponsorship levels increase. The digital exchange system 100 may also be programmed to automatically send electronic notifications to selected participants 112 and community organizations 102.

Referring again to FIG. 9, it can be seen that an embodiment includes operating the digital exchange system 100 in connection with a point-of-sale (POS) system 150. In particular embodiments, the process is initiated when, for example, a community resident, in the case acting as a participant 112, enters, for example, a retail establishment of a sponsor 106 having a POS system 150 that is capable of linking participant sales to the digital exchange server 140. One way this may be accomplished is by assigning a particular function key or keys that make the association, such that a cashier may press the function key at the beginning, during or at the end of a transaction to indicate that the transaction is to be associated with the digital exchange system 100 (see FIG. 8). In the way, the digital exchange system 100 may be credited with a percentage of the proceeds from each of these sales or a fixed predetermined amount for each sale. Those credited proceeds are then allocated to the appropriate community organization 102 in accordance with the relevant sponsorship plan 110. For example, a participant 112 may be issued an identification (ID) card having the unique identification code 116 referred to above, thus indicating an affiliation with the digital exchange.

In the manner, the POS system 150 can assign and track all sales resulting from those particular sponsorships being initiated by the digital exchange, and provide in a single document, a spreadsheet in a predetermined format for example, the total sales volume for a given period that is associated with the digital exchange. The data may be provided to the operator of the digital exchange system 100 to facilitate the transfer of any funds due the digital exchange. In a particular embodiment, the data is transferred electronically between the POS system 150 of the sponsor 106 and the digital exchange system 100. Such data transfers may occur automatically at predetermined intervals (e.g., weekly or the first day of the month). In alternate embodiments, the data may be transferred electronically between the POS system 150 and the digital exchange system 100 by system operators or automatically.

To effect the subsequent transfer of funds from the digital exchange system 100 to its various community organizations 102, in at least one embodiment, the participant 112 accesses the digital exchange system 100, via the network using a PC or via a mobile application for example, to enter relevant data concerning any transactions that should be credited to a particular community organization 102. In certain embodiments, when the participant 112 accesses the digital exchange system 100, the participant 112 is given the option of allowing any proceeds from the participant's recent transaction(s) to flow to one or more previously selected community organizations 102. The may be a default allocation for any proceeds generated for the digital exchange system 100 by the participant 112. In a particular embodiment, the default allocation to one or more community organizations 102 is stored in the digital exchange system 100 until modified or deleted by the participant 112. The participant 112 also has the option to designate one or more other community organizations 102 to receive the proceeds from any transactions being entered into the digital exchange system 100. The proceeds can be divided among one or more community organizations 102 in any percentages specified by the participant 112.

The digital exchange system 100 can be further programmed to periodically (e.g., monthly, weekly, daily, and the like) generate reports regarding purchases made under each sponsorship plan 110 during the period, allocations to community organizations during the period, and invoices to sponsors 106 and/or community organizations for services provided by the digital exchange.

However, in alternate embodiments, when sponsors 106 without a POS system 150, the cashier and/or participant may use a networked personal computer or a mobile device such as a tablet, or smart phone, or business kiosk with the appropriate application software platform to enter any data for transactions which may be requested by the digital exchange system 100. Furthermore, the sponsor 106 may have a mobile electronic communications device for the entry of information to be transmitted to the digital exchange system 100. In particular embodiments, the mobile electronic communications device may run a mobile application configured to transfer information to the digital exchange system 100 in a specific format or sequence.

For example, if the participant has an ID card and unique identification code 116 associated with the digital exchange system 100, the cashier may scan and/or enter all of the necessary data into the mobile communications device at the time of the sale. Alternatively, data may be entered by the participant, at a designated business kiosk, and may include an ID card with an identification code 116 or some other identifying information, along with the details of the particular transaction with the sponsor 106. In these cases, data can be entered into the kiosk or mobile application in an online or offline fashion. If in offline mode, the data can be transferred electronically subsequently to the digital exchange system 100.

The digital exchange system 100 may be configured to automatically reconcile the data from the participant with that provided from the POS system 150 of the sponsor 106. In certain embodiments, any inconsistencies in the data from the sponsor 106 and participant 112 are flagged by the digital exchange system 100 so that the appropriate corrections can be made.

In an alternate embodiment, the sponsor 106 may obtain certain information from the participant 112 at the time of sale to allow the digital exchange system 100 to make the allocations without additional input from the participant 112. For example, the cashier may request a phone number or ID card number from the participant 112, and the POS system may record both the digital exchange system 100 and the participant identification code 116 associated with the transaction. Without any additional input from the participant 112, the digital exchange system 100 can use the information provided by the POS system 150 to properly allocate funds to community organizations 102 (and from there to needs, programs and participants 112 within the community organization 102) based on the default selections made by the participant 112.

In the embodiment, the participant 112 may still have the option of accessing the digital exchange system 100 to modify the default allocations, or specify new allocations, for particular transactions. For example, the participant 112 may specify that all proceeds from transactions with one sponsor 106 go to a first community organization 102, while all proceeds from transactions with a second sponsor 106 go to a second community organization 102. Another exemplary, the participant 112 may specify that proceeds from transactions go to multiple community organizations 102, with specified percentage weights.

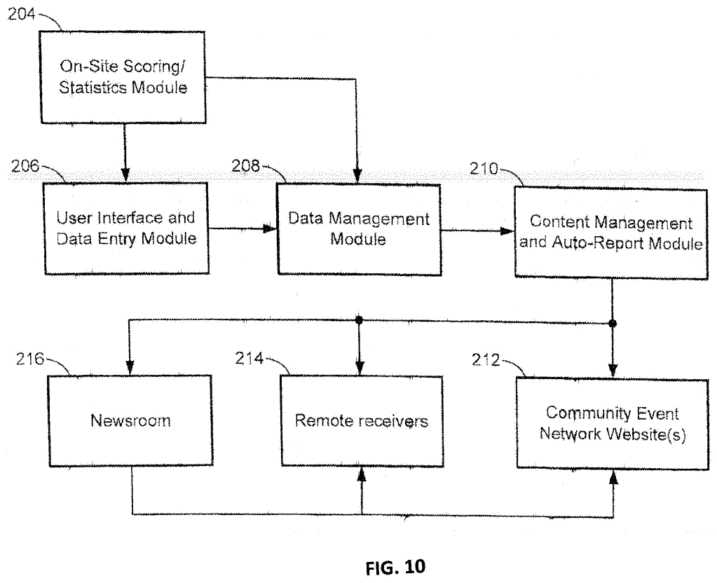

FIG. 10 is a block diagram illustrating a digital media network constructed in accordance with exemplary embodiments. In exemplary embodiments, the on-site scoring/statistics module 204 receives data from crowd-sourced reporters. The module 204 can interface with or be an integral part of hardware devices such as portable electronic scoring devices, scoreboards, etc. to automatically obtain the data. The data can include information relating to a community event, a sporting event, an advertisement, a promotional event and the like. The module 204 interfaces with a user interface and data entry module 206 that sends the data to data management module 208. The user interface and data entry module 206 may also receive data from crowd-sourced reporters. Alternatively, module 204 directly sends data to data management module 208. Data entered is stored in data management module 208, from which calculations are performed resulting in another level of analytics, such as sporting statistics, purchasing behavior, such as batting averages, earned run averages, team/individual standings, and the like. Data management module 208 may include multiple data storage servers located at one or more selected locations. For example, the servers could be stored in a central location or distributed throughout the communities being served.

In exemplary embodiments, the content management and auto-report module 210 transforms the data into a format for viewing at community event network website(s) 212 and/or at remote receivers 214 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 216. Newsroom 216 may be a newspaper newsroom, a television news station, news-based website, and the like. In an exemplary embodiment, the digital exchange system 100 contains an algorithm that monitors the on-going transactions through the system. The digital exchange system 100 tracks, among other things, the following and/or performs the following calculations: monthly purchase amounts input through the system—total from all sponsors in a given community/region, breakdown by business category (categories e.g., as shown in a digital sponsor network), breakdown by business category averages, breakdown by organization, i.e., purchase amounts attributed to each organization, and breakdown by organization on a per user ID card (e.g., $100,000 of purchases were recorded in the exchange system for a specific organization and the organization has 500 ID cards, resulting therefore in an average for this organization of $200/ID card); for each participating sponsor, number of registered users in each community organization or school that have made a purchase in the recent past (e.g., by month, over the last 6 months), comparing that to the total number of registered users in each community organization or school.

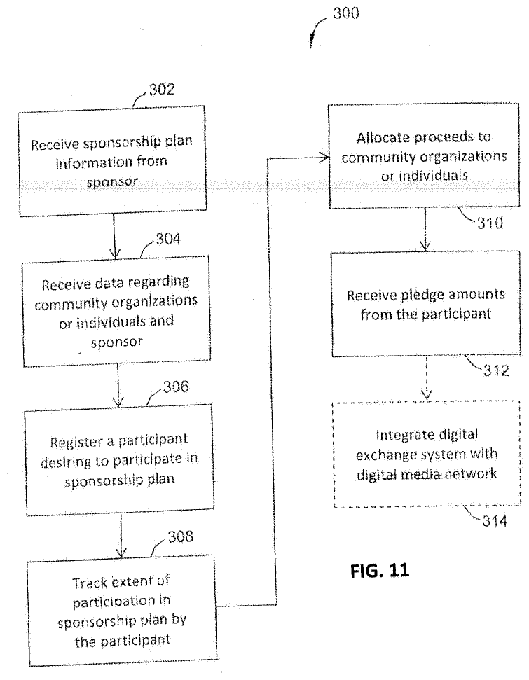

FIG. 11 is a flowchart illustrating an exemplary method of operating a digital exchange system 300. In an embodiment of the method shown in FIG. 11, the digital exchange system receives an electronic communication from the sponsor 302 with information regarding a sponsorship plan being offered by the sponsor. The information may include details on how participants can take advantage of the offer put forth by the sponsor, and how much the sponsor may contribute for purchases or other actions taken by the participant. The digital exchange also receives electronic communications from individuals, organizations, or sponsors 304 with specific profile information. The information may include personal information used to identify and communicate with the provider of the information. Information from the individual or organization may also include the amount of funding desired, the timing for obtaining the funding, the purpose for the funding, and how the funds may benefit the individual or organization and the community as a whole.

As explained above, in certain embodiments, participants in the digital exchange system may be asked to register and to provide information 306 which could be used to construct or complete a participant profile. Part of the registration process may involve issuance of a unique identification code for the participant. As also explained above, the digital exchange system tracks the level of participation in each sponsorship plan 308. The may include performing the calculations of monthly purchase amounts input through the system, breakdowns by business category, organization, sponsor, number of registered users, and the like.

The method of FIG. 11 also requires the digital exchange system to automatically allocate the proceeds 310 from participation in the sponsorship plans to the appropriate individual or organization. The digital exchange also receives electronic communications from participants with projected pledge amounts 312. The projected pledge amounts may be based on a sampling of the sponsorship proposals available for the individual or community organization being supported by the participant.

Optionally, the exemplary embodiments may include integrating the digital exchange system with a digital media network 314 (shown in phantom) that contains digital media publications configured to provide electronic magazines, websites, and mobile applications. Participants are provided subscriptions to such digital media publications, or pre-subscriptions to potential digital media publications, where the subscriptions are linked to the digital exchange system. The method may also include requesting registration of individuals for participation in one or more sponsorship offer plans or for subscription to the digital media network. Alternatively, the method may include electronically sending information regarding sponsorship and media platform subscriptions, and summarizing results of the participants and comparing the results to those of an organization or subgroup and the goals of the organization and subgroup. Further still the method may include tracking activity in the digital exchange system, allocating media coverage points, earned each time a tracked activity is detected on the digital exchange system, and notifying the one or more organizations or individuals when a specified level of media coverage points are earned, making the one or more organizations or individuals aware that media coverage on the digital media network is available.

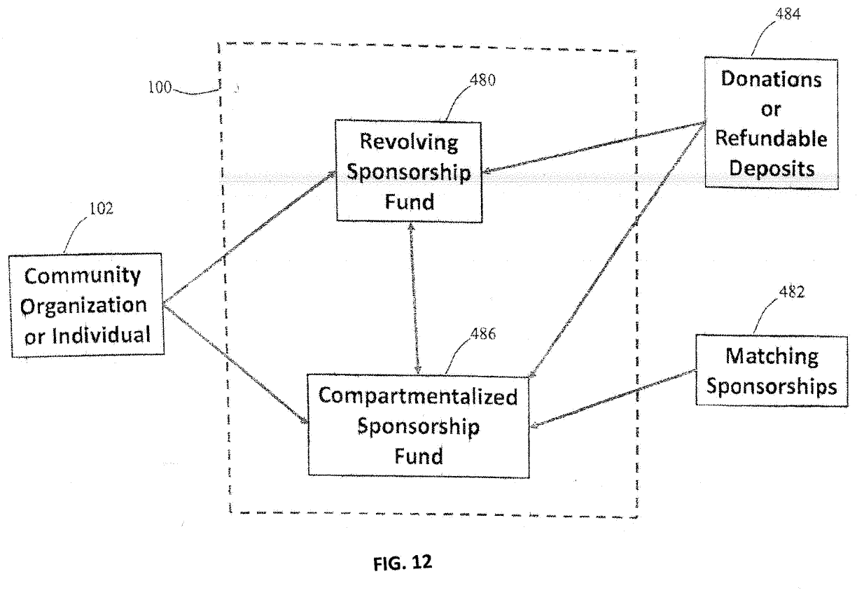

FIG. 12 is a schematic diagram showing the digital exchange system 100 that includes a revolving sponsorship fund 480, in accordance with exemplary embodiments. In exemplary embodiments, sponsors, such as corporations, businesses or other organizations, or even individuals, can electronically pledge (e.g., via the digital exchange system server 140—shown in FIG. 9) matching sponsorships 482—the matching sponsorship function being integrated with the digital exchange system 100 (see FIG. 12). In FIG. 12, the corporate and individual matching sponsorships 482 represent the system capability to electronically accept these matching sponsorship offers and to electronically account for the matching sponsorships 482 in a compartmentalized sponsorship fund 486. Therefore, once a matching sponsorship offer is pledged electronically in the system, and as individuals then make purchases in the digital sponsorship exchange system 100 (see FIG. 12), a matching sponsorship amount is also gained by the designated community organization or individual 102, as defined by the matching sponsorship offer (e.g., a $0.50 match for every sponsorship $1 earned). The digital exchange system 100 may electronically track the purchase activity and automatically account for the matching amounts, and allocate the appropriate funds to the designated community organization or individual 102.

The revolving sponsorship fund (RSF) 480 may be established to allow funds to be developed, consumed, and replenished by the community organizations or individuals 102 (see FIG. 12). The RSF 480 is an account where community organizations (or programs within the community organization) or individuals 102 can at times borrow an amount of money as needed—similar to a line of credit—from the RSF 480. The RSF 480 may be established electronically by one or more individuals or entities via refundable deposit or donation 484 and supplemented or replenished through purchase activity in the digital exchange system 100. Further, a pledge system may be utilized to establish the support group for the community organizations (or program within the community organization) or individuals 102 to borrow from the RSF 480, i.e., a group of people are registered in the digital exchange system 100, linked to a particular community organization or individual 102 within (e.g., a specific team in a sports organization or the drama club or a sports program within a school). As shown in FIG. 12, funds may flow between the RSF 480 and the compartmentalized sponsorship fund 486, when desired by the provider of a donation or refundable deposit 484 for example. Additionally, funds from the revolving sponsorship program 480 may be temporarily held in a compartmentalized sponsorship fund 486 for one of the one or more community organizations or individuals 102.

The registered users linked then pledge amounts of sponsorship through participation in the digital exchange system 100, e.g., $10/month for a year, the pledge amounts are tallied, when the collective or aggregate pledge amount reaches a predetermined sponsorship level over a specified period, the RSF funds such as, e.g., a line of credit, become available for the community organization or individual 102 and the digital-exchange-system users then participate in the digital exchange system 100 with the objective of achieving the sponsorship amount as pledged. A refundable deposit may be provided as well as a donation 484. The refundable deposit 484, like a donation, can be directed at the RSF 480 or directly to a community organization or individual 102 through a compartmentalized sponsorship fund 486 (see FIG. 12). In certain embodiments, an interest rate is attached to the refundable deposit 484.

In certain embodiments, digital exchange system 100 facilitates the acceptance of sponsorship proposals that include a “pay-per-pledge” term, where an electronic exchange occurs between an individual, community organization, or program within a community organization, and the prospective sponsor before the terms of the sponsorship proposal have been fulfilled. The community organization participants collectively pledge to purchase an amount, thereby yielding an amount of sponsorship. The “pay-per-pledge” term in the proposal, once the proposal is accepted as part of the sponsorship plan, is one where the sponsor pays a portion, or all, of the pledged sponsorship amount up front before the purchases take place. In addition to enabling the pay-per-pledge feature, where participants collectively pledge to make purchases for a sponsorship amount from a sponsor, the digital exchange system 100 may also electronically notify the sponsor of the pledged amount, and electronically invoice the sponsor for some, or all, of the sponsorship amount resulting from pledged purchases.

In another embodiment, the participants in a same cause may together send a TCard using the cryptocurrency, which may provide connections between these participants based on the shared caused-based transaction. Similarly, if a TCard/Tcoin is received by a group of individuals such as, e.g., members of a non-profit, a connection is created between these individuals. A portal, e.g., an exclusive portal, may be created to connect these individuals or organizations, thus creating a cause-based social network. For example, the portal may be stand-alone, or may be embedded in a third-party website, where the third party may label the transaction a cause-based transaction and thus gain the benefit of enhancing their reputation by supporting cause-based transactions. For example, if the third party is a social media platform, then the third party may gain the benefit of promoting ethical/social causes while marketing its own platform.

In exemplary embodiments, the transaction history of each user of the platform may provide the key content of a social network which is based on where and how people share their money and gratitude. In developing and growing the platform, new ways of extracting and leveraging these networks may be developed in furtherance of ethical/social causes.

Most cryptocurrencies provide a public secure transaction history in the form of their underlying blockchain. The transaction history can provide the armature of a social network which is based on where and how people share their money and gratitude. In developing and growing the platform, new ways of extracting and leveraging these networks may be developed and can be protected. This realization is already part of non-cryptographic commerce platforms and addressing the associated challenges.

A greater discussion regarding loyalty and rewards programs in the context of digital currency is provided below.

Notwithstanding the known techniques for disseminating advertising and promotional materials virally through social networks, there remains a need for a mechanism that ties a customer's purchase, whether transacted on-line or physically at a point of sale on the seller's premises, with the customer's unique identity (e.g., a customer loyalty card ID) and effectively rewards the customer and his or her networked friends as a function of the customer's purchasing activity.

According to exemplary embodiments, a network platform for marketing products or services to consumers, includes a transaction source for processing a purchasing transaction between a given business and a customer, and for producing corresponding transaction data including at least a unique identifier for the customer. A networking server is coupled to the transaction source and has a corporate network or web interface to enable the business to define marketing campaigns and enter data and information concerning customers of the business, and a consumer network or web interface. The consumer network interface enables each customer of the business to conduct at least one of (a) manage integration of social network(s) to which the customer belongs with the business, (b) customize the form or content of announcements or messages communicated to friends or followers of the customer on the social networks, (c) opt in or out of services made available to the customer by the business via the corporate network interface, (d) group the customer's friends selectively for targeting by the marketing campaigns defined by the business, and (e) obtain statistical data relating to the customer's patronage of the business. The networking server also has a social network interface for enabling the server to communicate with one or more social networks that each customer of the business designates through the consumer network interface of the networking server.

The inventive network system interfaces a customer's purchase, whether conducted physically at a retailer's premises or on-line, with one or more web based social networks to which the customer belongs. Referred to herein as a Social Network Appreciation Platform or SNAP, the system enables a retail business or vendor to communicate not only with a given customer, but also to market virally to selected friends over the customer's social network.

SNAP can be hosted by a web server or server farm, and it offers web portal access for a given business and for customers who create individual SNAP accounts with the business. A business web portal provides a backend tool for the business to create marketing campaigns that communicate, e.g., messages, coupons, and invitations for an event to a customer's friends using the customer's social network accounts. A customer web portal allows each customer to attach a unique identifier (e.g., a loyalty card or a gift card ID) issued by a participating business, to the customer's SNAP account.

Accordingly, customers can enable social networks of which they are members to open channels of communication from a participating business to the customers' friends, in return for a customer benefit that is offered by the business. Importantly, the customer web portal enables each customer to exercise complete control over the flow of any business marketing campaign to the customer's network of friends, and the portal can provide the customer with statistical data based on his or her own patronage of the participating business.

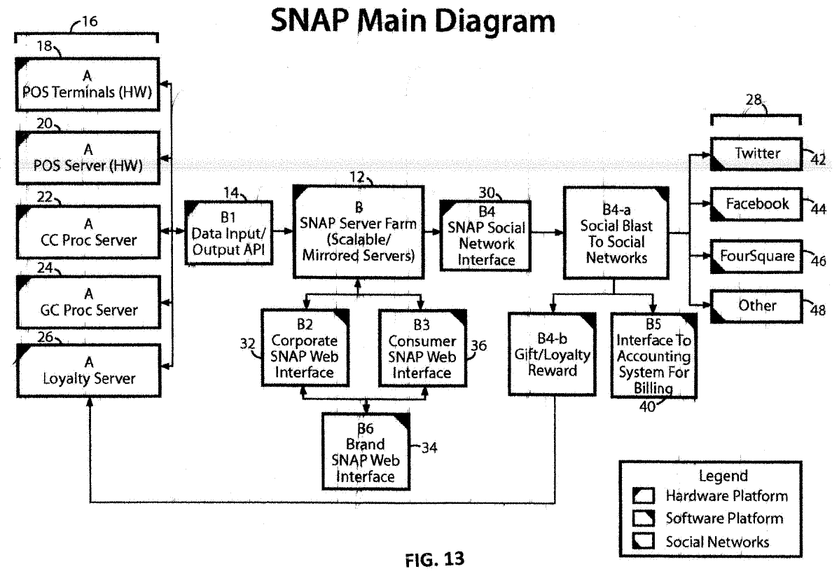

Businesses can market through SNAP to their customers and their customers' friends in a number of ways, such as, e.g., Social Postings/Customer Rewards, Social Following, Social Announcements, Social Coupon, Social Bonus, Social Party Plan/Date, and Social Sharing. Additionally, SNAP can offer statistical data and analytics to the business and to consumers in the form of graphical block diagrams and leader boards. A gaming factor is incorporated into SNAP as well through an engine configured to generate “badges”, kudos or awards. The foregoing features are explained in detail below. An exemplary workflow of the components of the SNAP system is illustrated in the block diagram in FIG. 13.

A transaction within SNAP begins with the submission of information containing a unique identifier to a SNAP server 12 through an API (Application Programming Interface) 14 from an originating source 16. The SNAP server 12 is programmed and configured to process the submitted information, match a unique identifier to the consumer's associated SNAP account, and communicate an appropriate message to selected friends on the consumer's enabled social networks while also providing businesses and consumers with web portal access for marketing campaign and account management. Exemplars of the source 16 include, e.g., a Point of Sale (POS) station 18, a POS server 20, a Credit Card Processing Server 22, a Gift Card Processing Server 24, and a Customer Loyalty Processing Server 26. The SNAP Server 12 is operative to process the information from the source 16, communicate with social networks 28 associated with the consumer's SNAP account, and also provide businesses and consumers with web portals for marketing campaigns and for account management.

The transaction source 16 that initiates the SNAP process submits the information or data required in order for the SNAP server 12 to route information associated with the transaction between businesses and the social networks. As mentioned, the transaction sources include, but are not limited to, the Point of Sale (POS) station 18, POS server 20, Credit Card Processing Server 22, Gift Card Processing Server 22, and Customer Loyalty Processing Server 26. The source 16 typically submits its information upon completion of a business transaction, as in the case of a point of sale transaction. Once the sale is completed, the source 16 submits the transaction data to the SNAP server 12 through the API 14. The information includes at least a unique identifier, plus other information such as, but not limited to, line item data, accumulated bonus points, business location data, and/or dollars spent.

The SNAP server 12 includes a central server located, e.g., on the cloud or in a climate controlled server farm. The server(s) may include a CPU, redundant storage (RAID), and redundant power supplies for running SNAP's web service. The web service is configured to provide such functionality as to allow a business to sign up for service, create a customized business web portal for the business's customers, add/edit customized marketing campaigns, and provide statistical data/leader info on patrons.

The web service also provides a customer web portal to allow a participating business's customers to (a) manage the integration of their social network(s) with the business, (b) customize the output or content communicated to friends of the customers on the networks, (c) opt in/out of certain services, (d) group friends/followers for certain campaigns, and (e) provide or obtain statistical data on their patronage of participating businesses.

The SNAP server 12 also provides an engine to open communication from participating businesses to the social networks 28, based on customized campaigns. A SNAP Social Network interface 20 is configured to contact available social networks and to disseminate information to friends and followers of participating consumers, based on the customer's preferences.

Information may be submitted to and received from the SNAP server 12 through a secure connection in a certain format using parameters specified in the SNAP SDK, and through secure SSL (Secure Sockets Layer) transmissions. Once information is submitted, the SNAP server 12 is configured to process and store the applicable data and to trigger an event relating to the products or services offered by the business and the information that is submitted. For example, if the business sends data to the SNAP server 12, and the SNAP server determines that the data reflects a marketing campaign to perform a Social Announcement, the server may store the supplied unique identifier plus other relevant data, and then trigger a posting to the customer's enabled social networks via the SNAP Social Networking Interface 30.

The SNAP Corporate Web Portal 32 is a tool for businesses to create and manage their customer facing web site, create marketing campaigns, choose which social networks to connect with, and categorize customers for the purpose of marketing to specific groups. Within the Corporate Web Portal 32, messages to be sent to various social networks can be defined, and coupons can be created for specific groups of customers or all customers who patronize the business. The Corporate Web Portal 32 is configured to provide the tools necessary for the business to create a customer facing web site, or a SNAP Brand Web Portal 34, to refer a customer to a web site where the customer can register their unique identifier (e.g., a loyalty or gift card issued to the customer from the business) with one or more social networks of the customer's choosing. The information is stored within a central SNAP database hosted on the SNAP server 12, so that it is accessible to the customer for account management purposes through a separate Customer Web Portal 36.

The SNAP Corporate Web Portal 32 is also configured to allow a business to use its logos and color schemes in order to retain the flavor of the business's own web site or its brand identity. Within the SNAP Corporate Web Portal 32, leader boards and statistical data may be made available based on consumer patronage. Statistical data can be displayed in a dashboard format. And leader board information can be made accessible to the business's Sources (POS Servers, or stations) through the SNAP API 14, for the purpose of displaying the information on digital signs within the store as well.

A business may also organize leading customers into groups and offer additional benefits for attaining Elite Status. For example, if a customer reaches 50 bonus points in a three month period, they reach Elite Status by which they earn double bonus points per transaction. A company may also choose to create additional benefits or marketing campaigns to members of such groups.

The SNAP Consumer Web Portal 36 offers the customer a central location to manage their customer services for each participating business. For example, within his or her personal account, a customer may perform functions such as, but not limited to, (i) enabling/disabling available social networks 28 with each business's unique identifier, (ii) opt in or out of any of the services, (iii) choose from a list of social announcement messages, and (iv) choose to which friends or groups of friends the business may channel announcements, ads, and/or marketing campaigns. Global settings may include an ability to enable/disable social networks 28 among all participating businesses with which the customer has an account.

A leader board may also be made available to the customer, as well as their standing among all the businesses with which they have an account. The SNAP Consumer Web Portal 36 may also allow a user to view accumulated bonus points/rewards earned from each business, as well as their group standing (e.g., Elite Status) if applicable. Statistical data may be displayed in a dashboard format.

Within the SNAP server, the SNAP Social Network Interface 30 is configured to process information submitted by a Source 16 through the SNAP API 14, and to route corresponding data to the social networks 28 based on the Source business's marketing campaign. The Social Network Interface 30 is operative to determine the business's submitted information that has been stored in the SNAP database in the server 12, and to open communication to the applicable social networks 28 based on the business's and the corresponding user's preferences.

Once each communication transaction is successfully completed, the SNAP Social Network Interface 30 may award a bonus point, if applicable, for each transaction posted. The SNAP Server 12 may either route the information back to the Source 16 in response to a query from the source, or deposit the information with an appropriate processing network (e.g., Loyalty Processor, Credit Card Processor, Gift Card Processor, or the like). In embodiments, all of the SNAP services, described further below, use the Social Network Interface 30.

The SNAP Server 12 is also programmed and configured to connect with an accounting system for purposes of billing. For example, each business may subscribe to the SNAP service for a monthly fee, plus transaction fees. A transaction takes place each time a message is successfully posted to a social network 28. The SNAP Accounting Interface 40 operates to track each successful posting from any service offered by SNAP, and to report the accumulated transactions per business account to a SNAP accounting system. The allows the SNAP provider to bill all the participating businesses appropriately at, e.g., monthly intervals, based on actual transaction data generated by the SNAP server. The billing program may itself be web-based, or proprietary.

As mentioned, the SNAP Corporate Web Portal 32 allows a participating business to create a customer facing web site or SNAP Brand Web Interface 34 dedicated to each of its customer's enabled SNAP features. The site enables a customer to register a unique customer identifier (e.g., a loyalty card) with those social networks 28 available to the customer. Within the site, a customer may view their accumulated bonus points, patronage statistics per location, leader boards, as well as their ranking within each location of the participating business.

The SNAP Brand Web Interface 34 may be accessed through the SNAP Consumer Web Interface 36 as well. When a customer logs into the SNAP Consumer Web Interface 36, they may have access to each of a number of SNAP Brand Web Interfaces 34 created by all of the business with which the customer has registered. Each SNAP Brand Web Interface 34 may be customizable by the participating business with respect to business logos, color schemes, text content and the like.

The SNAP Social Networking Interface 30 is configured and arranged to communicate with various social networks 28 using, e.g., the OAuth method, or other means of secure communication. SNAP adheres to the rules of each social network when submitting/querying data. The platform may of course be configured to integrate with other, additional social networks 48 in the same or similar fashion.

When enabled, SNAP communicates with Twitter 42 through a secure API (OAuth) to post a message. Twitter allows a limited number of characters, so the message should be predefined by the business in order to comply with Twitter's parameters. When a participating business's customer opts in to allow a connection to be made to Twitter, the effectively authorizes SNAP to make such a connection for purposes of communicating data from the business to followers of the user on Twitter.

When enabled, SNAP communicates with Facebook 44 through a secure API to post a message on a customer's message board. The customer's friends on Facebook may then be able to view the posting when they log into their account. The customer can choose which friends are to receive these messages through the SNAP Consumer Web Portal 36. The same parameters may be used when generating a message for Facebook 44 as with Twitter 42 (i.e., comply with the number of character restrictions).

FourSquare 46 differs from Twitter 42 and Facebook 44 in that FourSquare is a location based social network. A user can check in while at a location to earn points within FourSquare. FourSquare is generally used in conjunction with a GPS enabled smart phone that contains a FourSquare application. The phone's GPS determines the user's location, and the user informs FourSquare of the location. The user may earn a certain status for the location if they exceed the number of visits reported by other users.

For example, one may become a Mayor of that location if they have checked in from the location the most times. If a customer enables FourSquare on the SNAP service, the customer may be checked in upon completion of a transaction at a participating business, wherein the business submits the customer's location information to FourSquare under the customer's account in order to check them into that location. The business may also offer special promotions through SNAP if a customer reaches a certain status within FourSquare.

As mentioned, the services offered by SNAP enable a participating business to market a number of different ways to existing and potential customers through social networks. Each service is described below.

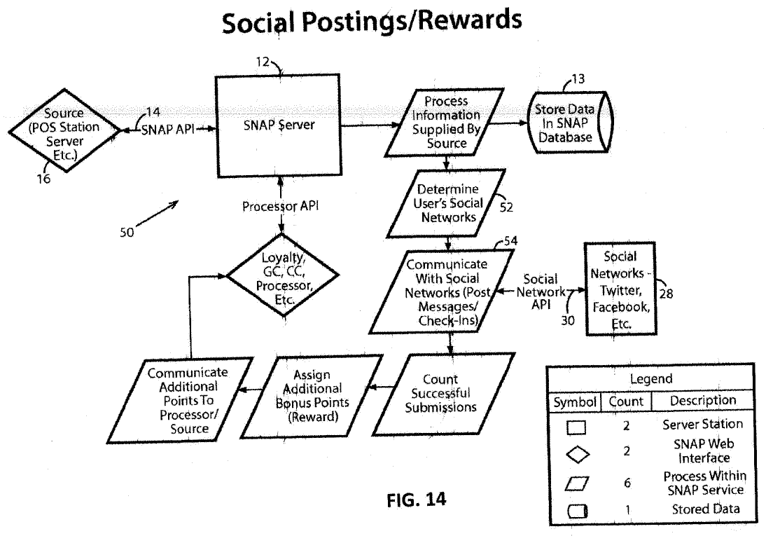

A Social Postings/Customer Reward service 50, illustrated in FIG. 14, enables a participating business to send a “tweet”, a message posting, or a FourSquare check-in on behalf of a customer upon completion of a transaction. For example, if a customer uses their loyalty card at a local frozen treat retailer at checkout on a point of sale system, the POS terminal 18 or its server submits the loyalty card information including the customer's unique identifier along with the customer's current accumulated bonus points, business location, and any other relevant information to the SNAP server 12 via the SNAP API 14. The SNAP Server 12 then invokes the Social Postings/Customer Reward service 50, if enabled by the business, as a marketing campaign.

At the point, the SNAP server 12 determines (at 52) which of the Social Networks 28 the customer has registered. Assuming all listed social networks are enabled, a corresponding posting is made (at 54) to Twitter, Facebook, and all other social networks (e.g., “I just received five bonus points at Frozen Treats, Pearl River, N.Y.”). The text and graphics of the posting may be chosen randomly from a list of predetermined postings defined by the business. In embodiments, the consumer may alter the list of possible postings or choose a particular posting from among the list, by way of the SNAP Consumer Web Portal 36.

If enabled, an automatic check-in on FourSquare including the business location may trigger as well, and the SNAP server 12 may issue an additional bonus point (if applicable as part of the business marketing campaign) for each successful communication. The information may be communicated back to the Source 16 or the loyalty processor [#?] depending on which service the business uses for the loyalty plan. Information that is sent back to the source 16 or processor [#?] need not be limited specifically to a loyalty service. Accordingly, the process allows a participating business to incentivize their customers to market the business's goods or services to the customer's friends.

A Social Following service 60 informs a participating business whenever the business is mentioned on a social network. This provides the business with valuable information as to how their company is perceived or discussed in the marketplace. The information supplied by the SNAP Social Following service 60 is found, for example, by logging into the SNAP Corporate Web Portal 32, and may also be e-mailed to a specified e-mail address set up within the Corporate Account Management component of the Portal 32. Text Messaging of the notification can be an option as well.

The SNAP Server 12 queries the various social networks 28 through the API 30 provided by the network, and checks for certain keywords relating to the business or its name. Criteria for the Social Following Service 60 can be set up through the SNAP Corporate Web Portal 32. If a query returns a positive response, the found message containing the keywords is displayed in list format within the business's Portal 32. If enabled, an e-mail may also be sent to a specified e-mail address.

A Social Announcement service 70 enables a participating business to create a message that is sent to any or all of the social networks 28 by creating a marketing campaign directed to a group of customers or all customers who register their social networks to the business through SNAP. The message can include text, and contain a graphic for those social networks 28 that support graphical postings.

The ability for the business to post messages in the fashion allows the business to launch a marketing campaign rapidly from one central web site. The campaign is generated within the SNAP Corporate Web Portal 32 and stored within the SNAP database 13 to be available for future use. Once the messages are posted, any click through responsive to the message is tracked by the SNAP Social Announcement service 70 to provide statistics on the launched marketing campaigns as well as the ability to offer a reward to the originating customer. A reward can take the form of additional bonus points, discounts or special coupons, and can be set up when developing the marketing campaign. In addition, the form of marketing campaign can be set to allow a customer to store the announcement within their personal SNAP Consumer Web Portal account for the purpose of re-sending or sharing it with their friends using a Social Sharing service (discussed below). The information is also accessible through the reporting section of SNAP Corporate Web Portal 32.

Traditional loyalty (e.g., incentive award, frequency reward, and the like.) programs have been around for years. Loyalty programs are typically used to help businesses develop and maintain participant loyalty and are used as marketing tools to develop new clientele. A frequent flyer program is an exemplary of a typical loyalty program, where the more the participant uses a particular airline or group of affiliated airlines the more frequent flyer miles the participant earns. After accumulating frequent flyer miles, the participant may choose to redeem those miles for upgrades in service or free airline tickets. Various forms of these programs have developed over the years, ranging from programs such as “buy 9 get one 1” punch cards to more sophisticated credit card loyalty systems, where participants are awarded points for using a particular transaction card and/or by using a transaction card with particular merchants or vendors. As competition in various markets increased, companies sought ways to expand loyalty programs to appeal to a broader cross-section of potential customers. One way this is accomplished was by developing strategic partnerships and affiliations with other business sectors. For example, hotel chains, airlines and rental car agencies developed loyalty program partnerships and affiliations; credit and transaction card companies also joined in to promote a more comprehensive and appealing loyalty program. These programs have been successful, but again were limited in that the loyalty points could only be redeemed within the network of companies in the loyalty program affiliation or partnership. For example, U.S. Pat. No. 5,937,391 ('391); U.S. Pat. No. 5,774,870 ('870) and 6,009,412 ('412); and U.S. Pat. No. 5,025,372 ('372) (all of which are hereby incorporated by reference) illustrate recent efforts to create more attractive loyalty systems.

The '391 patent is directed to an enhanced or improved method of accumulating, managing, and redeeming points with a point-service system in an online shopping mall established through a network. The system utilizes point accumulation and points redemption ratios based on particular vendors in order to vary the amount of points awarded and the value of points redeemed. The system is limited, however, to a participating network of vendors that accept redemption of points for product, i.e., the system is not compatible with merchants who do not accept points and are not integrated into a shopping mall. The system is also directed to managing, within a network of participating vendors, the accumulation of points from one vendor (with a particular accumulation ratio) and redemption of points with another vendor (with another redemption ratio).

The '870 and '412 patents both relate to an online, interactive frequency and award redemption program which immediately awards and issues bonus points to a user's awards account in response to that user's online purchase of merchandise. In other words, submission of a purchase order form during an online session results in the calculation and addition of points to an enrolled user's account as well as the display of current account information. The user is then immediately permitted to redeem any or all of the award points in the user's account, including currently awarded points, in that same online session. The system is specifically directed to expediting the award and redemption of points for product. Therefore, exemplary embodiments may include redeeming points within a redemption network of merchants who accept points.

The '372 patent generally relates to an incentive award program which allocates monetary amounts of credit based on a participant's performance of a designated level of achievement. The monetary amounts can be withheld and/or adjusted by a sponsoring company. Although the system allows for the crediting of a monetary value to a credit instrument, it is limited in that the participant is not able to interact over a computerized network with the system so as effect a real-time transaction or to effect a real time credit to a credit instrument.

Although many of these programs have been successful in developing customer loyalty and incenting customers to act, they have presented participants with limited opportunities to redeem loyalty points for the products of their choice or have provided participants with limited accessibility and control of their loyalty account. Therefore, a need exists in the industry for a program that expands product choice for loyalty program participants, while offering better real-time control of one's account.

In general, exemplary embodiments overcome the limitations and problems of the prior art by providing a system and method for facilitating virtually any transaction over a computerized network using any type of loyalty program. The system is not limited to merely exchanging loyalty points for product. In an exemplary embodiments, a participant desiring to apply loyalty points to facilitate a particular transaction over a computerized network such as the internet: (1) uses his or her charge card number to make an online purchase, (2) associates the charge card account with a loyalty account; and (3) invokes a process to apply a currency value credit (corresponding to a defined amount of loyalty points) to the participant's designated charge card account. The currency value credit may offset all or part of a corresponding purchase. Therefore, loyalty points are not used to make the purchase, but may be used to offset at least part of a corresponding charge. The integration of the loyalty program and existing transaction (e.g., charge card) account processing systems is generally transparent to the merchant in that the merchant may be unaware that the customer is using loyalty points by offsetting at least part of the charge with a corresponding credit. Additional embodiments relate to the crediting of a variety of different accounts to facilitate particular transactions.

The exemplary embodiments may or may not be integrated into a merchant or shopping network. The integrated exemplary embodiments (“the integrated system”) provides for an explicit and known relationship or interface between (1) a merchant or group of merchants (i.e., shopping or redemption network or gateway) and (2) the account manager (the loyalty program host system). The non-integrated embodiment (“the standalone system”), allows the systems and methods of the exemplary embodiments to function independently of the merchant network, where the participant may choose to redeem loyalty points for a currency equivalent credit without regard to a particular merchant, a network of merchants or a corresponding transaction. For example, a participant possessing a card provider A's (or account manager's) charge card and participating in an affiliated loyalty program, may use loyalty points to facilitate a transaction with any merchant that accepts card provider A's charge card.

An exemplary system and method of the exemplary embodiments is generally described herein, in terms of a transaction phase, a transaction authorization and settlement phase, and an account reconciliation phase. During the transaction phase, a loyalty program participant desiring to spend accumulated loyalty points generally selects products or services for purchase from an individual merchant or a shopping/redemption network of merchants. For example, in an online transaction, the participant may select a “pay with loyalty points” hyperlink button, thereby invoking a process to convert accumulated loyalty points to some currency value such as a credit to a participant's financial transaction account. After selecting a given product or service to purchase, the participant provides his or her transaction card number and the transaction is processed as with any other transaction. Additionally, in one embodiment, before the transaction is allowed to go forward, the account manager verifies that sufficient credit is available on participant's financial transaction account and/or sufficient loyalty points are available in participant's loyalty account. In the case, a charge authorization system is accessed to compare the transaction details with account information stored in the participant's loyalty account and the participant's transaction account.

During the verification process, the account manager's loyalty system middleware determines the appropriate number of loyalty points to use by implementing a conversion processor that converts the participant's loyalty points to an appropriate currency equivalent (e.g., 100 loyalty points=$1 US). For example, taking into account the 100 to 1 conversation ratio, if the transaction amount is $100.00, the loyalty point equivalent would be 10,000 points. If the participant confirms the use of designated loyalty points to complete the purchase, the participant's loyalty account is reduced by the appropriate number of loyalty points and the merchant proceeds with the transaction authorization and settlement phase to complete the transaction.

Additional exemplary embodiments relating to the transaction phase contemplate, inter alia, (1) use of a temporary account number (“secondary transaction number”) instead of a physical transaction card number, (2) integration of a shopping or third party redemption network, (3) integration with external loyalty programs or commercial transaction networks, (4) redemption and conversion of loyalty points for gift products or charitable donations, (5) redemption and conversion of points without a corresponding purchase, e.g., for cash or statement credit, (6) transfer of loyalty points from one party to another, (7) transfer of loyalty points to different transaction instruments or consolidating points onto a single transaction instrument.

Further, the transaction phase may occur over any computerized network via any suitable user interface system (e.g., internet, phone, wireless, POS terminal, and the like.). As used herein, the term “computerized network” includes, but is not limited to any network implemented in the form of a wire-based network (including telephone and cable lines), or as a wireless network (including satellite or cellular networks). It should be noted that the conversion ratio may vary from merchant to merchant according to the merchant's affiliation, if any, with the loyalty program or account manager. Through the loyalty system middleware conversion application, the account manager may adjust conversion ratios to take into account various promotional or incentive marketing programs in order to better serve the needs of its participants or affiliated merchants. By further exemplary, if the account manager desired to run a promotional program with a valued merchant, the conversion ratio for using loyalty points at the valued merchant (10 loyalty points=$1 US) may be twice the amount for that of an ordinary merchant (20 loyalty points=$1 US).

As with traditional purchases using transaction cards, the transaction card details (e.g., transaction card number, expiration date, and the like) are provided to the merchant or shopping network system to complete the transaction. The merchant then processes the transaction card number (and associated transaction details) for authorization and settlement as is generally done with routine transaction card purchases. The transaction authorization and settlement phase supports the processes of submitting a transaction record to the account manager (e.g., card provider or acquirer) for payment. A financial capture system captures the financial information and transaction details and sends the information to an accounts payable system to pay the merchant and to an accounts receivable system to update the participant's transaction card account record to reflect the transaction event and applicable charge.

During the account reconciliation phase, the accounts receivable system reconciles the charge for the particular transaction with a credit from the participant's loyalty account. In one embodiment, for each charge where the participant selected to pay with loyalty points, there may be a corresponding and offsetting charge to the account. In another embodiment, where the account participant desires to pay only part of the transaction amount with loyalty points, the loyalty credit may only partially offset the merchant charge and the remainder may be paid with the participant's transaction card. In a third embodiment, there may be a credit from a participant's loyalty account without a corresponding transaction charge, such as is the case with a gift certificate embodiment, where the points are converted to a currency credit and issued in the form of a gift certificate; or stored on or downloaded to a stored value card or smart card.

In general, the exemplary embodiments integrate a loyalty program and the financial transaction systems of a transaction card provider (“account manager”) to more effectively use loyalty points to facilitate transactions. Specifically, the system and methods described herein, allow an individual to convert loyalty points to currency in order to facilitate a purchase or other transaction. The system not only provides a mechanism for converting loyalty points to a currency credit to purchase merchandise, but it also comprises existing account manager settlement systems such as accounts receivable and accounts payable processes to facilitate transaction processing.

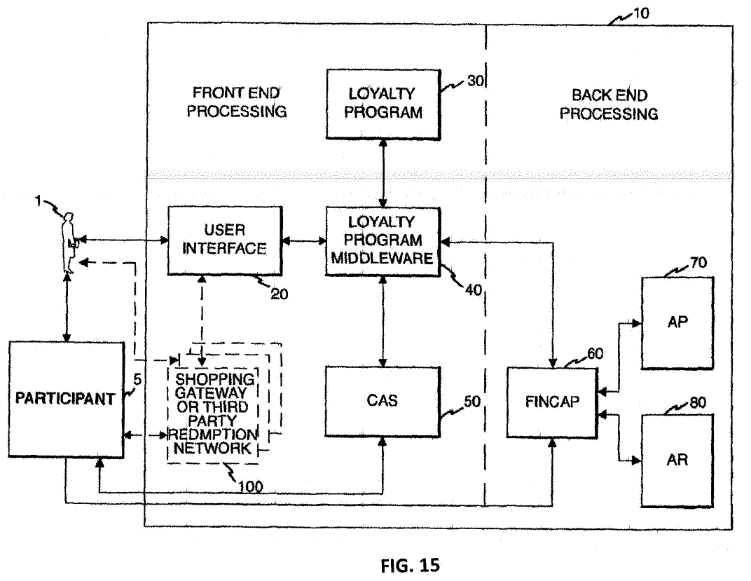

FIG. 15 illustrates exemplary components of the exemplary embodiments. To facilitate a transaction using loyalty points, a participant 1 engages a merchant 5 to purchase a product or service using currency credit generated by conversion of loyalty points. The merchant 5 need not be affiliated or partnered with any loyalty program, shopping network, or third party redemption system, although the arrangement is contemplated by an exemplary embodiment, as shown in FIG. 15 (shopping gateway or redemption network 100). Further, unlike traditional loyalty programs, the merchant 5 may not even be aware that the participant 1 is using loyalty points to facilitate the transaction because the merchant 5 processes the transaction using a participant's financial transaction account information just as with any other transaction where a transaction card number is used for payment. The account manager 10 handles the processes to convert the loyalty points to a currency-equivalent and to then credit the participant's financial transaction account with an amount that may offset a charge associated with a particular transaction. As depicted in FIG. 15, an exemplary system of the exemplary embodiments may comprise various subsystems and applications, some of which are part of the loyalty program, some of which are part of the financial transaction account system, and some of which are used to facilitate interaction between the two systems. The exemplary systems are, inter alia, a User Interface System 20, a loyalty system middleware 40, a loyalty program 30, a card authorization system (CAS) 50, a financial capture system (FINCAP) 60, accounts payable (AP) 70 and accounts receivable (AR) 80 systems. The exemplary components and participants of the exemplary embodiments are described below in more detail.

The participant 1, as used throughout the application, should be understood to mean any individual, business or other entity that desires to use any non-currency tender such as loyalty points to facilitate a transaction. The participant 1 may also be known as and occasionally referred to herein as a “customer,” “cardholder,” “user,” “card member,” or the like. In an exemplary embodiment, although the participant 1 may be an existing credit card holder, this is not required. Although the participant 1 may generally be enrolled in a loyalty program, and may have accumulated loyalty points, this is also not required.

In exemplary embodiments, although the non-currency tender referred to throughout the disclosure is frequently referred to as “loyalty points,” exemplary embodiments are not so limited. It should be understood the loyalty points includes any type of non-currency tender, such as coupons, frequent flyer miles, incentive awards, frequency awards, and the like. One exemplary of loyalty points contemplated by exemplary embodiments is the membership reward points awarded to participants in the reward program. The “merchant 5” is any individual, business or other entity who transacts with the participant 1, whether or not in exchange for goods or services. For example, in one embodiment, a merchant 5 may be an online bookstore. In another embodiment, a merchant 5 may be a local hardware store utilizing a point of sale system. In other situations, the merchant 5 and the participant 1 may be the same. In other situations, the merchant 5 may be the same as the account manager 10. Although certain embodiments contemplate the merchant 5 being affiliated or partnered with a shopping network as shown at 100 in FIG. 15, this is not required. Although referred to herein as “merchant,” the term contemplates situations where any second party receives a form of currency from a first party, such as, for example, where a participant 1 gifts a product (e.g., gift certificate) containing a currency credit to another individual. For example, a participant 1 may desire to convert loyalty points to a currency-equivalent value to generate a gift certificate for use at a particular merchant 5.

The term “transaction” not only contemplates an exchange of goods or services for value from one party to another, but also the gifting of something of value from one party to another. The may be, for example, gifting of a merchant gift certificate as described above or gifting of loyalty currency from a first party account to another account. Additionally, transaction or transaction card numbers are account numbers that are used to facilitate any type of transaction. As used herein, a “transaction card” may include any account used for financial and/or loyalty transactions wherein the account may or may not be associated with a physical card, such as a charge card, credit card, debit card, smart card, bar-coded card, magnetic stripe card, account number, internet account, internet card, personal digital assistant account, digital wallet account, airline card, mall card, frequent shopper card, and/or the like.

The account manager 10 as defined herein includes any individual, business, or other entity; or group or affiliation of individuals, businesses or other entities, that facilitates the processes of the exemplary embodiments. The account manager 40 may also be known as and occasionally referred to herein as “card provider,” “card issuer,” or the like. It should be appreciated that although FIG. 15 depicts the loyalty program 30, loyalty system middleware 40, CAS 50, FINCAP 60, AR 70, AR 80, User Interface 20 as contained within one account manager system, it should be appreciated that the account manager 10 may comprise many sub-components, subsystems and/or a variety of business entities. While a closed-loop network may contain many, if not all of the subsystems in FIG. 15, an open network system may utilize various acquirer and issuer networks and components that make up the various systems in FIG. 15. One skilled in the art may appreciate that these systems may be one system, distributed systems or any other arrangement of systems in any form, such as software, hardware, and the like. In short, the various subsystems described herein may be contained within one account manager 10 system or within the systems of many account managers 10.

Communication among the account participant 1, merchant 5, the account manager 10 or additional third parties (as may be contemplated by various embodiments) may take place over any computerized network via any suitable user interface system 20 that allow for the exchange of analog or digital information. As such, these systems may include, but are not limited to, telephone interactive voice response or operator-facilitated systems, online or offline computer networked systems using various transfer protocols, wireless devices, personal data assistants, interactive TV, broadband, ultrawide band devices, transponders and the like. For example, the user interface system may comprise web servers and applications configured to facilitate client/server communication over the internet via any wireless or wire-based system.

The loyalty program 30 may be any computer system for managing, tracking, and/or reporting loyalty program information. As previously described, the traditional loyalty systems allow participants to accumulate points in a loyalty program account and to then redeem points for merchandise loyalty program 30, as contemplated by the exemplary embodiments, may be a stand-alone system or may be affiliated or integrated with other loyalty programs or transaction networks. The component parts of an exemplary loyalty program 30 generally include computer server and database systems for processing and storing loyalty program account information. As depicted in FIG. 15, the loyalty program system may exist within the account manager's systems. Alternatively, the loyalty program system may be a separate loyalty program managed by a third party. The loyalty system middleware 40 is a processing system that is generally configured to facilitate communication between the loyalty program 30, existing transaction card processing systems, and/or shopping/redemption networks. Specifically, the loyalty system middleware 40 is configured to, inter alia, (1) receive requests to use loyalty points as currency, via a user interface system 20, (2) verify with the loyalty program 30 that sufficient loyalty points are available, (3) communicate with an authorization system (e.g., CAS 50) to determine if the participant's 1 financial transaction account is active and has a sufficient credit limit, (4) convert loyalty points to currency, and (5) interact with financial capture (e.g., FINCAP 60) or accounts receivable (AR) 80 systems in order to credit a participant's financial transaction account with the appropriate amount of loyalty currency. The loyalty system middleware 40 may comprise various computer web and application servers, databases, routers, relays and the like in order to suitably process, route, and transmit data among, inter alia, the user interface system 20, loyalty program 30, FINCAP 60, and CAS 50.

The charge authorization system (CAS) 50, the financial capture system (FINCAP) 60, the accounts payable system (AP) 70 and the accounts receivable system (AR) 80 are known in the art systems employed by transaction card companies to authorize merchant transaction requests and process settlement requests. While FIG. 15 shows these systems in one account manager system, it should be appreciated that these systems take various forms depending on the particular account manager or groups of account managers. For example, an exemplary CAS 50 receives an authorization request from a merchant 5 to determine if the financial transaction account associated with a transaction card number is valid and has sufficient credit. CAS 50 includes systems for comparing the transaction details (e.g., account number, monetary amount of transaction, expiration date, and the like) with the participant's financial transaction account information to determine if the financial transaction account is active and if a sufficient credit limit exists to complete a transaction. If these conditions are satisfied, CAS 50 returns to the merchant 5 an approval code reflecting that the merchant 5 is authorized to complete the transaction. The loyalty system middleware 40 or loyalty program 30 may also either reference the same CAS 50 as shown in FIG. 15 to determine if the participant's loyalty account information is valid (and with sufficient loyalty points) or may invoke a separate CAS component (not shown) to complete the same task.

In an exemplary embodiment, upon completion of a transaction (or a series of transactions), the merchant 5 transmits a record of charges (ROC) and summary of charges (SOC) request to the card provider (referred to herein as the “account manager 10”) requesting to be paid for the transaction. The ROC file generally contains transaction details which could include, inter alia, the merchant identification number, amount of purchase, date of purchase, and expiration date. The information is captured in the account manager's (e.g., charge card provider) financial capture system (FINCAP) 60 where it is processed for merchant 5 payment and cardholder (participant 1) billing. FINCAP 60 then sends a payment file to an AP 70 to pay the merchant 5, retrieves the appropriate participant 1 (e.g., cardholder) account information, and sends a billing file to an AR 80. The AR 80 generates a participant 1 billing statement that reflects the appropriate billing information such as date of charge, amount of charge, merchant, and the like. As may be described in detail later, exemplary embodiments contemplate the AR 80 receiving a credit from the loyalty system middleware 40 to appropriately offset at least a part of the merchant 5 transaction charge. Alternatively, as shown in FIG. 15, the loyalty system middleware may send credit requests to the FINCAP 60 for processing and forwarding to the AR 80.

Having described and defined exemplary components of exemplary embodiments, it should be appreciated that the transaction system of the exemplary embodiments may be described herein in terms of functional block components, flow charts, screen shots, optional selections and various processing steps. It should be appreciated that such functional blocks may be realized by any number of hardware and/or software components configured to perform the specified functions. For example, the exemplary embodiments may employ various integrated circuit components, e.g., memory elements, processing elements, logic elements, look-up tables, and the like, which may carry out a variety of functions under the control of one or more microprocessors or other control devices. Similarly, the software elements of the exemplary embodiments may be implemented with any programming or scripting language such as C, C++, Java, COBOL, assembler, PERL, or the like, with the various algorithms being implemented with any combination of data structures, objects, processes, routines or other programming elements. Further, it should be noted that the exemplary embodiments may employ any number of conventional techniques for data transmission, signaling, data processing, network control, and the like. For a basic introduction of cryptography, please review a text written by Bruce Schneider which is entitled “Applied Cryptography: Protocols, Algorithms, And Source Code In C,” published by John Wiley & Sons (second edition, 1996), which is hereby incorporated by reference.

It should be appreciated that the particular implementations shown and described herein are illustrative of the exemplary embodiments and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It may be appreciated, that many applications of the exemplary embodiments could be formulated. One skilled in the art may appreciate that a network may include any system for exchanging data or transacting business, such as the Internet, an intranet, an extranet, wide area network (WAN), local area network (LAN), satellite or wireless communications, and/or the like. The participant 1 may interact with the account manager's 10 (e.g., charge card provider) transaction system or a merchant 5 via any input device such as a telephone, keyboard, mouse, kiosk, personal digital assistant, touch screen, voice recognition device, transponder, biometrics device, handheld computer, personal data assistant, cellular phone, web TV, web phone, blue tooth/beaming device and/or the like. Similarly, the exemplary embodiments could be used in conjunction with any type of personal computer, network computer, workstation, minicomputer, mainframe, or the like running any operating system such as any version of Windows, macOS, Linux, iOS, Android, or the like. Moreover, although the exemplary embodiments use protocols such as TCP/IP to facilitate network communications, it may be readily understood that the exemplary embodiments could also be implemented using IPX, Appletalk, IP-6, NetBIOS, OSI or any number of existing or future protocols. Moreover, the system contemplates the use, sale, exchange, transfer, or any other distribution of any goods, services or information over any network having similar functionality described herein.

As may be appreciated by one of ordinary skill in the art, the exemplary embodiments may be embodied as a method, a data processing system, a device for data processing, and/or a computer program product. Accordingly, the exemplary embodiments may take the form of an entirely software embodiment, an entirely hardware embodiment, or an embodiment combining aspects of both software and hardware. Furthermore, the exemplary embodiments may take the form of a computer program product on a computer-readable storage medium having computer-readable program code means embodied in the storage medium. Any suitable computer-readable storage medium may be utilized, including hard disks, CD-ROM, optical storage devices, magnetic storage devices, flash card memory and/or the like.

Communication between the parties (e.g., participant 1, account manager 10, and/or merchant 5) to the transaction and the system of the exemplary embodiments may be accomplished through any suitable communication means, such as, for example, a telephone network, Intranet, Internet, point of interaction device (point of sale device, personal digital assistant, cellular phone, kiosk, and the like.), online communications, off-line communications, wireless communications, and/or the like. One skilled in the art may also appreciate that, for security reasons, any databases, systems, or components of the exemplary embodiments may consist of any combination of databases or components at a single location or at multiple locations, wherein each database or system includes any of various suitable security features, such as firewalls, access codes, encryption, de-encryption, compression, decompression, and/or the like.

Exemplary embodiments are described below with reference to block diagrams and flowchart illustrations of methods, apparatus (e.g., systems), and/or computer program products according to various exemplary embodiments. It may be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. The system may be integrated with other systems to better facilitate the spending of loyalty points and the conversion of loyalty points to a currency credit.

Referencing the online aspect of an exemplary embodiment, each participant is equipped with a computing system to facilitate online commerce transactions. The computing units may be connected with each other via a data communication network. The network is a public network and assumed to be insecure and open to eavesdroppers. In the illustrated implementation, the network is embodied as the internet. In the context, the computers may or may not be connected to the internet at all times. For instance, the participant's computer may employ a modem to occasionally connect to the internet, whereas the account manager's computing center might maintain a permanent connection to the internet. It is noted that the network may be implemented as other types of networks, such as an interactive television (ITV) network. The merchant 5 computer and the account manager 10 computer may be interconnected via a second network, referred to as a payment network. The payment network represents existing proprietary networks that presently accommodate transactions for credit cards, debit cards, and other types of financial/banking cards. The payment network is a closed network that is assumed to be secure from eavesdroppers. While an exemplary embodiment is described in association with a transaction system, the exemplary embodiments contemplate any type of networks or transaction systems, including, for example, unsecure networks, public networks, wireless networks, closed networks, open networks, intranets, extranets, and/or the like.

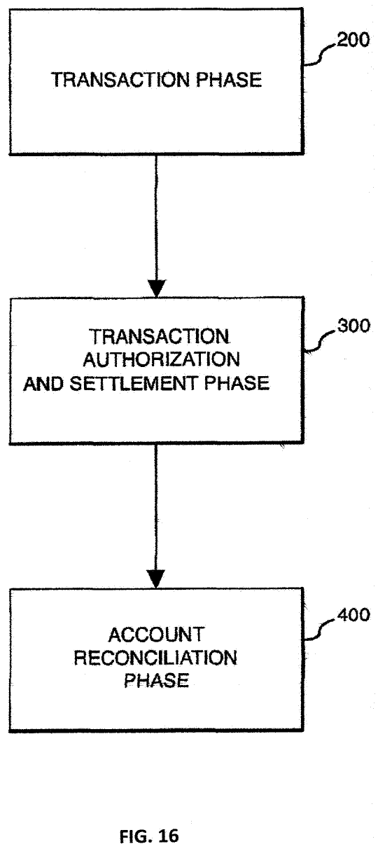

Turning now to the methods for spending loyalty points by converting to a currency value credit, FIG. 16 illustrates three exemplary phases: (1) a transaction phase (step 200), (2) a transaction authorization and settlement phase (step 300), and (3) an account reconciliation phase (step 400). The transaction phase includes a participant's successful registration and enrollment to use the system and method of the exemplary embodiments. In general, although not required, a participant 1 may have registered to participate in a loyalty program and may have accumulated at least some loyalty points. However, conducting the transaction before acquiring loyalty points is also contemplated by the exemplary embodiments. In an exemplary embodiment, the participant 1 has a transaction card associated with a financial transaction account, wherein the card provider or loyalty program manager is what is referred to herein as the account manager 10. In an exemplary system, the account manager is both a card provider and a loyalty program manager. Registration and enrollment processes are known in the art, and as such, may not be discussed in-depth herein. Although an exemplary embodiment contemplates the use of, and integration of a participant's loyalty account and financial transaction account, other embodiments (e.g., the secondary transaction number embodiment, stored value card, gift certificate, and the like (discussed later)) do not necessarily require the integration.

Phase II—E-commerce

In another embodiment, TCard users may have access to a number of design options to customize their TCards based on preference and/or the type of cause being supported. The TCard may be coupled to the Tcoin during a transaction, and a record of the cause-based transaction can be established that is defined by the combination of a given TCard and a given Tcoin.

In exemplary embodiments, users may choose from a variety of professionally designed messages in the process of creating their TCard. Specifically, the professionally designed messages may be uploaded on the platform for a fee. As such, more design options for TCard users may be provided, which may enhance or improve the appearance of the user portal. The design of the TCards may become part of the creation of a new tradeable cryptocurrency, recognizable as being specifically an ethical cryptocurrency.

In exemplary embodiments, the platform may be an E-Commerce platform allowing the users to exchange Tcoins/TCards in exchanges for goods and services. As a result, ethical- or cause-based activities may be further encouraged.

In exemplary embodiments, the implementation of the cryptocurrency may include registering and managing user accounts, inviting new users to create an account, creating and sending a TCard with an associated Tcoin value, receiving a TCard, managing the Tcoin accounts (referred to herein as “TWallet”) which may include replenishing the Tcoin from external sources and monetizing Tcoins, transferring Tcoins between Tcoins between TWallets, creating and managing a group TWallet, creating a TWallet associated with an organization or a campaign.

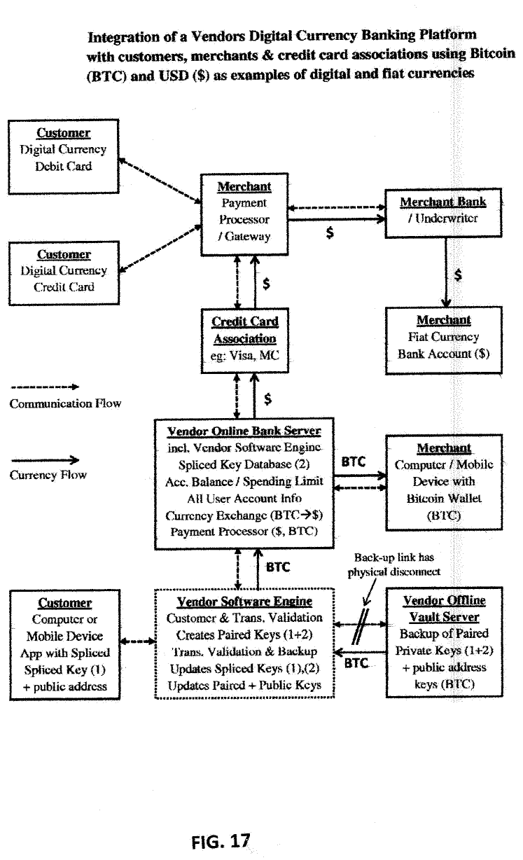

The integration of the exemplary embodiments with customers, merchants and credit card associations using bitcoin (BTC) and US dollars ($) as typical exemplarys of digital and fiat currencies is described in FIG. 17. The customer can use a digital currency credit or debit card to make purchases with third party merchants in US dollars via conventional merchant credit card payment processors and gateways that interface with traditional credit card associations including, but in no way limited to, Visa, MasterCard, American Express and Diners Card. The vendors' online banking platform processes and completes payments in US dollars to credit card associations and payments in bitcoin directly to merchants for all approved and confirmed customer purchases. The banking platform also converts all fiat currency transaction amounts from US dollars into bitcoin, charges any transaction fees applicable, deducts all converted fiat and digital currency transactions from the customers bitcoin wallet, splices and encodes new private key information on the customers computer device and vendors online server, and makes a backup of the paired private key information on the vendors offline server or network. In the case that credit and debit card products use conventional magnetic stripe storage of information, transaction approval from the vendor can be received by the merchant almost instantaneously via the verification of stored account balances or spending limits. However transaction processing with magnetic striped cards may take longer as it requires a subsequent online connection between the customers' computer or mobile device with the vendors online server platform for the customer to formally confirm the transaction. In the case that credit and debit card products use the latest smart card technology with programmable onboard integrated circuitry for storage of information, transaction approval and processing can be completed in a single process at the time of the purchase.

The exemplary embodiments include in part a unique and novel digital wallet technology that can be described as a spliced/paired online wallet technology. Conventional digital wallets typically comprise, but are not limited to, a private software key in excess of fifty characters long and a shorter public key or address around thirty characters long. The private key is required to access or use digital currency assets stored in accounts associated with the public address. Theft or loss of the private key typically results in the permanent loss of all digital currency assets. However loss of the public address is not detrimental as it can be recalculated or reformulated using the private key. Regardless of whether the private key is retained by the customer, the wallet vendor or both, if it is stored on any server, computer or mobile device that is connected to the internet it is vulnerable to online theft or loss. Consequently conventional online digital wallets are susceptible to online theft, fraud, loss or deletion of the private key information which commercially limits the amount of digital currency typically stored by customers in an online wallet or debit card. Large amounts of digital currency are more often stored in much more secure offline digital wallets that are difficult for the customer to access and use.

In contrast to conventional online digital wallets, exemplary embodiments include a novel spliced/paired digital wallet design involves the private software key being separated or spliced into two separate smaller keys that can only access the contents of a digital wallet when paired together, but cannot access a digital wallet separately on their own. The concept is for the customer to retain one spliced private key and the card issuer, wallet vendor or digital bank to retain the other spliced portion of the private key for trusted payment processing and storage backup services. Most of the time, when a transaction is not being executed, the spliced private key information stored on either the vendors computer server or the customers computer device is entirely useless to an online thief or computer hacker who is successful in penetrating computer security. The two spliced keys are only ever susceptible to online theft when the customer decides to execute a digital currency transaction via connecting to the wallet vendors' online platform server via the internet. Note that in most practical real world cases a much more complicated set of coding algorithms would be used to encode spliced private keys and create paired private key combinations.

When a purchase transaction is initiated by a customer the vendors online platform server and software engine first confirms the identity of the customer, temporarily pairs the two spliced private keys together, executes a digital currency transaction using the paired wallet information, updates the public address and spliced private key information on both the vendors platform and the customers computer device, stores a backup copy of the updated public address and paired key information on an offline server network, remote digital storage device or cold wallet that is not connected to the internet, and then finally destroys the temporarily paired key information on the platform server. If a customer makes several transactions a day then the paired private key might only be susceptible to online theft for a few minutes a day. However even the small period of susceptibility to online theft of the paired private key information is virtually eliminated if the platform server only allows access from a single customer device at any one time and implements sufficiently stringent customer identification and transaction security protocols. Moreover, the customers' digital currency assets can be fully protected against both theft and loss because the only place the customers paired private key information is stored is on the wallet vendors' highly secure offline server network, cold wallet or digital vault which is not physically connected to the internet. If the customer loses their spliced key information via the physical loss of a computer, mobile device, the deletion of stored software files or the physical loss of a credit/debit card then the spliced key information can be restored on their device using the paired key information stored on the vendors offline server network, cold wallet or digital vault. Consequently spliced/paired digital wallet technology represents a significant enhancement or improvement in the security of digital assets against both theft and loss compared to conventional digital wallet technology.

Spliced/paired digital wallet technology enables dramatically increased security against online theft or loss, the use of traditional credit and debit card payment processing systems, and the use of conventional digital currency payment processing systems that are accessed via the internet on a personal computer or mobile device. In one possible embodiment spliced/paired digital wallets may be configured as a novel class of encryption or crypto-currency that exists on top of existing digital or crypto-currencies such as Bitcoin and Litecoin. A dramatic reduction in online security risk combined with the increased ease of use for customers makes it significantly more attractive for credit issuers and lenders to accept the risks involved in issuing digital currency credit card accounts to approved customers. In addition the increased security of digital currency in spliced/paired wallets promotes larger transactions to be more acceptable to debit card customers. Consequently spliced/paired digital wallet technology has the potential to ensure a very high degree of online security and safety against potential theft or loss of stored assets, thereby enabling credit card and debit transactions to be more safely accepted by credit card issuers and customers.

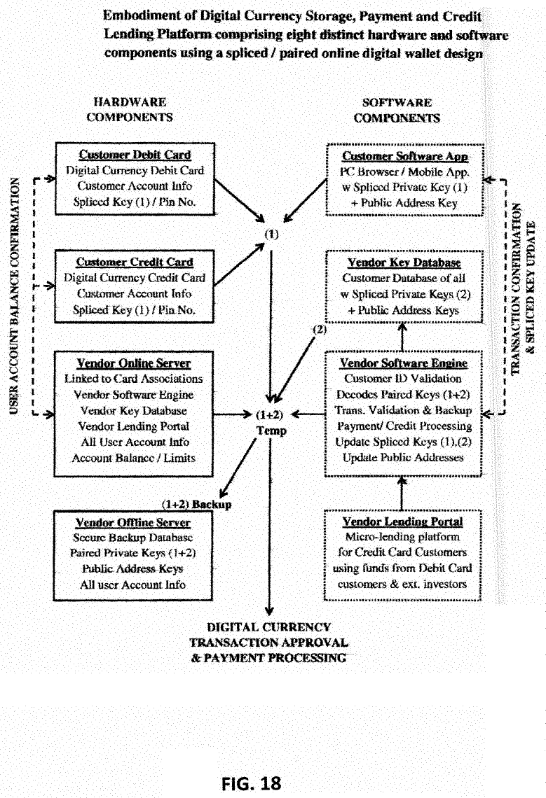

In a first embodiment described in FIG. 18, although this should not be seen as limiting the exemplary embodiments in any way, a secure digital currency storage, payment and credit lending platform is provided to customers by a digital currency card issuer, banking institution or wallet vendor; and consists of the following eight distinct components of hardware and software; a first component being of hardware, namely a digital currency debit card issued by the vendor to the customer that enables the use of converted digital currency assets stored in a spliced/paired digital currency wallet account for the purchase of goods and services in fiat currency with existing merchant credit/debit card payment processing infrastructure and credit card associations; a second component being of hardware, namely a digital currency credit card issued by the vendor to the customer that enables the use of converted digital currency assets, borrowed from a pool of investors or credit lending network, and stored in a spliced/paired digital currency wallet account for the purchase of goods and services in fiat currency with existing merchant credit/debit card payment processing infrastructure and credit card associations; a third component being of hardware, namely the vendors online server platform or network that stores the vendors spliced private key information and runs the vendors software engine for customer validation, processing of digital currency and credit/debit card transactions and peer-to-peer lending of credit to customer accounts; a fourth component being of hardware, namely the vendors offline server platform, network, cold wallet or digital vault that is safely located, securely operated and physically disconnected from the internet and is used to regularly store updates of the back-up copy of the customers' account information, paired private key and public address information in case either vendors or customers spliced private key information is lost, deleted or corrupted; a fifth component being of software, namely the customers portion of the spliced digital currency wallet account that includes the customers digital wallet public address and the customers splice or portion of the customers digital wallet private key, that can be stored on customers credit/debit card and the customers computer or mobile device; a sixth component being of software, namely a database of the vendors portion of the spliced digital currency wallet account that includes the customers digital wallet public address and the vendors splice or portion of the customers digital wallet private key, that is stored on the vendors online server platform or network; a seventh component being of software, namely the vendors software engine that runs on the vendors online server platform, and performs numerous functions including, but not limited to (a) validation of customer identity, account balances and spending limits (b) interfacing with the credit card associations and digital currency accounts for transaction validation, (c) temporary pairing of spliced keys to produce a complete paired private key, (d) using the paired private key for digital currency transactions and conversions into fiat currency transactions, (e) updating and encryption of spliced private keys stored on the customers computer and vendors online server platform, (f) updating customer card account balances and spending limits, (g) creation of a back-up of the paired private key stored on the vendors offline server network before deleting it on the online server, and (h) interfacing with a distributed peer-to-peer lending network for funding credit card customer accounts; and an eighth component being of software, namely the vendors peer-to-peer lending platform or network that connects customers applying for digital currency credit card funds with a pool or distributed network of digital currency lenders which may include both external third party credit investors and existing customers with debit card accounts, stores all existing credit balances and spending limits, and manages all customer credit card contracts, fees and interest charges on behalf of the lender, or pool of lenders.

In a second embodiment the vendors offline server platform, or the eighth component, can also be used to store and validate customer card account balances and spending limits, and to interface directly with credit card associations for validation of customer credit and debit card transactions. In the embodiment the vendors' online server platform is not required for the storage of customer account balance and spending limit information in a database used for validation and processing of credit/debit card transactions. Consequently the second embodiment may offer enhanced or improved credit/debit card security benefits for the vendor, and also enhanced or improved security ease-of-use benefits for customers.

In a third embodiment, the vendors database of spliced portions of customer private keys and user account information, or the sixth component, may exist as a software block-chain that is stored on a large distributed peer-to-peer network of customer computers instead of the vendors online server network. The configuration may have advantages in terms of providing increased security without customers having to place total trust in the vendor for digital asset security. In the case the database of vendor private keys would be stored on all customers' computers and mobile devices for pairing with the customers' portion of the private key. The block-chain may be decoded for a specific private key by either the vendors' software engine or on the customers' computer or mobile device. The configuration has greater stability and transparency for the vendors' key database and may be virtually immune to the loss of digital currency assets from the loss or deletion of the private key software. However, unlike the first two embodiments described, the third embodiment is not totally immune to theft of assets from online fraud or computer hacking as the customer possesses both portions of the private key necessary to confirm transactions. Nonetheless the storing of both portions of the spliced/paired digital wallet existing on the customers computer or mobile device offers better security than conventional digital currency wallets that currently exist on customer devices, primarily due to the added layer of the proprietary encryption engine required to pair the two keys together to form a single private key.

In a fourth embodiment the customers debit cards and credit cards, or the first and second components, utilize smart card technology with embedded integrated circuitry. In the case the customers' spliced private key can be stored and updated directly on the card when being used for fiat currency transactions. Consequently bitcoin transactions using a smart debit or smart credit card can be quickly approved and processed at the time of the purchase, and updated spliced keys can be stored locally on the card. Private key updates and transaction information can be updated on the customers computer or mobile device when the customer next logs onto the vendors online server. The customers' updated private key information is permanently stored as a back-up on the vendors' offline server, and may be temporarily stored on the vendors online server for updating customer computers and mobile devices.

In a fifth embodiment, the customers debit cards and credit cards, or the first and second components, utilize traditional credit card technology with magnetic stripe encoding for data storage. In the case the transaction is approved at the time of the purchase by confirming the customers' account balance or spending limit. However because the customers spliced private key information is not stored and updated locally on the magnetic credit card, processing of digital currency payments and transactions may be handled in batches requiring the customer to log-on to the vendors online server with their computer or mobile device. Consequently the may take a significantly longer time for payment processing unless a payment confirmation message is sent to the customers computer or mobile device. Nonetheless conventional credit card transactions typically take a few days to fully process and automatic batch processing of transactions whenever the customer logs onto the vendors online server is a highly feasible solutions. Moreover, customer confirmation of each transaction after vendor approval via text, email or internet application to a computer or smart mobile device is a feature that many customers may want for additional security reasons.

In embodiments, although this should not be seen as limiting the exemplary embodiments in any way, the exemplary embodiments include four hardware components and four key software components that form an integrated payment and banking platform. The platform interfaces with external digital currency exchanges, credit card associations, 3rd party investors and credit lenders, and customers via credit cards, debit cards, computers and mobile devices. The platform also has the capability for customers to confirm each individual credit/debit card transaction via internet software application, email or SMS/text notification for additional levels of transaction security. For computer hackers or online thieves to steal the customers' private key from the spliced/paired digital currency wallet they may first gain a copy of the customers portion of the private key from their personal computer or mobile device, second gain a copy of the vendors portion of the private key from the vendors online server, and third gain a copy of the vendors software engine and platform that encodes, splices and pairs the two keys from the vendors online server. It is important to realize that the vendors' software engine is a large, proprietary piece of software that is continually running on the highly secure vendor online server network that only approved customers and the vendor have access to. In other words they not only have to steal both codes from two different parties, they would also have to steal a proprietary online banking platform while it was operating. Consequently, even in the highly inconceivable case that an online thief could acquire all three pieces of software code, their identity would be well known to the vendor with sufficient customer approval and validation procedures.

In summary of the specific details discussed herein, the exemplary embodiments can be described as a highly secure financial banking platform that uses spliced/paired digital wallet technology for the storage of digital currency, uses digital currency credit and debit cards for fiat currency transactions with merchants, uses internet connected computers and mobile devices for digital currency transactions with merchants, and uses a distributed network of debit card customers and 3rd party lenders for the provision of credit lending for credit card customers. The process of splicing digital currency private key software into two portions held by two different trusted parties combined with proprietary encoding, splicing and pairing software virtually eliminates the possibility of online theft of digital currency. The process of making back-ups of the paired keys and only storing these keys on a secure offline server or cold wallet eliminates the possibility of losing digital currency from the loss of private key software stored on customer computer or mobile devices. Consequently the exemplary embodiments are secure against both theft and loss of private keys and public addresses.

The exemplary embodiments offer numerous advantages for customers over existing digital currency debit card products including increased online security of digital currency assets, the additional use of digital currency with credit card products, the widespread acceptance of digital currency with any merchant or third party that accepts credit cards for conventional fiat currency transactions, the use of computers or mobile devices with any merchant that accepts digital currency transactions, and the supply of credit lending funds to credit card customers using a distributed pool of investors and lenders. The exemplary embodiments also offer numerous advantages for digital currency card issuers, banking institutions or wallet vendors including the dramatic reduction of security risks associated with online digital wallets, the increased commercially feasibility of digital currency credit card products, the ability to fund credit card lending using existing debit card customers and 3^{rd} party investors, and the increasing mainstream consumer appeal of digital currency credit and debit card products as digital currencies grow in popularity, currency value and market stability. The exemplary embodiments represent a significant and innovative advance in online banking technology and digital currency storage, payment and credit lending products. Various modifications may be made in details of design and construction of the exemplary embodiments and its component parts, process steps, parameters of operation and the like without departing from the scope and ambit of the exemplary embodiments.

Phase III—Marketplace—Lending, Borrowing and Investing in Ethical

In an additional embodiment, the platform may be expanded to allow Tcoins holders the opportunity to qualify for lending and/or investing accounts on the platform. Specifically, organizations, or individual users of the platform may be able to obtain loans as a group, e.g., when they individually may not be able to obtain such loans. Platform users may also become lenders and open lending accounts to engage in Tcoin lending activities. Alternatively, only users having a predefined balance of Tcoins may be allowed to open lending accounts. In a separate embodiment, users may be able to invest in existing cause-based projects through the portal. As such, the portal can provide a complete marketplace where users, such as individuals or organizations, are able to trade, fund, invest, lend and borrow Tcoins. The portal would thus provide an eco-system of ethical based funding.

Exemplary embodiments of systems and methods include developing a technological platform with IT System or Mobile Application in the form of TCards that may enable users to express gratitude towards one another, towards a group of people and towards organizations undergoing campaigns that benefit society at large. Exemplary embodiments facilitate the expression of gratitude towards these ethical/social causes and campaigns, and empower users to continue and contribute to creating a better community society around them and in the society at-large.

In exemplary embodiments, users may be able to complete the following operations on the TCard platform: replenish their TWallet accounts with Tcoins by transferring local currency from external sources; receive TCards/Tcoins from other users directly or through an organization that creates a group account to which the user is included; send TCards/Tcoins to individual users, independent groups, groups associated with different organizations and humanitarian campaigns organized by these institutions; and monetize the Tcoins accumulated in their TWallets by transferring them to external financial accounts.

In exemplary embodiments, within each TWallet account, a user can edit their profile (photos, bio, and the like). Individual users may create an independent group dedicated to a cause and set up an expiration date, at which point in time, the total Tcoins in the group TWallet may be distributed, e.g., equally distributed, among the group members that have contributed to the cause. Once the cause expires, the Tcoins may be redistributed among the group members, or may be redeployed towards one or more other causes.

In exemplary embodiments, if a user has a cause TWallet account, they may create causes or campaigns, and manage participants or volunteers to the causes or campaigns by adding individual users, managing them and assigning them to various tasks. The user may also set up an expiration date for a cause. Once the cause expires, Tcoins may be distributed to the TWallets of each individual user, or redeployed to one or more other causes. Subsequently, the cause may be closed on the platform.

In exemplary embodiments, an organization administrator can edit group details, e.g., photos, mission statement, and the like. An organization may create, e.g., two types of TWallets: a general TWallet (supporting causes/campaigns), and a cause or group TWallet (supporting volunteers/participants) In exemplary embodiments, Tcoins accumulated in the General TWallet may be deployed to other TWallets, or may be monetized. Tcoins accumulated in Groups TWallets associated with an organization or cause may be distributed among participants and/or sent to their individual TWallets. In exemplary embodiments, when the distribution of Tcoins in a Group TWallet is not possible, the Tcoins remaining undistributed may be sent to the General TWallet.

Investing Mechanism

In exemplary embodiments, the lending and borrowing mechanisms discussed above may be further expanded to include investing as well. Same mechanisms may be used to qualify Tcoin holders for an investment account, and businesses to submit a public request for funding. Businesses interested in raising capital who pass the review process may make a public request for funding, and may raise Tcoins capital from the qualified community. Similar to the lending accounts, users who qualify for an investment account on the platform may also have access to investing their Tcoins and contributing to the growth of those cause-based businesses.

In exemplary embodiments, Tcoins users may promote the businesses they lend to and/or invest in by sending TCards through social-media platforms to acknowledge their good work and business activities. Tcoins users may also further support these businesses by buying their products and/or services on the marketplace if those businesses access their option to open an e-commerce account on the platform.

In exemplary embodiments, lending, borrowing and investing operational models may include an independent, blind review process that the businesses may undergo in order to qualify for access to the public funding request options on the platform. Reviewers opening a “reviewer account” may be selected and verified prior to engaging in the review process and being matched with businesses who submit a request for Business Plan review. The Tcoin lenders/investors may view the public requests for funding which passed a minimum number of reviews performed by pre-qualified reviewers. Accordingly, the lenders/investors' risk may be reduced, and the lenders/investors may build confidence with the Tcoins users that their lending/investing options on the platform have a reasonable chance of providing returns. The TCard social-media application, the marketplace and the lending/investing additions to the technological platform may form an eco-system which rewards users for their community-service, and gives them opportunities to further contribute to their communities by engaging in donation, lending, and investing activities that support the organizations and businesses of their choice. The system may enable both direct accounts with end-users as well as the ability to create organizational accounts. Manual entry and instantiation of a Tcoin/TCard system may be conducted by an organization.

In exemplary embodiments, for larger, dynamic organizations, integration is possible with existing volunteer registration systems, human resource systems, and other human capital systems through single-sign-on integration or other means of dynamically integrating these systems to accommodate a dynamically changing volunteer database. Corporate accounts can be manually initiated by designated individuals in an organization.

Analytics of Ethical Cryptocurrency Transactions

In a separate embodiment, the platform may accumulate data related to transactions of Tcoins/TCards, and may be used to classify various users of the platform in relation to the ethical activities in which they are engaged, as well as to the number and amount of transactions they perform. As a user authors a TCard, the system may suggest, through semantic analysis of the text or description of the card, a particular level of Tcoins to be donated or transacted. For example, patterns related to seasonality of the transactions or donations, community characteristics, or other factors may be stored and associated with each user. Accordingly, various user profiles may be determined and stored. Such user profiles may be used to, e.g., suggest further donations, or to set specific goals based on the type and frequency of past donations. In addition, different terms or action descriptions may be associated with users associated with higher donation levels of TCard/Tcoins.

For example, information/trend analysis may be aggregated to allow the determination of which actions lead to higher Tcoin/TCard donations. Also, such information aggregation may allow for the determination of preferred times of the year that such donations are more likely to occur. Aggregating and analyzing the information may provide increased economic and competitive value for investors in the eco-system who purchase Tcoins/TCards, organizations that implement the systems, and individuals performing the ethical acts. As a result, the analysis could allow for the determination of which candidate would be best for a given ethical project based on what the track record of the candidate and the nature of the ethical project.

It should be understood, however, that the detailed description and specific exemplarys, indicating exemplary embodiments, are given for purposes of illustration only and not as limitations. Many changes and modifications within the scope of the exemplary embodiments may be made without departing from the spirit thereof, and the exemplary embodiments include all such modifications. The scope of the exemplary embodiments should be determined by the appended claims and their legal equivalents, rather than by the exemplarys given above.

As used herein, the singular form of a word includes the plural, and vice versa, unless the context clearly dictates otherwise. Thus, the references “a”, “an”, and “the” are generally inclusive of the plurals of the respective terms.

The words “comprise”, “comprises”, and “comprising” are to be interpreted inclusively rather than exclusively. Likewise the terms “include”, “including” and “or” should all be construed to be inclusive, unless such a construction is clearly prohibited from the context. Further, forms of the terms “comprising” or “including” are intended to include embodiments encompassed by the phrases “consisting essentially of” and “consisting of”. Similarly, the phrase “consisting essentially of” is intended to include embodiments encompassed by the phrase “consisting of”.

Where used herein, ranges are provided in shorthand, so as to avoid having to list and describe each and every value within the range. Any appropriate value within the range can be selected, where appropriate, as the upper value, lower value, or the terminus of the range.

The, methods and/or other advances disclosed here are not limited to particular methodology, protocols, and/or components described herein because, as the skilled artisan may appreciate, they may vary. Further, the terminology used herein is for the purpose of describing particular embodiments only, and is not intended to, and does not, limit the scope of that which is disclosed or claimed. Although any methods or other means or materials similar or equivalent to those described herein can be used in the practice of the exemplary embodiments, the formulations, compositions, methods, or other means or materials are described herein.

Any patents, patent applications, publications, technical and/or scholarly articles, and other references cited or referred to herein are in their entirety incorporated herein by reference to the extent permitted under applicable law. Any discussion of those references is intended merely to summarize the assertions made therein. No admission is made that any such patents, patent applications, publications or references are prior art, or that any portion thereof is either relevant or material to the patentability of what is claimed herein. Applicant specifically reserves the right to challenge the accuracy and pertinence of any assertion that such patents, patent applications, publications, and other references are prior art, or are relevant, and/or material.

While the foregoing represents exemplary embodiments, it may be understood by those skilled in the art that various modifications and changes may be made without departing from the spirit and scope of the exemplary embodiments, and that the exemplary embodiments include all such modifications and changes as come within the scope of the following claims.

What is claimed is:

1. A method of combining digital currency and social messaging to create an ethical digital currency, the method comprising:
creating a recognition note;
embedding an amount of digital currency in the recognition note; and
submitting the recognition note embedded with the amount of digital currency;
wherein the ethical digital currency is a combination of the amount of digital currency and the recognition note.

2. The method of claim 1, wherein the digital currency cannot be submitted when the digital currency is not embedded in the recognition note.

3. The method of claim 1, wherein the recognition note comprises at least one of a gratitude note, a celebration note, a caring note, an encouragement note, a reconciliation note a love note, and a happiness note.

4. The method of claim 1, further comprising creating a marketplace where the digital currency is exchanged.

5. The method of claim 4, wherein the creating the marketplace comprises at least one of managing investing in the ethical digital currency and using the ethical digital currency for investments.

6. The method of claim 4, wherein the creating the marketplace comprises managing borrowing and lending of the ethical digital currency.

7. The method of claim 1, wherein the submitting the recognition note comprises reporting the submitting to a social platform.

8. A system for combining digital currency and social messaging to create an ethical digital currency, the system comprising:
a processor;
a user interface functioning via the processor; and
a repository accessible by the processor; wherein
the processor creates a recognition note;
the processor embeds an amount of digital currency in the recognition note; and
the processor submits the recognition note embedded with the amount of digital currency;
wherein the ethical digital currency is a combination of the amount of digital currency and the recognition note; and
wherein at least one of the embedding of the amount of digital currency and the submitting the recognition note is performed on a digital currency exchange platform.

9. The system of claim 8, wherein the digital currency exchange platform is unable to exchange the ethical digital currency when the recognition note is not embedded with the amount of digital currency.

10. The system of claim 8, wherein the recognition note comprises at least one of a gratitude note, a celebration note, a caring note, an encouragement note, a reconciliation note a love note, and a happiness note.

11. The system of claim 8, wherein the digital currency exchange platform includes a marketplace where the digital currency and embedded recognition note are exchanged.

12. The system of claim 11, wherein the marketplace comprises an investment marketplace allowing to at least one of lend and borrow against the ethical digital currency.

13. The system of claim 8, wherein the digital currency exchange platform includes a social messaging platform.
